(19) United States
(12) Patent Application Publication
(10) Pub. No.: US 2025/0228153 A1
(43) Pub. Date: Jul. 17, 2025

(54) SEED TREATMENT SYSTEMS, METHODS, AND AGRICULTURAL COMPOSITIONS

(71) Applicant: Pivot Bio, Inc., Berkeley, CA (US)

(72) Inventors: Keith O'BRYAN, Omaha, NE (US); Richard Wilson BELCHER, Hayward, CA (US); Matt KESTEL, Grimes, IA (US); Paul A. KAEB, Sabetha, KS (US); Dominic E. MEYER, Sabetha, KS (US); Chad Kimmelshue, Richmond Heights, MO (US)

(73) Assignee: Pivot Bio, Inc., Berkeley, CA (US)

(21) Appl. No.: 18/875,618

(22) PCT Filed: Jun. 30, 2023
(86) PCT No.: PCT/US2023/026729

§ 371 Date: Dec. 16, 2024

Related U.S. Application Data
(60) Provisional application No. 63/357,422, filed on Jun. 30, 2022.

(51) Int. Cl. A01C 1/06; A01N 25/02; A01P 21/00

(52) U.S. Cl. CPC A01C 1/06; A01N 25/02; A01P 21/00

(57) ABSTRACT

Seed treatment systems with a mixing reservoir including a tank, a circulation mechanism positioned within the tank, and a controller coupled to the circulation mechanism, where the circulation mechanism includes a plurality of vanes configured to rotate about an axis within the tank, and where the controller is configured to mix seed treatment components within the tank in one or more mixing cycles by rotating the plurality of vanes within the tank, each mixing cycle including a first mixing operation in which the plurality of vanes rotate in a first direction about an axis for a first time period, and a second mixing operation in which the plurality of vanes rotate in a second direction about the axis opposite to the first direction for a second time period. Methods of use of the disclosed systems, e.g., for treating plant seeds, and agricultural compositions produced thereby are also provided.

### CROSS-REFERENCE TO RELATED APPLICATIONS

This application claims priority to U.S. Provisional Patent Application No. 63/357,422, filed on Jun. 30, 2022, the entire contents of which are incorporated herein by reference.

### TECHNICAL FIELD

This disclosure relates to systems and methods for treating seeds prior to planting and to agricultural compositions containing treated plant seeds.

### BACKGROUND

Seeds of food crops can be treated with different agents to preserve and enhance their viability. Conventional treatments are generally applied by spraying seeds with an atomized liquid that includes a treatment composition and drying the sprayed seeds prior to storage.

### SUMMARY

This disclosure features systems and methods for applying microbial compositions to seeds and agricultural compositions that include plant seeds featuring a first coating and an overtreatment that includes at least one microbial with the ability to fix atmospheric nitrogen and excrete nitrogen compounds useful for the growth of crop plants. The microbial compositions are typically applied as an overtreatment, following prior application of a coating to the seeds, and include at least one microbial. The microbial is generally a microbe which impacts plant health or nutrition, such as a nitrogen-fixing microbe, such as a bacterium, which converts atmospheric nitrogen gas (N₂) into ammonia (NH₃) via reduction mediated by the enzyme nitrogenase. The ammonia can be incorporated into organic matter such as plant tissues, thereby contributing significantly to increased yields relative to untreated crop seeds. The systems and methods described herein can be used to ensure that microbials applied as overtreatments remain viable between the time of application and time at which the treated seeds are planted. Further, microbial-containing overtreatments are applied in a manner that does not adversely affect the viability of the underlying seed, and the efficacy of previously applied seed coatings, or coatings applied during or after seed overtreatment.

In an aspect, the disclosure features seed treatment systems that include an inlet for receiving seeds, a treatment dispersal assembly for applying a treatment to seeds, an outlet for discharging seeds, a first transport mechanism configured to deliver seeds from the inlet to the treatment dispersal assembly, and a second transport mechanism configured to deliver treated seeds from the treatment dispersal assembly to the outlet, where during operation, the systems are configured to receive seeds that include a first coating, and apply an overtreatment to the received seeds that comprises at least one microbial.

Embodiments of the systems can include any one or more of the following features.

The systems can be configured to apply the overtreatment to the received seeds such that a stability of the microbial is maintained on the seeds following the overtreatment. The systems can be configured to apply the overtreatment to the received seeds such that a viability of the seeds is maintained following the overtreatment. The systems can be configured to apply the overtreatment to the received seeds such that an effectiveness of elements of the first coating is maintained on the seeds following the overtreatment. The systems can be configured to apply the overtreatment to the received seeds by dispersing the seeds spatially so that the seeds do not aggregate following application of the overtreatment.

The systems can be configured through adjustment of one or more of settings on an atomizer present in the treatment dispersal assembly, a flow rate of the seeds through the system, an agitation rate of seeds, a drying time for treated seeds, and a dwell time of seeds in the system.

The elements of the first coating can include a biocide. The at least one microbial can include at least one microbe which impacts plant health or nutrition, such as a nitrogen fixing microbe. The at least one microbial can include at least one gram-negative microbe. The at least one microbial can include at least one gram-negative nitrogen fixing microbe. The at least one microbial can include at least one nitrogen-fixing bacterium. The at least one nitrogen-fixing bacterium can be selected from the group consisting of Klebsiella variicola strains 137-1036, 137-2253, and 137-3890, and Kosakonia saccharii strain 6-5687, and any combination thereof.

The overtreatment can include an extender. The systems can be configured to apply the extender and the microbial simultaneously to the seeds.

The systems can include a first reservoir configured to contain the extender, and a second reservoir configured to contain the microbial. The systems can include a reservoir that contains both the extender and the microbial.

The systems can include a member configured to expose the seeds to the treatment. The member can be cone-shaped and positioned in a housing of the systems such that an apex of member faces the inlet. The member can include a recess into which seeds are delivered by the first transport mechanism. The recess can include surfaces that are inclined relative to a bottom surface of the member. An angle of inclination of the recess surfaces can be between 1 degree and 45 degrees.

Relative to a ground surface that supports the system, the first transport mechanism can be positioned below the inlet and above the treatment dispersal assembly so that seeds are transported by falling through the first transport mechanism. The first transport mechanism can include a seed flow gate to adjust a transportation rate of the seeds through the first transport mechanism.

The treatment dispersal assembly can include an atomizer configured to generate droplets of a treatment fluid. The atomizer can be integrated into the member. The atomizer can be in fluid communication with a reservoir configured to contain the treatment fluid. The atomizer can include a plurality of apertures configured to discharge the treatment fluid to generate the droplets. Relative to a ground surface that supports the system, the second transport mechanism can be positioned below the treatment dispersal assembly so that treated seeds fall into the second transport mechanism from the treatment dispersal assembly.

The systems can include a scattering mechanism configured to disperse received seeds onto the member. The scattering mechanism can include a plurality of apertures positioned so that received seeds are delivered to multiple surface regions of the member. The scattering mechanism can include an aperture that rotates relative to an axis of the member. The scattering mechanism can include an orifice that rotates relative to an axis of the member.

The scattering mechanism can include a first distribution member and a second distribution member, where relative to a ground surface that supports the system, the first distribution member is positioned above the second distribution member, and where during operation of the system, the treatment dispersal assembly delivers received seeds from the inlet to the first distribution member, seeds fall from the first distribution member to the second distribution member, and seeds fall from the second distribution member to the member of the treatment dispersal assembly. Each of the first and second distribution members can include a plurality of apertures.

At least one of the first and second distribution members can rotate about an axis oriented orthogonally with respect to the at least one of the first and second distribution members. The axis can extend through the at least one of the first and second distribution members.

The systems can be configured so that during operation, at least one of the first and second distribution members is displaced vertically relative to the ground surface to redistribute at least some seeds to different locations on the at least one of the first and second distribution members.

Relative to a horizontal ground surface that supports the system, the systems can be configured so that during operation, the member is displaced vertically to redistribute at least some seeds to different locations on the member. During operation, the member can be continuously displaced vertically to redistribute seeds. During operation, the member can be displaced intermittently vertically to redistribute seeds.

The treatment dispersal assembly can include a powder scattering mechanism, and during operation, the powder scattering mechanism can be configured to apply an overtreatment composition featuring the at least one microbial to the received seeds. The composition can include a dry powder featuring the at least one microbial. The composition can include granules featuring the at least one microbial.

The overtreatment can include a protecting agent that preserves viability of the at least one microbial.

The treatment dispersal assembly can include an atomizer configured to generate droplets from a liquid, and during operation, the treatment dispersal assembly can be configured to generate droplets of a liquid overtreatment composition featuring the at least one microbial and a protecting agent that preserves viability of the at least one microbial, and expose the received seeds to the droplets of the liquid overtreatment composition to coat the received seeds with the overtreatment composition. The liquid overtreatment composition can be an aqueous or non-aqueous composition. The liquid overtreatment composition can include at least one polymer or polymer precursor. The overtreatment can include more than one microbial. The systems can include separate reservoirs for each microbial.

Embodiments of the systems can also include any of the other features described herein, and can include any combination of features, including combinations of features that are individually described in connection with different embodiments, without limitation unless expressly stated otherwise.

In another aspect, the disclosure features seed treatment systems that include an inlet for receiving seeds, a treatment dispersal assembly for applying a treatment to seeds, featuring a conical member configured to spatially disperse the received seeds to expose the seeds to the treatment, an outlet for discharging seeds, a first transport mechanism configured to deliver seeds from the inlet to the treatment dispersal assembly, and a belt conveyor mechanism configured to deliver treated seeds from the treatment dispersal assembly to the outlet, where during operation, the treatment dispersal assembly is configured to receive seeds delivered by the first transport mechanism and featuring a first coating, and apply an overtreatment to the received seeds that includes at least one microbial.

Embodiments of the systems can include any one or more of the following features.

The belt conveyor mechanism can include a conveyor that is inclined upwards relative to a ground surface that supports the systems from an entrance of the belt conveyor mechanism to an exit of the belt conveyor mechanism. The belt conveyor mechanism can include a conveyor that is approximately parallel to a ground surface that supports the system.

The systems can be configured to apply the overtreatment to the received seeds such that a stability of the microbial is maintained on the seeds following the overtreatment. The systems can be configured to apply the overtreatment to the received seeds such that a viability of the seeds is maintained following the overtreatment. The systems can be configured to apply the overtreatment to the received seeds such that an effectiveness of elements of the first coating is maintained on the seeds following the overtreatment. The systems can be configured to apply the overtreatment to the received seeds so that the seeds do not aggregate following application of the overtreatment.

The at least one microbial can include at least one microbe which impacts plant health or nutrition, such as a nitrogen fixing microbe. The at least one microbial can include at least one gram-negative microbe. The at least one microbial can include at least one gram-negative nitrogen fixing microbe. The at least one microbial can include at least one nitrogen-fixing bacterium. The at least one nitrogen-fixing bacterium can be selected from the group consisting of strains Klebsiella variicola strains 137-1036, 137-2253, and 137-3890, Kosakonia saccharii strain 6-5687, and any combination thereof.

The member can be positioned in a housing of the systems such that an apex of the member faces the inlet. The member can include a recess into which seeds are delivered by the first transport mechanism. The recess can include surfaces that are inclined relative to a bottom surface of the member. An angle of inclination of the recess surfaces can be between 1 degree and 30 degrees.

Relative to a ground surface that supports the system, the first transport mechanism can be positioned below the inlet and above the treatment dispersal assembly so that seeds are transported by falling through the first transport mechanism. The first transport mechanism can include a seed flow gate to adjust a transportation rate of the seeds through the first transport mechanism.

The treatment dispersal assembly can include an atomizer configured to generate droplets of a treatment fluid. The atomizer can be integrated into the member. The atomizer can be in fluid communication with a reservoir configured to contain the treatment fluid. The atomizer can include a plurality of apertures configured to discharge the treatment fluid to generate the droplets.

Relative to a ground surface that supports the system, the belt conveyor mechanism can be positioned below the treatment dispersal assembly so that treated seeds fall into the belt conveyor mechanism from the treatment dispersal assembly.

The systems can include a scattering mechanism configured to disperse received seeds onto the member. The scattering mechanism can include a plurality of apertures positioned so that received seeds are delivered to multiple surface regions of the member. The scattering mechanism can include an aperture that rotates relative to an axis of the member. The scattering mechanism can include an orifice that rotates relative to an axis of the member.

The scattering mechanism can include a first distribution member and a second distribution member, where relative to a ground surface that supports the system, the first distribution member is positioned above the second distribution member, and where during operation, the treatment dispersal assembly delivers received seeds from the inlet to the first distribution member, seeds fall from the first distribution member to the second distribution member, and seeds fall from the second distribution member to the member of the treatment dispersal assembly. Each of the first and second distribution members can include a plurality of apertures. At least one of the first and second distribution members can rotate about an axis oriented orthogonally with respect to the at least one of the first and second distribution members. The axis can extend through the at least one of the first and second distribution members.

The systems can be configured so that during operation, at least one of the first and second distribution members can be displaced vertically relative to the ground surface to redistribute at least some seeds to different locations on the at least one of the first and second distribution members. Relative to a horizontal ground surface that supports the systems, the systems can be configured so that during operation, the member is displaced vertically to redistribute at least some seeds to different locations on the member.

During operation, the member can be continuously displaced vertically to redistribute seeds. During operation, the member can be displaced intermittently vertically to redistribute seeds.

The treatment dispersal assembly can include a powder scattering mechanism, and during operation, the powder scattering mechanism can be configured to apply an overtreatment composition featuring the at least one microbial to the received seeds. The composition can include a dry powder featuring the at least one microbial. The composition can include granules featuring the at least one microbial. The overtreatment can include a protecting agent that preserves viability of the at least one microbial.

The treatment dispersal assembly can include an atomizer configured to generate droplets from a liquid, and during operation, the treatment dispersal assembly can be configured to generate droplets of a liquid overtreatment composition featuring the at least one microbial and a protecting agent that preserves viability of the at least one microbial, and expose the received seeds to the droplets of the liquid overtreatment composition to coat the received seeds with the overtreatment composition. The liquid overtreatment composition can be an aqueous or non-aqueous composition. The liquid overtreatment composition can include at least one polymer or polymer precursor. The overtreatment can include more than one microbial. The systems can include separate reservoirs for each microbial.

The systems can be configured through adjustment of one or more of settings on an atomizer present in the treatment dispersal assembly, a flow rate of the seeds through the system, an agitation rate of seeds, a drying time for treated seeds, and a dwell time of seeds in the system.

The first coating can include a biocide.

The overtreatment can include a polymer. The systems can include a first reservoir configured to contain the polymer, and a second reservoir configured to contain the microbial.

Embodiments of the systems can also include any of the other features described herein, and can include any combination of features, including combinations of features that are individually described in connection with different embodiments, without limitation unless expressly stated otherwise.

In another aspect, the disclosure features seed treatment systems that include an inlet for receiving seeds, a treatment dispersal assembly for applying a treatment to seeds, featuring a conical member configured to spatially disperse the received seeds to expose the seeds to the treatment, an outlet for discharging seeds, a first transport mechanism configured to deliver seeds from the inlet to the treatment dispersal assembly, and an auger mechanism configured to deliver treated seeds from the treatment dispersal assembly to the outlet, where during operation, the treatment dispersal assembly is configured to receive seeds delivered by the first transport mechanism and featuring a first coating, and apply an overtreatment to the received seeds that includes at least one microbial.

Embodiments of the systems can include any one or more of the following features.

The systems can be configured to apply the overtreatment to the received seeds such that a stability of the microbial is maintained on the seeds following the overtreatment. The systems can be configured to apply the overtreatment to the received seeds such that a viability of the seeds is maintained following the overtreatment. The systems can be configured to apply the overtreatment to the received seeds such that an effectiveness of elements of the first coating is maintained on the seeds following the overtreatment. The systems can be configured to apply the overtreatment to the received seeds so that the seeds do not aggregate following application of the overtreatment.

The at least one microbial can include at least one microbe which impacts plant health or nutrition, such as a nitrogen fixing microbe. The at least one microbial can include at least one gram-negative microbe. The at least one microbial can include at least one gram-negative nitrogen fixing microbe. The at least one microbial can include at least one nitrogen-fixing bacterium. The at least one nitrogen-fixing bacterium can be selected from the group consisting of Klebsiella variicola strains 137-1036, 137-2253, and 137-3890, Kosakonia saccharii strain 6-5687, and any combination thereof.

The member can be positioned in a housing of the system such that an apex of the member faces the inlet. The member can include a recess into which seeds are delivered by the first transport mechanism. The recess can include surfaces that are inclined relative to a bottom surface of the member. An angle of inclination of the recess surfaces can be between 1 degree and 30 degrees.

Relative to a ground surface that supports the systems, the first transport mechanism can be positioned below the inlet and above the treatment dispersal assembly so that seeds are transported by falling through the first transport mechanism. The first transport mechanism can include a seed flow gate to adjust a transportation rate of the seeds through the first transport mechanism.

The treatment dispersal assembly can include an atomizer configured to generate droplets of a treatment fluid. The atomizer can be integrated into the member. The atomizer can be in fluid communication with a reservoir configured to contain the treatment fluid. The atomizer can include a plurality of apertures configured to discharge the treatment fluid to generate the droplets.

Relative to a ground surface that supports the systems, the auger conveyor mechanism can be positioned below the treatment dispersal assembly so that treated seeds fall into the auger conveyor mechanism from the treatment dispersal assembly.

The systems can include a scattering mechanism configured to disperse received seeds onto the member. The scattering mechanism can include a plurality of apertures positioned so that received seeds are delivered to multiple surface regions of the member. The scattering mechanism can include an aperture that rotates relative to an axis of the member. The scattering mechanism can include an orifice that rotates relative to an axis of the member.

The scattering mechanism can include a first distribution member and a second distribution member, where relative to a ground surface that supports the systems, the first distribution member can be positioned above the second distribution member, and where during operation, the treatment dispersal assembly delivers received seeds from the inlet to the first distribution member, seeds fall from the first distribution member to the second distribution member, and seeds fall from the second distribution member to the member of the treatment dispersal assembly. Each of the first and second distribution members can include a plurality of apertures. At least one of the first and second distribution members can rotate about an axis oriented orthogonally with respect to the at least one of the first and second distribution members. The axis can extend through the at least one of the first and second distribution members.

The systems can be configured so that during operation, at least one of the first and second distribution members is displaced vertically relative to the ground surface to redistribute at least some seeds to different locations on the at least one of the first and second distribution members. Relative to a horizontal ground surface that supports the systems, the systems can be configured so that during operation, the member is displaced vertically to redistribute at least some seeds to different locations on the member.

During operation, the member can be continuously displaced vertically to redistribute seeds. During operation, the member can be displaced intermittently vertically to redistribute seeds.

The treatment dispersal assembly can include a powder scattering mechanism, and during operation, the powder scattering mechanism can be configured to apply an overtreatment composition featuring the at least one microbial to the received seeds. The composition can include a dry powder featuring the at least one microbial. The composition can include granules featuring the at least one microbial. The overtreatment can include a protecting agent that preserves viability of the at least one microbial.

The treatment dispersal assembly can include an atomizer configured to generate droplets from a liquid, and during operation, the treatment dispersal assembly can be configured to generate droplets of a liquid overtreatment composition featuring the at least one microbial and a protecting agent that preserves viability of the at least one microbial, and expose the received seeds to the droplets of the liquid overtreatment composition to coat the received seeds with the overtreatment composition. The liquid overtreatment composition can be an aqueous or non-aqueous composition. The liquid overtreatment composition can include at least one polymer or polymer precursor.

The systems can be configured through adjustment of one or more of settings on an atomizer present in the treatment dispersal assembly, a flow rate of the seeds through the system, an agitation rate of seeds, a drying time for treated seeds, and a dwell time of seeds in the system.

The first coating can include a biocide. The overtreatment can include a polymer. The systems can include a first reservoir configured to contain the at least one polymer or polymer precursor, and a second reservoir configured to contain the microbial. The overtreatment can include more than one microbial. The systems can include separate reservoirs for each microbial.

Embodiments of the systems can also include any of the other features described herein, and can include any combination of features, including combinations of features that are individually described in connection with different embodiments, without limitation unless expressly stated otherwise.

In another aspect, the disclosure features methods of treating seeds that include transporting seeds having a first coating from an inlet to a member of a treatment dispersal assembly, and applying an overtreatment to the seeds on the member, where the overtreatment includes at least one microbial.

Embodiments of the methods can include any one or more of the following features.

The methods can include applying the overtreatment to the seeds such that a stability of the microbial is maintained on the seeds following the overtreatment. The methods can include applying the overtreatment to the seeds such that a viability of the seeds is maintained following the overtreatment. The methods can include applying the overtreatment to the seeds such that an effectiveness of elements of the first coating is maintained on the seeds following the overtreatment. The methods can include applying the overtreatment to the seeds such that the seeds do not aggregate following application of the overtreatment.

The at least one microbial can include at least one microbe which impacts plant health or nutrition, such as a nitrogen fixing microbe. The at least one microbial can include at least one gram-negative microbe. The at least one microbial can include at least one gram-negative nitrogen fixing microbe. The at least one microbial can include at least one nitrogen-fixing bacterium. The at least one nitrogen-fixing bacterium can be selected from the group consisting of Klebsiella variicola strains 137-1036, 137-2253, and 137-3890, and Kosakonia saccharii strain 6-5687, and any combination thereof.

The member can be cone-shaped and positioned so that an apex of the member faces the inlet. The methods can include delivering the seeds into a recess of the member prior to applying the overtreatment. The recess can include surfaces that are inclined relative to a bottom surface of the member. An angle of inclination of the recess surfaces can be between 1 degree and 30 degrees.

The methods can include transporting the seeds by allowing the seeds to fall from the inlet to the member. The methods can include adjusting a transportation rate of the seeds from the inlet to the member. The methods can include generating droplets of a treatment fluid and exposing the seeds to the droplets to apply the overtreatment to the seeds. The methods can include discharging the treatment fluid through a plurality of apertures of an atomizer to generate the droplets.

The methods can include transporting the seeds through a scattering mechanism configured to disperse the seeds onto the member. The scattering mechanism can include a plurality of apertures positioned so that the seeds are delivered to multiple surface regions of the member. The methods can include rotating an aperture of the scattering mechanism relative to an axis of the member to deliver the seeds to the multiple surface regions of the member. The methods can include rotating an orifice of the scattering mechanism relative to an axis of the member to deliver the seeds to the multiple surface regions of the member. Transporting the seeds through a scattering mechanism can include delivering the seeds from the inlet to a first distribution member of the scattering mechanism, allowing the seeds to fall from the first distribution member to a second distribution member of the scattering mechanism, and allowing the seeds to fall from the second distribution member to the member of the treatment dispersal assembly. Each of the first and second distribution members can include a plurality of apertures.

The methods can include rotating at least one of the first and second distribution members about an axis oriented orthogonally with respect to the at least one of the first and second distribution members. The axis can extend through the at least one of the first and second distribution members.

The methods can include displacing at least one of the and second distribution members vertically relative to a ground surface to redistribute at least some seeds to different locations on the at least one of the first and second distribution members. The methods can include displacing the member vertically relative to a horizontal ground surface to redistribute at least some seeds to different locations on the member. The methods can include continuously displacing the member vertically to redistribute seeds. The methods can include intermittently displacing the member vertically to redistribute seeds.

The methods can include applying an overtreatment composition featuring the at least one microbial to the received seeds using a powder scattering mechanism. The composition can include a dry powder featuring the at least one microbial. The composition can include granules featuring the at least one microbial. The composition can include a protecting agent that preserves viability of the at least one microbial.

The overtreatment can include a liquid overtreatment composition featuring the at least one microbial and a protecting agent that preserves viability of the at least one microbial, and the methods can include generating droplets of the overtreatment composition from an atomizer, and exposing the received seeds to the droplets of the overtreatment composition to coat the received seeds with the overtreatment composition. The liquid overtreatment composition can be an aqueous or non-aqueous composition. The liquid overtreatment composition can include at least one polymer or polymer precursor.

The methods can include adjusting one or more of settings on an atomizer that applies the overtreatment to the seeds, a flow rate of the seeds during application of the overtreatment, an agitation rate of seeds during drying of the applied overtreatment, a drying time for the overtreated seeds, and a dwell time of seeds following application of the overtreatment.

The first coating can include a biocide. The overtreatment can include a polymer. The methods can include retrieving the polymer from a first reservoir and retrieving the microbial from a second reservoir. The overtreatment can include more than one microbial. The methods can include retrieving each microbial from a separate reservoir.

Embodiments of the methods can also include any of the other features described herein, and can include any combination of features, including combinations of features that are individually described in connection with different embodiments, without limitation unless expressly stated otherwise.

In another aspect, the disclosure features methods of treating seeds that include transporting seeds having a first coating from an inlet of a seed treatment system to a member of a treatment dispersal assembly, dispersing the received seeds spatially using the member, applying an overtreatment to the dispersed seeds to produce treated seeds, and transporting the treated seeds to an outlet of the seed treatment system using a belt conveyor mechanism, where the overtreatment includes at least one microbial.

Embodiments of the methods can include any one or more of the following features.

The methods can include applying the overtreatment to the seeds such that a stability of the microbial is maintained on the seeds following the overtreatment. The methods can include applying the overtreatment to the seeds such that a viability of the seeds is maintained following the overtreatment. The methods can include applying the overtreatment to the seeds such that an effectiveness of elements of the first coating is maintained on the seeds following the overtreatment. The methods can include applying the overtreatment to the seeds such that the seeds do not aggregate following application of the overtreatment.

The at least one microbial can include at least one microbe which impacts plant health or nutrition, such as a nitrogen fixing microbe. The at least one microbial can include at least one gram-negative microbe. The at least one microbial can include at least one gram-negative nitrogen fixing microbe. The at least one microbial can include at least one nitrogen-fixing bacterium. The at least one nitrogen-fixing bacterium can be selected from the group consisting of Klebsiella variicola strains 137-1036, 137-2253, and 137-3890, Kosakonia saccharii strain 6-5687, and any combination thereof.

The member can be cone-shaped and positioned so that an apex of the member faces the inlet. The methods can include delivering the seeds into a recess of the member prior to applying the overtreatment. The recess can include surfaces that are inclined relative to a bottom surface of the member. An angle of inclination of the recess surfaces can be between 1 degree and 30 degrees.

The methods can include transporting the seeds by allowing the seeds to fall from the inlet to the member. The methods can include adjusting a transportation rate of the seeds from the inlet to the member. The methods can include generating droplets of a treatment fluid and exposing the seeds to the droplets to apply the overtreatment to the seeds. The methods can include discharging the treatment fluid through a plurality of apertures of an atomizer to generate the droplets. The methods can include transporting the seeds through a scattering mechanism configured to disperse the seeds onto the member. The scattering mechanism can include a plurality of apertures positioned so that the seeds are delivered to multiple surface regions of the member. The methods can include rotating an aperture of the scattering mechanism relative to an axis of the member to deliver the seeds to the multiple surface regions of the member. The methods can include rotating an orifice of the scattering mechanism relative to an axis of the member to deliver the seeds to the multiple surface regions of the member.

Transporting the seeds through a scattering mechanism can include delivering the seeds from the inlet to a first distribution member of the scattering mechanism, allowing the seeds to fall from the first distribution member to a second distribution member of the scattering mechanism, and allowing the seeds to fall from the second distribution member to the member of the treatment dispersal assembly. Each of the first and second distribution members can include a plurality of apertures.

The methods can include rotating at least one of the first and second distribution members about an axis oriented orthogonally with respect to the at least one of the first and second distribution members. The axis can extend through the at least one of the first and second distribution members.

The methods can include displacing at least one of the and second distribution members vertically relative to a ground surface to redistribute at least some seeds to different locations on the at least one of the first and second distribution members. The methods can include displacing the member vertically relative to a horizontal ground surface to redistribute at least some seeds to different locations on the member. The methods can include continuously displacing the member vertically to redistribute seeds. The methods can include intermittently displacing the member vertically to redistribute seeds.

The methods can include applying an overtreatment composition featuring the at least one microbial to the received seeds using a powder scattering mechanism. The composition can include a dry powder featuring the at least one microbial. The composition can include granules featuring the at least one microbial. The composition can include a protecting agent that preserves viability of the at least one microbial.

The overtreatment can include a liquid overtreatment composition featuring the at least one microbial and a protecting agent that preserves viability of the at least one microbial, and the methods can include generating droplets of the overtreatment composition from an atomizer, and exposing the received seeds to the droplets of the overtreatment composition to coat the received seeds with the overtreatment composition. The liquid overtreatment composition can be an aqueous or non-aqueous composition. The liquid overtreatment composition can include at least one polymer or polymer precursor.

The methods can include adjusting one or more of settings on an atomizer that applies the overtreatment to the seeds, a flow rate of the seeds during application of the overtreatment, an agitation rate of seeds during drying of the applied overtreatment, a drying time for the overtreated seeds, and a dwell time of seeds following application of the overtreatment.

The first coating can include a biocide. The overtreatment can include a polymer. The methods can include retrieving the polymer from a first reservoir and retrieving the microbial from a second reservoir. The overtreatment can include more than one microbial. The methods can include retrieving each microbial from a separate reservoir. The overtreatment can include an extender. The methods can include retrieving the extender from a first reservoir and retrieving the microbial from a second reservoir. The extender and the microbial can be maintained in a common reservoir. The methods can include mixing the extender and the microbial in a common reservoir.

Embodiments of the methods can also include any of the other features described herein, and can include any combination of features, including combinations of features that are individually described in connection with different embodiments, without limitation unless expressly stated otherwise.

In another aspect, the disclosure features methods of treating seeds that include transporting seeds having a first coating from an inlet of a seed treatment system to a member of a treatment dispersal assembly, dispersing the received seeds spatially using the member, applying an overtreatment to the seeds on the member to produce treated seeds, and transporting the treated seeds to an outlet of the seed treatment system using an auger conveyor mechanism, wherein the overtreatment includes at least one microbial.

Embodiments of the methods can include any one or more of the following features.

The methods can include applying the overtreatment to the seeds such that a stability of the microbial is maintained on the seeds following the overtreatment. The methods can include applying the overtreatment to the seeds such that a viability of the seeds is maintained following the overtreatment. The methods can include applying the overtreatment to the seeds such that an effectiveness of elements of the first coating is maintained on the seeds following the overtreatment. The methods can include applying the overtreatment to the seeds such that the seeds do not aggregate following application of the overtreatment.

The at least one microbial can include at least one microbe which impacts plant health or nutrition, such as a nitrogen fixing microbe. The at least one microbial can include at least one gram-negative microbe. The at least one microbial can include at least one gram-negative nitrogen fixing microbe. The at least one microbial can include at least one nitrogen-fixing bacterium. The at least one nitrogen-fixing bacterium can be selected from the group consisting of Klebsiella variicola strains 137-1036, 137-2253, and 137-3890, Kosakonia saccharii strain 6-5687, and any combination thereof.

The member can be cone-shaped and positioned so that an apex of the member faces the inlet. The methods can include delivering the seeds into a recess of the member prior to applying the overtreatment. The recess includes surfaces that are inclined relative to a bottom surface of the member. An angle of inclination of the recess surfaces can be between 1 degree and 30 degrees.

The methods can include transporting the seeds by allowing the seeds to fall from the inlet to the member. The methods can include adjusting a transportation rate of the seeds from the inlet to the member. The methods can include generating droplets of a treatment fluid and exposing the seeds to the droplets to apply the overtreatment to the seeds. The methods can include discharging the treatment fluid through a plurality of apertures of an atomizer to generate the droplets. The methods can include transporting the seeds through a scattering mechanism configured to disperse the seeds onto the member. The scattering mechanism can include a plurality of apertures positioned so that the seeds are delivered to multiple surface regions of the member. The methods can include rotating an aperture of the scattering mechanism relative to an axis of the member to deliver the seeds to the multiple surface regions of the member. The methods can include rotating an orifice of the scattering mechanism relative to an axis of the member to deliver the seeds to the multiple surface regions of the member.

Transporting the seeds through a scattering mechanism can include delivering the seeds from the inlet to a first distribution member of the scattering mechanism, allowing the seeds to fall from the first distribution member to a second distribution member of the scattering mechanism, and allowing the seeds to fall from the second distribution member to the member of the treatment dispersal assembly. Each of the first and second distribution members can include a plurality of apertures. The methods can include rotating at least one of the first and second distribution members about an axis oriented orthogonally with respect to the at least one of the first and second distribution members. The axis can extend through the at least one of the first and second distribution members.

The methods can include displacing at least one of the and second distribution members vertically relative to a ground surface to redistribute at least some seeds to different locations on the at least one of the first and second distribution members. The methods can include displacing the member vertically relative to a horizontal ground surface to redistribute at least some seeds to different locations on the member. The methods can include continuously displacing the member vertically to redistribute seeds. The methods can include intermittently displacing the member vertically to redistribute seeds.

The methods can include applying an overtreatment composition featuring the at least one microbial to the received seeds using a powder scattering mechanism. The composition can include a dry powder comprising the at least one microbial. The composition can include granules featuring the at least one microbial. The composition can include a protecting agent that preserves viability of the at least one microbial.

The overtreatment can include a liquid overtreatment composition featuring the at least one microbial and a protecting agent that preserves viability of the at least one microbial, and the methods can include generating droplets of the overtreatment composition from an atomizer and exposing the received seeds to the droplets of the overtreatment composition to coat the received seeds with the overtreatment composition. The liquid overtreatment composition can be an aqueous or non-aqueous composition. The liquid overtreatment composition can include at least one polymer or polymer precursor.

The methods can include adjusting one or more of settings on an atomizer that applies the overtreatment to the seeds, a flow rate of the seeds during application of the overtreatment, an agitation rate of seeds during drying of the applied overtreatment, a drying time for the overtreated seeds, and a dwell time of seeds following application of the overtreatment.

The first coating can include a biocide. The overtreatment can include a polymer. The methods can include retrieving the polymer from a first reservoir and retrieving the microbial from a second reservoir. The overtreatment can include more than one microbial. The methods can include retrieving each microbial from a separate reservoir.

Embodiments of the methods can also include any of the other features described herein, and can include any combination of features, including combinations of features that are individually described in connection with different embodiments, without limitation unless expressly stated otherwise.

In another aspect, the disclosure features agricultural compositions that include a plant seed featuring a first coating and an overtreatment, where the overtreatment includes at least one microbial.

Embodiments of the agricultural compositions can include any one or more of the following features.

The plant seed can be a corn seed.

The first coating can include a biocide. The overtreatment can include a polymer. The overtreatment can include more than one microbial. The overtreatment can include an extender.

The at least one microbial can include a microbe which impacts plant health or nutrition, such as a nitrogen fixing microbe. The at least one microbial can include at least one gram-negative microbe. The at least one microbial can include at least one gram-negative nitrogen fixing microbe. The at least one microbial can include at least one nitrogen-fixing bacterium.

The at least one nitrogen-fixing bacterium can be selected from the group consisting of Klebsiella variicola strains 137-1036, 137-2253, 137-3890, Kosakonia saccharii strain 6-5687, and any combination thereof.

The plant seed can be viable to grow into a plant. The first coating can have biocidal activity. The at least one microbial can provide fixed nitrogen to a plant grown from the plant seed.

Embodiments of the agricultural compositions can also include any of the other features described herein, and can include any combination of features, including combinations of features that are individually described in connection with different embodiments, without limitation unless expressly stated otherwise.

In another aspect, the disclosure features seed treatment systems that include: a treatment applicator featuring an inlet for receiving seeds, a treatment dispersal assembly for applying a treatment to the received seeds, and an outlet for discharging treated seeds; a mixing reservoir featuring a tank, one or more inlets connected to the tank and configured to receive treatment components, and an outlet connected to the tank; a mixing mechanism featuring an inlet in fluid communication with the outlet of the mixing reservoir, a pump in fluid communication with the mixing mechanism inlet, and a circulation mechanism positioned within the tank; and a controller coupled to the circulation mechanism, where the circulation mechanism includes a plurality of vanes configured to rotate about an axis within the tank, and where the controller is configured to mix the treatment components within the tank in one or more mixing cycles by rotating the plurality of vanes within the tank, each mixing cycle including a first mixing operation in which the plurality of vanes rotate in a first direction about the axis for a first time period, and a second mixing operation in which the plurality of vanes rotate in a second direction about the axis opposite to the first direction for a second time period.

Embodiments of the systems can include any one or more of the following features.

Each vane of the plurality of vanes can include a propeller. The first time period can be at least 3.0 seconds. The second time period can be at least 3.0 seconds. The first and second time periods can be the same. The plurality of vanes can include two vanes (e.g., three or more vanes). The controller can be configured to rotate the plurality of vanes at a rate of at least 1800 revolutions per minute (RPM) during the first time period. The controller can be configured to rotate the plurality of vanes at a rate of at least 1800 RPM during the second time period. The controller can be configured to rotate the plurality of vanes at different rotation rates during the first and second time periods. The controller can be configured to discontinue rotation of the plurality of vanes for a resting period between the first and second periods. The resting period can be at least 1.0 second. The one or more mixing cycles can include at least 3 mixing cycles (e.g., at least 5 mixing cycles).

The one or more inlets of the mixing reservoir can include at least one inlet connected to a source of a solid component of a treatment. The one or more inlets of the mixing reservoir can include at least one inlet connected to a source of a liquid component of a treatment.

The systems can include a delivery mechanism configured to deliver at least a portion of a treatment mixture featuring the treatment components from the tank to the treatment applicator.

The delivery mechanism can include an inlet in fluid communication with the outlet of the mixing reservoir. The delivery mechanism can include a filter. The filter can include a mesh screen. The delivery mechanism can include a pump. The pump can include a peristaltic pump.

The delivery mechanism can include a flow rate measuring device.

The systems can include a recirculation mechanism featuring a plurality of outlets positioned within the tank, where central axes of at least two of the outlets are oriented at an angle with respect to an axis of the tank. The plurality of outlets of the recirculation mechanism can include at least three outlets (e.g., at least four outlets, at least five outlets). Two or more of the plurality of outlets of the recirculation mechanism can be positioned along a wall of the tank. Each of the plurality of outlets of the recirculation mechanism can be positioned along a wall of the tank.

The tank can include a curved lateral wall. The tank can have a cylindrical shape. At least a portion of a lateral wall of the tank can be curved about the axis of the tank, and oriented at an angle with respect to the axis of the tank.

The inlet of the mixing mechanism can be positioned to capture a portion of a treatment mixture comprising the treatment components, and to direct the captured portion of the treatment mixture to a recirculation pump. The recirculation pump can be configured to direct the captured portion of the treatment mixture to the recirculation mechanism. The recirculation mechanism can be positioned and oriented within the tank to deliver the captured portion of the treatment mixture into the tank in a fluid vortex.

Central axes of at least three of the outlets (e.g., at least four of the outlets, at least five of the outlets) of the recirculation mechanism can be oriented at an angle with respect to the axis of the tank. Central axes of each of the outlets of the recirculation mechanism can be oriented at an angle with respect to the axis of the tank. Central axes of the at least two of the outlets of the recirculation mechanism can be oriented at a common angle with respect to the axis of the tank. Central axes of one or more of at least two of the outlets of the recirculation mechanism can be oriented at a first angle with respect to the axis of the tank and the central axes of one or more of at least two of the outlets of the recirculation mechanism can be oriented at a second angle with respect to the axis of the tank, where the first and second angles are different.

The recirculation pump and recirculation mechanism can be configured to deliver the captured portion of the treatment mixture into the tank at a rate of at least 1.5 gallons per minute.

The rate can be between 10.0 and 15.0 gallons per minute.

The one or more inlets can be one inlet.

The microbe can be a microbe which impacts at least one of plant health and plant nutrition.

Embodiments of the systems can also include any of the other features described herein, and can include any combination of features, including combinations of features that are individually described in connection with different embodiments, without limitation unless expressly stated otherwise.

In another aspect, the disclosure features systems for mixing seed treatment components that include: a mixing reservoir featuring a tank, one or more inlets connected to the tank and configured to receive treatment components, and an outlet connected to the tank; a mixing mechanism featuring an inlet in fluid communication with the outlet of the mixing reservoir, a pump in fluid communication with the mixing mechanism inlet, and a circulation mechanism positioned in the tank and comprising a plurality of vanes positioned to rotate about an axis; and a controller coupled to the circulation mechanism and configured to rotate the plurality of vanes about the axis in each of two opposite directions to mix the treatment components.

Embodiments of the systems can include any one or more of the following features.

Each vane of the plurality of vanes can include a propeller.

The controller can be configured to mix the treatment components within the tank in one or more mixing cycles by rotating the plurality of vanes within the tank, each mixing cycle including a first mixing operation in which the plurality of vanes rotate in a first direction about the axis for a first time period, and a second mixing operation in which the plurality of vanes rotate in a second direction about the axis opposite to the first direction for a second time period. The first time period can be at least 3.0 seconds. The second time period can be at least 3.0 seconds. The first and second time periods can be the same. The plurality of vanes can include two vanes (e.g., three or more vanes).

The controller can be configured to rotate the plurality of vanes at a rate of at least 1800 revolutions per minute (RPM) during the first time period. The controller can be configured to rotate the plurality of vanes at a rate of at least 1800 RPM during the second time period. The controller can be configured to rotate the plurality of vanes at different rotation rates during the first and second time periods. The controller can be configured to discontinue rotation of the plurality of vanes for a resting period between the first and second periods. The resting period can be at least 1.0 second. The one or more mixing cycles can include at least 3 mixing cycles (e.g., at least 5 mixing cycles).

The one or more inlets of the mixing reservoir can include at least one inlet connected to a source of a solid component of a treatment. The one or more inlets of the mixing reservoir can include at least one inlet connected to a source of a liquid component of a treatment.

The systems can include a delivery mechanism configured to deliver at least a portion of a treatment mixture including the treatment components from the tank to a treatment applicator.

The delivery mechanism can include an inlet in fluid communication with the outlet of the mixing reservoir. The delivery mechanism can include a filter. The filter can include a mesh screen. The delivery mechanism can include a pump. The pump can include a peristaltic pump.

The delivery mechanism can include a flow rate measuring device.

The systems can include a recirculation mechanism featuring a plurality of outlets positioned within the tank, where central axes of at least two of the outlets are oriented at an angle with respect to an axis of the tank. The plurality of outlets of the recirculation mechanism can include at least three outlets. Two or more of the plurality of outlets of the recirculation mechanism can be positioned along a wall of the tank. Each of the plurality of outlets of the recirculation mechanism can be positioned along a wall of the tank.

The tank can include a curved lateral wall. The tank can have a cylindrical shape. At least a portion of a lateral wall of the tank can be curved about an axis of the tank, and oriented at an angle with respect to the axis of the tank.

The inlet of the mixing mechanism can be positioned to capture a portion of a treatment mixture including the treatment components and direct the captured portion of the treatment mixture to a recirculation pump. The recirculation pump can be configured to recirculate the captured portion of the treatment mixture by directing the captured portion of the treatment mixture to the recirculation mechanism.

Central axes of at least two of the outlets of the recirculation mechanism can be oriented at an angle with respect to an axis of the tank. Central axes of each of the outlets of the recirculation mechanism can be oriented at an angle with respect to an axis of the tank. Central axes of the at least two of the outlets of the recirculation mechanism can be oriented at a common angle with respect to an axis of the tank. Central axes of one or more of the at least two of the outlets of the recirculation mechanism can be oriented at a first angle with respect to an axis of the tank and the central axes of one or more of the at least two of the outlets of the recirculation mechanism can be oriented at a second angle with respect to the axis of the tank, where the first and second angles are different.

The recirculation pump and recirculation mechanism can be configured to deliver the captured portion of the treatment mixture into the tank at a rate of at least 1.5 gallons per minute. The rate can be between least 10.0 and 15.0 gallons per minute.

The one or more inlets can be one inlet.

The microbe can be a microbe which impacts at least one of plant health and plant nutrition.

Embodiments of the systems can also include any of the other features described herein, and can include any combination of features, including combinations of features that are individually described in connection with different embodiments, without limitation unless expressly stated otherwise. In another aspect, the disclosure features methods of treating seeds, the methods including preparing a seed treatment composition featuring a liquid treatment component which extends a viability of a microbe and a solid treatment component including the microbe, and applying the seed treatment composition to seeds, where: preparing the seed treatment composition includes introducing the liquid and solid treatment components into a mixing reservoir comprising a tank, one or more inlets connected to the tank and configured to receive the treatment components, and an outlet connected to the tank, and mixing the liquid and solid treatment components with a mixing mechanism featuring an inlet in fluid communication with the outlet of the mixing reservoir, a pump in fluid communication with the mixing mechanism inlet, and a circulation mechanism positioned within the tank and comprising a plurality of vanes configured to rotate about an axis within the tank; and the treatment components are mixed within the tank in one or more mixing cycles by rotating the plurality of vanes within the tank, each mixing cycle including a first mixing operation in which the plurality of vanes rotate in a first direction about the axis for a first time period, and a second mixing operation in which the plurality of vanes rotate in a second direction about the axis opposite to the first direction for a second time period.

Embodiments of the methods can include any one or more of the following features.

The first time period can be at least 3.0 seconds. The second time period can be at least 3.0 seconds. The first and second time periods can be the same.

The plurality of vanes can include two vanes (e.g., three or more vanes). The plurality of vanes rotate at a rate of at least 1800 revolutions per minute (RPM) during the first time period. The plurality of vanes rotate at a rate of at least 1800 RPM during the second time period. The plurality of vanes rotate at different rotation rates during the first and second time periods. The methods can include discontinuing rotation of the plurality of vanes for a resting period between the first and second periods. The resting period can be at least 1.0 second. The one or more mixing cycles can include at least 3 mixing cycles (e.g., at least 5 mixing cycles).

The methods can include capturing portion of a treatment mixture including the treatment components from within the tank, and directing the captured portion of the treatment mixture to a recirculation pump. The methods can include directing the captured portion of the treatment mixture into a recirculation mechanism featuring a plurality of outlets, and introducing the captured portion of the treatment mixture into the tank using the recirculation mechanism. The plurality of outlets of the recirculation mechanism can include at least three outlets (e.g., at least four outlets, at least five outlets).

Two or more of the plurality of outlets of the recirculation mechanism can be positioned along a wall of the tank. Each of the plurality of outlets of the recirculation mechanism can be positioned along a wall of the tank. The recirculation mechanism can be positioned and oriented within the tank to deliver the captured portion of the treatment mixture into the tank in a fluid vortex. The methods can include orienting central axes of at least three of the outlets of the recirculation mechanism (e.g., at least four outlets of the recirculation mechanism, at least five outlets of the recirculation mechanism) at an angle with respect to the axis of the tank. The methods can include orienting central axes of each of the outlets of the recirculation mechanism at an angle with respect to the axis of the tank. The methods can include orienting central axes of the at least two of the outlets of the recirculation mechanism at a common angle with respect to the axis of the tank. The methods can include orienting central axes of one or more of at least two of the outlets of the recirculation mechanism at a first angle with respect to the axis of the tank and orienting central axes of one or more of at least two of the outlets of the recirculation mechanism at a second angle with respect to the axis of the tank, where the first and second angles are different.

The methods can include delivering at least a portion of a treatment mixture including the treatment components from the tank to a treatment applicator. The methods can include filtering the at least a portion of the treatment mixture before delivering it to the treatment applicator.

The captured portion of the treatment mixture can be introduced into the tank at a rate of at least 1.5 gallons per minute. The rate can be between 10.0 and 15.0 gallons per minute.

The microbe can be a microbe which impacts at least one of plant health and plant nutrition.

Embodiments of the methods can also include any of the other features described herein, and can include any combination of features, including combinations of features that are individually described in connection with different embodiments, without limitation unless expressly stated otherwise.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed.

As used herein, the term “about” is used synonymously with the term “approximately.” Illustratively, the use of the term “about” with regard to an amount indicates that values slightly outside the cited values, e.g., plus or minus 0.1% to 10%.

Some embodiments described herein relate to a computer storage product with a nontransitory computer-readable medium (also can be referred to as a non-transitory processor-readable medium) having instructions or computer code thereon for performing various computer-implemented operations. The computer-readable medium (or processor-readable medium) is nontransitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The term “extender” as used herein means a composition that is applied to seeds together with, or sequentially before or after, the application of at least one microbial. The general purpose of an “extender” is to increase on-seed microbial viability. The extender can function in various ways. For example, the extender can function to protect the at least one microbial to ensure that the microbial remains viable after application to the seeds. The extender can also enhance the flowability of treated seeds, for example, so that treated seeds are prevented from clumping and undergoing other aggregation behaviors. The extender may help to reduce “dust-off”—that is, the aerosolization of treatments applied to seeds.

The “extender” is a liquid that is combined with a liquid or dry form of the microbe to facilitate seed treatment. The extender disperses the microbes, allowing them to be distributed across the surface of the seed. The composition of both the extender and the dry microbial formulation function to promote the viability of gram-negative bacteria. The sugars and polymers in the dry formulation help to stabilize microbial membranes and proteins, allowing the microbes to survive being stored in the vitrified state. When combined with extender, the sugars and polymers in both the extender and the dry formulation together help promote microbial survival on seed.

The term “microbial” as used in this specification includes, but not restricted to, a microbe, microbes, microorganism, microorganisms, bacteria, bacterium, gram-positive bacteria, gram-positive bacterium, gram-negative bacteria, gram-negative bacterium, nitrogen fixing bacteria and nitrogen fixing bacterium.

No language in the specification should be construed as indicating any non-claimed element as essential to the practice of the disclosure. Unless otherwise defined, all technical and scientific terms used herein have the same meaning as commonly understood by one of ordinary skill in the art to which this disclosure belongs. Although methods and materials similar or equivalent to those described herein can be used in the practice or testing of the subject matter herein, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments are set forth in the accompanying drawings and the description below. Other features and advantages will be apparent from the description, drawings, and claims.

### DESCRIPTION OF DRAWINGS

FIG. 1 is a schematic diagram of an example of a seed treatment system.

FIG. 2A is a schematic diagram of a portion of an example of a seed treatment system that includes a rotating support member.

FIG. 2B is a schematic diagram of an example of a rotating support member.

FIG. 2C is a schematic diagram of another example of a rotating support member.

FIG. 2D is a schematic diagram of an example of a support member with an integrated atomizer.

FIG. 3 is a schematic diagram of a portion of an example of a seed treatment system with a scattering mechanism.

FIG. 4 is a schematic diagram of an example of a powder scattering mechanism.

FIG. 5A is a schematic diagram of an example of a mixer for seed treatment components.

FIG. 5B is a schematic diagram of another example of a mixer for seed treatment components.

FIG. 6A is an image of a microbial powder and liquid extender prior to mixing in a commercially available mixer.

FIG. 6B is in image of the microbial powder and liquid extender of FIG. 6A after mixing.

FIG. 6C is an image of an in-line filter used to filter the mixed microbial powder and liquid extender of FIG. 6A.

FIG. 7A is an image of the mixing shaft and vanes of an example of the mixers described herein.

FIG. 7B is an image of a microbial powder and liquid extender prior to mixing in an example mixer described herein.

FIG. 7C is an image of the microbial powder and liquid extender of FIG. 7B after mixing for 5 seconds.

FIG. 7D is an image of the microbial powder and liquid extender of FIG. 7C after mixing for an addition 5 seconds under counter-rotation.

FIG. 7E is an image of the microbial powder and liquid extender of FIG. 7D after 5 mixing cycles.

FIG. 7F is an image of an in-line filter used to filter the mixed microbial powder and liquid extender of FIG. 7E.

FIG. 7G is an image of the mixed microbial powder and liquid extender of FIG. 7E.

FIG. 8 is a viability profile of microbes on the surface of the corn seeds overtreated according to the present disclosure (PROVEN 40 OS) either at the laboratory scale or commercial scale.

FIG. 9 is a viability profile of the microbes on the surface of corn seeds from multiple hybrids overtreated according to the present disclosure in a commercial scale seed treater (PROVEN 40 OS). The horizontal line indicates that the PROVEN 40 OS seeds from majority of the corn varieties harbored microbes above the threshold level of 1×10⁵ CFUs.

FIG. 10 is a viability profile of the microbes on the surface of the PROVEN 40 OS seeds during storage for 100 days at 21° C.

FIG. 11 is a warm germination profile for two different varieties of corn seeds overtreated using a commercial seed treater according to the present disclosure (PROVEN 40 OS) as compared to untreated control (UTC) seeds.

FIG. 12 is a cold germination profile for two different varieties of corn seeds overtreated using a commercial seed treater according to the present disclosure (PROVEN 40 OS) as compared to untreated control (UTC) seeds.

FIG. 13 is a plantability profile for two different varieties of corn seed overtreated using a commercial seed treater according to the present disclosure (PROVEN 40 OS) as compared to untreated control (UTC) seeds.

FIG. 14 is a dust-off profile for two different varieties of corn seed overtreated using a commercial seed treater according to the present disclosure (PROVEN 40 OS) as compared to untreated control (UTC) seeds.

FIG. 15 is the farm trial design followed at multiple sites to evaluate the performance of corn seeds overtreated using a commercial seed treater according to the present disclosure (PROVEN 40 OS) as compared to non-treated control seeds.

FIG. 16 is a profile of emergence and early seedling growth of corn seed overtreated using a commercial seed treater according to the present disclosure (PROVEN 40 PROVEN 40 OS) as compared to non-treated control seeds. The values on the vertical axis represent the number of corn stands per acre.

FIG. 17 is a profile of leaf firing analysis in the corn plants grown from the seed overtreated using a commercial seed treater according to the present disclosure (PROVEN 40 OS) as compared to non-treated control seeds. The values on the vertical axis represent the number of green leaves below the ear leaf.

FIG. 18 shows nitrogen accumulation at the VT stage of plants grown from the corn seeds overtreated using a commercial seed treater according to the present disclosure (PROVEN 40 OS) as compared to untreated control seeds. The plants grown from the untreated seeds received synthetic nitrogen fertilizer at the level of growers' standard practice (Full N) whereas the plants grown from the PROVEN 40 OS seeds received synthetic nitrogen fertilizer at a reduced level which is 40 pounds lower per acre from the growers' standard practice (Reduced N).

FIG. 19 shows yield for the plants grown from the corn seeds overtreated using a commercial seed treater according to the present disclosure (PROVEN 40 OS) as compared to untreated control seeds. The plants grown from the untreated seeds received synthetic nitrogen fertilizer at the level of growers' standard practice (Full N) whereas the plants grown from the PROVEN 40 OS seeds received synthetic nitrogen fertilizer at a reduced level which is 40 pounds lower per acre from growers' standard practice (Reduced N).

Like reference symbols in the various drawings indicate like elements.

### DETAILED DESCRIPTION

### Introduction

Biological nitrogen fixation (BNF) is a process by which plant-associated microbes such as bacteria are believed to be able to provide nitrogen to host plants. Nitrogen is an important nutrient that influences plant growth. In particular, nitrogen is present in both amino acids and chlorophyll pigments, and a wide variety of biological processes, including plant-based protein synthesis and photosynthesis, therefore depend on the availability of nitrogen. When adequate soluble nitrogen is not available in a plant's growth medium, vegetative growth may be retarded and fruit production attenuated.

Typically, fixation of atmospheric nitrogen gas to yield soluble ammonia occurs via naturally occurring microbes such as bacteria. Nitrogenases present in the bacteria catalyze atmospheric nitrogen reduction. Significant research activity is currently directed to engineering improved microbes that enhance reductive conversion of atmospheric nitrogen to ammonia. An important aspect of this activity is measurement of nitrogen incorporation in plant tissues, and evaluation of engineered microbe strains for their nitrogen fixing activity.

In some cases, nitrogen fixation pathway may act as a target for genetic engineering and optimization. One trait that may be targeted for regulation is nitrogen fixation. Nitrogen fertilizer is the largest operational expense on a farm and the biggest driver of higher yields in row crops like corn and wheat. While some endophytes have the genetics necessary for fixing nitrogen in pure culture, the fundamental technical challenge is that wild-type endophytes of cereals and grasses stop fixing nitrogen in fertilized fields. The application of chemical fertilizers and residual nitrogen levels in field soils signal the microbe to shut down the biochemical pathway for nitrogen fixation.

Changes to the transcriptional and post-translational levels of components of the nitrogen fixation regulatory network may be beneficial to the development of a microbe capable of fixing and transferring nitrogen to corn in the presence of fertilizer.

In order to utilize elemental nitrogen (N) for chemical synthesis, life forms combine nitrogen gas (N₂) available in the atmosphere with hydrogen in a process known as nitrogen fixation. Because of the energy-intensive nature of biological nitrogen fixation, diazotrophs (bacteria and archaea that fix atmospheric nitrogen gas) have evolved sophisticated and tight regulation of the nif gene cluster in response to environmental oxygen and available nitrogen. Nif genes encode enzymes involved in nitrogen fixation (such as the nitrogenase complex) and proteins that regulate nitrogen fixation. Shamseldin (2013. Global J. Biotechnol. Biochem. 8(4):84-94) discloses detailed descriptions of nif genes and their products, and is incorporated herein by reference. Described herein are methods of producing a plant with an improved trait comprising isolating bacteria from a first plant, introducing a genetic variation into a gene of the isolated bacteria to increase nitrogen fixation, exposing a second plant to the variant bacteria, isolating bacteria from the second plant having an improved trait relative to the first plant, and repeating the steps with bacteria isolated from the second plant.

In Proteobacteria, regulation of nitrogen fixation centers around the σ54-dependent enhancer-binding protein NifA, the positive transcriptional regulator of the nif cluster. Intracellular levels of active NifA are controlled by two key factors: transcription of the nifLA operon, and inhibition of NifA activity by protein-protein interaction with NifL. Both of these processes are responsive to intracellular glutamine levels via the PII protein signaling cascade. This cascade is mediated by GlnD, which directly senses glutamine and catalyzes the uridylylation or deuridylylation of two PII regulatory proteins—GlnB and GlnK—in response the absence or presence, respectively, of bound glutamine. Under conditions of nitrogen excess, unmodified GlnB signals the deactivation of the nifLA promoter. However, under conditions of nitrogen limitation, GlnB is post-translationally modified, which inhibits its activity and leads to transcription of the nifLA operon. In this way, nifLA transcription is tightly controlled in response to environmental nitrogen via the PII protein signaling cascade. On the post-translational level of NifA regulation, GlnK inhibits the NifL/NifA interaction in a matter dependent on the overall level of free GlnK within the cell.

NifA is transcribed from the nifLA operon, whose promoter is activated by phosphorylated NtrC, another σ54-dependent regulator. The phosphorylation state of NtrC is mediated by the histidine kinase NtrB, which interacts with deuridylylated GlnB but not uridylylated GlnB. Under conditions of nitrogen excess, a high intracellular level of glutamine leads to deuridylylation of GlnB, which then interacts with NtrB to deactivate its phosphorylation activity and activate its phosphatase activity, resulting in dephosphorylation of NtrC and the deactivation of the nifLA promoter. However, under conditions of nitrogen limitation, a low level of intracellular glutamine results in uridylylation of GlnB, which inhibits its interaction with NtrB and allows the phosphorylation of NtrC and transcription of the nifLA operon. In this way, nifLA expression is tightly controlled in response to environmental nitrogen via the PH protein signaling cascade. nifA, ntrB, ntrC, and glnB, are all genes that can be mutated in the methods described herein. These processes may also be responsive to intracellular or extracellular levels of ammonia, urea or nitrates.

The activity of NifA is also regulated post-translationally in response to environmental nitrogen, most typically through NifL-mediated inhibition of NifA activity. In general, the interaction of NifL and NifA is influenced by the PII protein signaling cascade via GlnK, although the nature of the interactions between GlnK and NifL/NifA varies significantly between diazotrophs. In Klebsiella pneumoniae, both forms of GlnK inhibit the NifL/NifA interaction, and the interaction between GlnK and NifL/NifA is determined by the overall level of free GlnK within the cell. Under nitrogen-excess conditions, deuridylylated GlnK interacts with the ammonium transporter AmtB, which serves to both block ammonium uptake by AmtB and sequester GlnK to the membrane, allowing inhibition of NifA by NifL. On the other hand, in Azotobacter vinelandii, interaction with deuridylylated GlnK is required for the NifL/NifA interaction and NifA inhibition, while uridylylation of GlnK inhibits its interaction with NifL. In diazotrophs lacking the nifL gene, there is evidence that NifA activity is inhibited directly by interaction with the deuridylylated forms of both GlnK and GlnB under nitrogen-excess conditions. In some bacteria the Nif cluster may be regulated by glnR, and further in some cases this may comprise negative regulation.

Regardless of the mechanism, post-translational inhibition of NifA is an important regulator of the nif cluster in most known diazotrophs. Additionally, nfL, amtB, glnK, and glnR are genes that can be mutated in the methods described herein.

In addition to regulating the transcription of the nif gene cluster, many diazotrophs have evolved a mechanism for the direct post-translational modification and inhibition of the nitrogenase enzyme itself, known as nitrogenase shutoff. This is mediated by ADP-ribosylation of the Fe protein (NifH) under nitrogen-excess conditions, which disrupts its interaction with the MoFe protein complex (NifDK) and abolishes nitrogenase activity. DraT catalyzes the ADPribosylation of the Fe protein and shutoff of nitrogenase, while DraG catalyzes the removal of ADP-ribose and reactivation of nitrogenase. As with nifLA transcription and NifA inhibition, nitrogenase shutoff is also regulated via the PII protein signaling cascade. Under nitrogen-excess conditions, deuridylylated GlnB interacts with and activates DraT, while deuridylylated GlnK interacts with both DraG and AmtB to form a complex, sequestering DraG to the membrane. Under nitrogen-limiting conditions, the uridylylated forms of GlnB and GlnK do not interact with DraT and DraG, respectively, leading to the inactivation of DraT and the diffusion of DraG to the Fe protein, where it removes the ADP-ribose and activates nitrogenase. The methods described herein also contemplate introducing genetic variation into the nifH, nifD, nifK, and draT genes.

Although some endophytes have the ability to fix nitrogen in vitro, often the genetics are silenced in the field by high levels of exogenous chemical fertilizers. One can decouple the sensing of exogenous nitrogen from expression of the nitrogenase enzyme to facilitate field-based nitrogen fixation. Improving the integral of nitrogenase activity across time further serves to augment the production of nitrogen for utilization by the crop. Specific targets for genetic variation to facilitate field-based nitrogen fixation using the methods described herein include one or more genes selected from the group consisting of nifA, nifL, ntrB, ntrC, glnA, glnB, glnK, draT, amtB, glnD, glnE, nifJ, nifH, nifD, nifK, nifY nifE, nifN, nifU, nifS, nifV nifW, nifZ, nifM nifF, nifB, and nifQ.

An additional target for genetic variation to facilitate field-based nitrogen fixation using the methods described herein is the NifA protein. The NifA protein is typically the activator for expression of nitrogen fixation genes. Increasing the production of NifA (either constitutively or during high ammonia condition) circumvents the native ammonia-sensing pathway. In addition, reducing the production of NifL proteins, a known inhibitor of NifA, also leads to an increased level of freely active NifA. In addition, increasing the transcription level of the nifAL operon (either constitutively or during high ammonia condition) also leads to an overall higher level of NifA proteins. Elevated level of nifAL expression is achieved by altering the promoter itself or by reducing the expression of NtrB (part of ntrB and ntrC signaling cascade that originally would result in the shutoff of nifAL operon during high nitrogen condition). High level of NifA achieved by these or any other methods described herein increases the nitrogen fixation activity of the endophytes.

Another target for genetic variation to facilitate field-based nitrogen fixation using the methods described herein is the GlnD/GlnB/GlnK PII signaling cascade. The intracellular glutamine level is sensed through the GlnD/GlnB/GlnK PII signaling cascade. Active site mutations in GlnD that abolish the uridylyl-removing activity of GlnD disrupt the nitrogen-sensing cascade. In addition, reduction of the GlnB concentration short circuits the glutamine-sensing cascade. These mutations “trick” the cells into perceiving a nitrogen-limited state, thereby increasing the nitrogen fixation level activity. These processes may also be responsive to intracellular or extracellular levels of ammonia, urea or nitrates.

The amtB protein is also a target for genetic variation to facilitate field-based nitrogen fixation using the methods described herein. Ammonia uptake from the environment can be reduced by decreasing the expression level of amtB protein. Without intracellular ammonia, the endophyte is not able to sense the high level of ammonia, preventing the down-regulation of nitrogen fixation genes. Any ammonia that manages to get into the intracellular compartment is converted into glutamine. Intracellular glutamine level is the major currency of nitrogen sensing. Decreasing the intracellular glutamine level prevents the cells from sensing high ammonium levels in the environment. This effect can be achieved by increasing the expression level of glutaminase, an enzyme that converts glutamine into glutamate. In addition, intracellular glutamine can also be reduced by decreasing glutamine synthase (an enzyme that converts ammonia into glutamine). In diazotrophs, fixed ammonia is quickly assimilated into glutamine and glutamate to be used for cellular processes. Disruptions to ammonia assimilation may enable diversion of fixed nitrogen to be exported from the cell as ammonia. The fixed ammonia is predominantly assimilated into glutamine by glutamine synthetase (GS), encoded by glnA, and subsequently into glutamine by glutamine oxoglutarate aminotransferase (GOGAT). In some examples, glnS encodes a glutamine synthetase. GS is regulated post-translationally by GS adenylyl transferase (GlnE), a bi-functional enzyme encoded by glnE that catalyzes both the adenylylation and de-adenylylation of GS through activity of its adenylyl-transferase (AT) and adenylyl-removing (AR) domains, respectively. Under nitrogen limiting conditions, glnA is expressed, and GlnE's AR domain de-adynylylates GS, allowing it to be active. Under conditions of nitrogen excess, glnA expression is turned off, and GlnE's AT domain is activated allosterically by glutamine, causing the adenylylation and deactivation of GS.

Furthermore, the draT gene may also be a target for genetic variation to facilitate field-based nitrogen fixation using the methods described herein. Once nitrogen fixing enzymes are produced by the cell, nitrogenase shut-off represents another level in which cell downregulates fixation activity in high nitrogen condition. This shut-off could be removed by decreasing the expression level of DraT.

Methods for imparting new microbial phenotypes can be performed at the transcriptional, translational, and post-translational levels. The transcriptional level includes changes at the promoter (such as changing sigma factor affinity or binding sites for transcription factors, including deletion of all or a portion of the promoter) or changing transcription terminators and attenuators. The translational level includes changes at the ribosome binding sites and changing mRNA degradation signals. The post-translational level includes mutating an enzyme's active site and changing protein-protein interactions. These changes can be achieved in a multitude of ways. Reduction of expression level (or complete abolishment) can be achieved by swapping the native ribosome binding site (RBS) or promoter with another with lower strength/efficiency. ATG start sites can be swapped to a GTG, TTG, or CTG start codon, which results in reduction in translational activity of the coding region. Complete abolishment of expression can be done by knocking out (deleting) the coding region of a gene. Frameshifting the open reading frame (ORF) likely will result in a premature stop codon along the ORF, thereby creating a non-functional truncated product. Insertion of in-frame stop codons will also similarly create a non-functional truncated product. Addition of a degradation tag at the N or C terminal can also be done to reduce the effective concentration of a particular gene.

Conversely, expression level of the genes described herein can be achieved by using a stronger promoter. To ensure high promoter activity during high nitrogen level condition (or any other condition), a transcription profile of the whole genome in a high nitrogen level condition could be obtained and active promoters with a desired transcription level can be chosen from that dataset to replace the weak promoter. Weak start codons can be swapped out with an ATG start codon for better translation initiation efficiency. Weak ribosomal binding sites (RBS) can also be swapped out with a different RBS with higher translation initiation efficiency. In addition, site-specific mutagenesis can also be performed to alter the activity of an enzyme.

Increasing the level of nitrogen fixation that occurs in a plant can lead to increased crop yields, a reduction in the amount of chemical fertilizer needed for crop production, and reduced greenhouse gas emissions (e.g., nitrous oxide). Prior to planting, seeds can be overtreated with microbials that have been engineered to perform nitrogen fixation. Plant growth from such seeds can be enhanced, particularly during early to mid-season stages of plant growth, by the overtreated microbials. Further still, other overtreatments can be applied prior to planting to enhance seed viability, and in a manner such that other coatings applied to seeds remain effective.

Conventional seed treatments applied to corn seed are typically applied upstream (for example, at a seed processing facility) using batch-style treaters prior to delivery of seed to a dealer or grower. Batch treaters are thought to be less abrasive to “flat” shaped seeds such as corn seed. Such treatments can include, for example, pesticides (fungicides, insecticides, nematicides), polymers, colorants, and for certain seeds, biological agents. Seed treatments applied to soybean seed are typically applied downstream (for example, at a grower's farm or at a facility located near the grower's farm using drum-style treaters. Drum treaters are used to treat crop seeds such as soybeans, which have relatively round seeds that are amenable to tumbling and relatively uniform application of coatings. In North America crop production area, conventional coatings may be applied in December, for example, prior to seed delivery in January and planting in April, as the components of the coatings are sufficiently stable to survive the intervening several months-long period.

Corn seeds benefit from application of an overtreatment coating that includes nitrogen-fixing microbials such as gram-negative, nitrogen-fixing bacteria. However, corn seeds are considerably “flatter” in shape than soybean seeds, and are therefore less amenable to tumbling to disperse an overtreatment coating composition. Further, overtreated microbials applied to corn seeds may not be sufficiently stable to withstand more than about 90 days of pre-planting storage, and may benefit from being applied as close to planting time as possible. As a result, an enhanced method for application of a microbial based overcoating to corn seed would include overcoating application using a non-tumbling style treater at a date closer to the location (farm) where the seed would be planted.

Particularly where both upstream and downstream treatments involve the application of biological agents, the agents may compete with one another for vitality. If one agent significantly outcompetes the other, the “losing” agent may be inactive when the seed is planted. One solution to this bio-compatibility problem is to apply one or both of the agents to the seed during an overcoating treatment shortly before planting, which reduces the time that the two agents compete with one another in the seed coating.

### Seed Treatment Systems

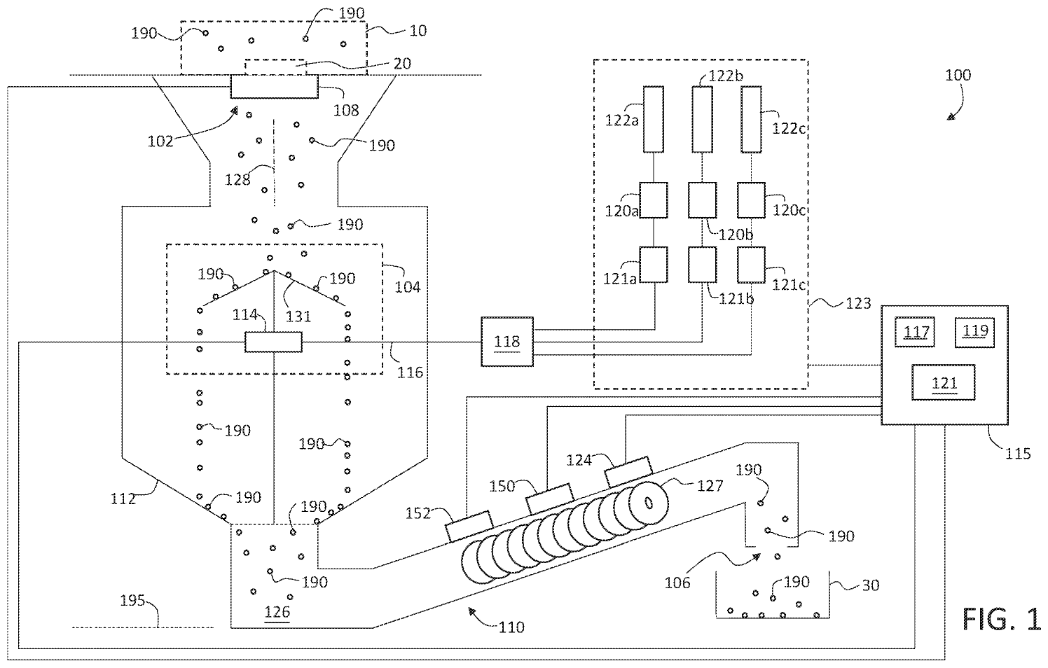

FIG. 1 is a schematic diagram of an example seed treatment system 100. System 100 includes an inlet 102, a treatment dispersal assembly 104, an outlet 106, a first transport mechanism 108, and a second transport mechanism 110.

During operation of system 100, seeds 190 stored in a seed box 10 leave the seed box through a box gate 20 and enter system 100 through inlet 102. For example, as shown in FIG. 1, the seed box 10 (storage container for seeds 190) can be mounted vertically atop system 100. Seeds 190 flow from the seed box 10 into inlet 102 through gate 20 by simply falling under the influence of gravitational force. The seeds 190 are transported by first transport mechanism 108 (which can be implemented, for example, as a seed flow metering gate) past treatment dispersal assembly 104, which applies an overtreatment to seeds 190 that includes at least one microbial. Following application of the overtreatment, the seeds are transported by second transport mechanism 110 to outlet 106, from which they are discharged, typically into a container such as seed box 30.

System 100 includes a fluid handling system 123. Fluid handling system 123 includes a mixer 118 (e.g., a static mixer), pumps 120a-c, flow meters 121a-c, and fluid reservoirs 122a-c. In FIG. 1, three pumps, flow meters, and fluid reservoirs are shown by way of illustration, but it should be appreciated that the system 100 can include any number of pumps, flow meters, and fluid reservoirs.

In certain embodiments, system 100 includes a control module 124 for second transport mechanism 110. Examples of suitable second transport mechanisms 110 and their associated control modules 124 are discussed further below.

System 100 includes a controller 115 that generally regulates operation of multiple components of the system during the application of the overtreatment to seeds 190. Controller 115 includes one or more electronic processors 121, one or more display devices 117, and one or more interfaces 119 through which an operator of system 100 can transmit instructions to system 100 to adjust or control various parameters, steps, and other aspects of system operation. Although a single controller 115 is shown in FIG. 1, it should be appreciated that the control operations described in connection with system 100 can be implemented by multiple controllers, and system 100 can include more than one controller 115, with each controller performing a subset of the operations described. However, for simplicity, the following discussion will refer to a single controller 115.

As shown in FIG. 1, controller 115 can be connected via one or more control lines to various components of system 100. For example, controller 115 is connected to first transport mechanism 108 to adjust the first transport mechanism, and to control module 124 of second transport mechanism 110 to adjust the second transport mechanism. Controller 115 is also connected to fluid handling system 123, and in particular, to mixer 118, to pump 120a-c, and to flow meter 121a-c, to regulate the delivery of fluid compositions to treatment dispersal assembly 104. Controller 115 is further connected to treatment dispersal assembly 104 to adjust the manner in which the overtreatment is applied to seeds 190, as described in further detail below.

Inlet 102 is typically implemented as an aperture in a housing 112 of system 100. Housing 112 can generally surround and contain any one or more of the components of system 100, and can be implemented in modular form as multiple housings secured together, or as a unitary housing. A variety of different materials are suitable for housing 112, including but not limited to metals such as steel and aluminum, and plastics.

As shown in FIG. 1, a portion of housing 112 is typically cone-shaped between inlet 102 and collection region 126 of system 100. The angled lateral surfaces of the cone-shaped region of housing 112 direct seeds 190, to which the overtreatment has been applied, into collection region 126, from which the overtreated seeds 190 are transported by a seed-transporting mechanism 127 (for example, an auger or conveyor) through the second transport mechanism 110 exiting the system 100 through the outlet 106.

In some embodiments, first transport mechanism 108 is implemented as a seed flow metering gate or other flow regulation device connected to, and regulated by, controller 115. As shown in FIG. 1, first transport mechanism 108 is located vertically above treatment dispersal assembly 104, relative to a ground surface 195 that supports system 100. Accordingly, when the seed flow metering device or other flow regulation device of first transport mechanism 108 is opened by controller 115, seeds 190 fall under the influence of gravity past treatment dispersal assembly 104 to the collection region 126 of system 100. Controller 115 can regulate the rate at which seeds 190 are introduced into system 100 by adjusting the cross-sectional area of the aperture in the seed flow metering gate or other flow regulation device of first transport mechanism 108.

In certain embodiments, treatment dispersal assembly 104 includes an atomizer 114 connected to mixer 118 via a conduit 116. Atomizer 114 is also connected to controller 115 via a control line. During operation of system 100, one or more fluids from reservoirs 122a-c are pumped by pumps 120a-c through flow meters 121a-c and into mixer 118, where the fluids are mixed to form an overtreatment composition. The overtreatment composition is delivered from mixer 118 into atomizer 114 through conduit 116.

The volumes of fluids entering mixer 118 are regulated by controller 115, which adjusts flow meters 121a-c to adjust the rate at which fluids enter mixer 118 and are delivered to atomizer 114. In some embodiments, controller 115 synchronizes the flow rate of seeds 190 entering system 100 (by controlling first transport mechanism 108) and the amount of various fluids delivered from reservoirs 122a-c into atomizer 114 so that the amount of overtreatment that is applied to seeds 190 is carefully controlled and consistent. For example, system 100 can include a scale or other mass sensor (not shown in FIG. 1) connected to controller 115 that transmits information about the mass of seeds 190 in seed box 10 to controller 115. Using this mass information, controller 115 determines a rate at which seeds 190 enter system 100 from seed box 10 (i.e., by determining a loss-of-mass rate from seed box 10) and adjusts flow meters 121a-c to ensure that the amounts of fluids delivered from mixer 118 and to the atomizer 114 per unit time are precisely controlled for the rate at which seeds enter system 100. In this manner, appropriate volumes of fluids can be introduced into reservoirs 122a-c prior to initiating treatment of a box of seeds, and controller 115 automatically controls the rate at which the fluids are mixed and applied to the seeds so that the exact volumes of fluids introduced are dispersed evenly onto the seeds, with no waste of fluids and/or uneven seed overtreatment.

In FIG. 1, components—typically in fluidized form (e.g., solutions, suspensions)—are combined in mixer 118 to form an overtreatment that is applied to seeds 190 as described above. As will be discussed in more detail subsequently, the overtreatment that is prepared in mixer 118 can include one or more microbial agents, one or more extenders, and any of the other agents and components described herein. In some embodiments, once the overtreatment is prepared in mixer 118, the overtreatment is delivered directly to atomizer 114. In certain embodiments, flow of the prepared overtreatment to the atomizer is regulated by a flow meter positioned between mixer 118 and atomizer 114 (not shown in FIG. 1). This flow meter can be connected to and controlled by controller 115, in a manner similar to flow meters 121a-c.

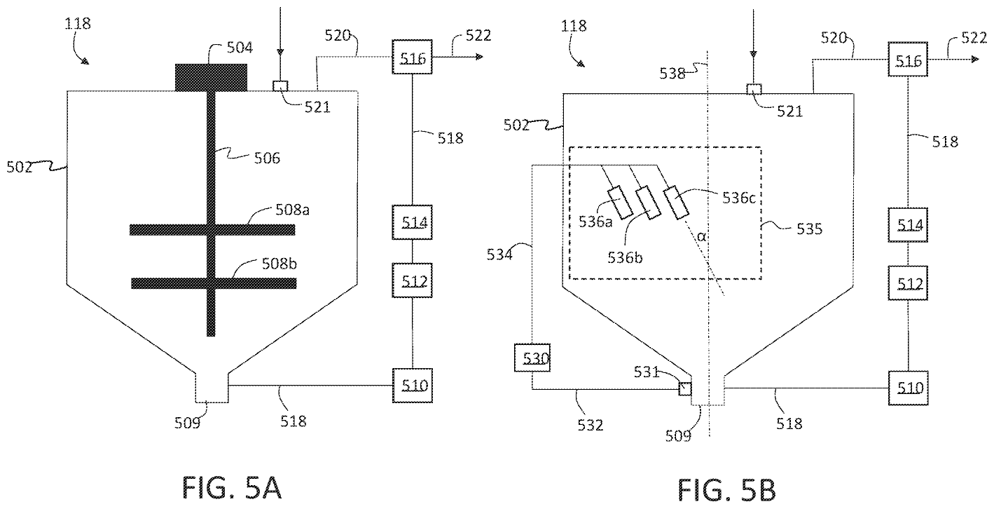

Mixer 118 can be implemented in various ways. FIG. 5A shows one example of a mixer 118 that includes multiple rotating vanes or propellers to mix seed treatment components. As shown in FIG. 5A, mixer 118 features a mixing reservoir that includes a tank 502 and one or more inlets 521 connected to tank 502. Inlets 521 are connected are connected to fluid handling system 123 and configured to receive seed treatments components from fluid handling system 123. In general, the seed treatment components received from fluid handling system 123 are liquid components, suspensions, emulsions, extenders, microbials, and similar components and substances in fluid form as solutions, suspensions, and other fluid-based mixtures. In some embodiments, one or more inlets 521 can also be configured to receive solid seed treatment components such as powders, crystallites, and other solid components consisting of one or more particulate constituents. For example, one or more microbials may be delivered into mixer 118 is solid form.

Mixer 118 also includes vanes 508a-508b connected to a rotating shaft 506 that is in turn connected to a motor 504. Although the example mixing reservoir in FIG. 5A includes two vanes, more generally the reservoir can include any number (e.g., one or more, two or more, three or more, four or more, five or more, seven or more, 10 or more, or even more) of vanes connected to shaft 506. During operation, seed treatment components enter tank 502 through inlets 521 (and/or are recirculated back into tank 502) and are mixed by the rotating vanes, ensuring that the components are intermingled with one another. The mixture exits tank 502 through outlet 509 and enters conduit 518.

Mixer 118 can optionally include an in-line filter (e.g., a mesh screen) 510 through which the mixture of seed treatment components passes. In-line filter 510 can be selected to remove aggregates of solid seed treatment components, debris, and other contaminants from the mixture of seed treatment components.

The mixture then passes through pump 512. A variety of different pumps can be used to circulate the seed mixture after it has been removed from tank 502. In some embodiments, for example, a peristaltic pump can be used as pump 512. Peristaltic pumps can provide certain advantages depending upon the composition of the seed treatment mixture. For example, in seed treatment mixtures that include suspended solids, peristaltic pumps can—in some circumstances circulate such mixtures more efficiently than other types of pumps that are better suited to the circulation of homogeneous liquids.

Mixer 118 can optionally include a flow meter 514. Flow meter 514 measures the flow through rate of the seed treatment mixture circulated by pump 512. In general, motor 504, pump 512, and flow meter 514 can each be connected to controller 115 through individual control lines (not shown in FIG. 5A for clarity). Controller 115 can regulate the mixing rate of the seed treatment components in tank 502 by adjusting the rotation rate of vanes 508a-508c by transmitting suitable control signals to motor 504.

Controller 115 can also control the recirculation rate of the seed treatment mixture by adjusting pump 512 through suitable control signals transmitted to pump 512. In particular, as will be explained in more detail below, controller 115 can adjust the rate at which the seed treatment mixture is recirculated back into tank 502 by adjusting the pumping rate of pump 512. Adjustments to the pumping rate of pump 512 can be performed by controller 115 based at least in part on flow rate information measured by flow meter 514 and transmitted to controller 115.

Mixer 118 also includes a valve 516 that is connected to controller 115. Valve 516 can be configured by controller 115, via suitable control signals transmitted from controller 115 to valve 516, to direct the incoming seed treatment mixture in conduit 518 into either conduit 520 or conduit 522. To ensure that the components of the mixture are thoroughly and homogeneously mixed, controller 115 can adjust valve 516 to recirculate the seed treatment mixture through tank 502 for an extended period of time. In some embodiments, for example, the seed treatment mixture can be mixed and recirculated through tank 502 for a time of 0.25 minutes or more (e.g., 0.5 minutes or more, 1.0 minutes or more, 1.5 minutes or more, 2.0 minutes or more, 2.5 minutes or more, 3.0 minutes or more, 4.0 minutes or more, 5.0 minutes or more, or even more).

In general, vanes 508a and 508b can rotate in either direction about the axis of shaft 506. That is, motor 504—under the control of controller 115—can adjust the direction and rate of rotation of vanes 508a and 508b to control the extent of mixing of various components delivered into tank 502. In some embodiments, components delivered into tank 502 are mixed simply by rotating vanes 508a and 508b in one direction for a period of time.

However, it has also been discovered that to ensure proper mixing of the components in certain complex mixtures (e.g., to prepare a suitable overtreatment for seeds), a more complex mixing procedure is advantageous. In particular, mixing can be implemented in one or more mixing cycles in which vanes 508a and 508b are first rotated in one direction for a first time period, and then rotated in a second direction (opposite the first direction) for a second time period. Each period of rotation in one direction followed by a period of rotation in the opposite direction is a “mixing cycle”.

In some embodiments, the first and second periods of time within a cycle are the same. In certain embodiments, the first and second periods of time are different. Each of the first and second time periods can be independently 1.0 second or more (e.g., 2.0 seconds or more, 3.0 seconds or more, 4.0 seconds or more, 5.0 seconds or more, 6.0 seconds or more, 7.0 seconds or more, 8.0 seconds or more, 9.0 seconds or more, 10 seconds or more, 15 seconds or more, 20 seconds or more, 30 seconds or more, or even more).

In certain embodiments, only one mixing cycle is used to mix components delivered into mixer 118. In some embodiments, however, multiple mixing cycles are used. Each mixing cycle—consisting of both a first period of rotation of vanes 508a and 508b in one direction about shaft 506 and a second period of rotation of vanes 508a and 508b in a second, opposite direction about shaft 506—can occur for the same total time period, or alternatively, some or all different mixing cycles can occur for different total time periods. The total number of mixing cycles can be 1 or more (e.g., 2 or more, 3 or more, 4 or more, 5 or more, 6 or more, 7 or more, 8 or more, 9 or more, 10 or more, or even more).

In some embodiments, a subsequent mixing cycle begins as soon as an immediately prior mixing cycle ends. In certain embodiments, a resting period occurs between the end of one or more mixing cycles and the beginning of the next sequential mixing cycle. Resting periods between sequential mixing cycles can be the same, or alternatively, resting periods between certain pairs of mixing cycles can be different. Each resting period can be independently 0.1 seconds or more (e.g., 0.2 seconds or more, 0.3 seconds or more, 0.5 seconds or more, 0.7 seconds or more, 1.0 seconds or more, 1.5 seconds or more, 2.0 seconds or more, 2.5 seconds or more, 3.0 seconds or more, 4.0 seconds or more, 5.0 seconds or more, 7.0 seconds or more, 10.0 seconds or more, or even more).

In certain embodiments, resting periods can occur within any one or more mixing cycles in addition to, or alternatively to, resting periods between mixing cycles. For example, after rotating vanes 508a and 508b in one direction for a first time period, and prior to rotating vanes 508a and 508b in the opposite direction for a second time period, a resting period can occur during which vanes 508a and 508b do not rotate about the axis of shaft 506. Resting periods within individual mixing cycles can be the same or different, and certain mixing cycles may include resting periods while others do not. Each resting period within an individual mixing cycle can independently occur for 0.1 seconds or more (e.g., 0.2 seconds or more, 0.3 seconds or more, 0.5 seconds or more, 0.7 seconds or more, 1.0 seconds or more, 1.5 seconds or more, 2.0 seconds or more, 2.5 seconds or more, 3.0 seconds or more, 4.0 seconds or more, 5.0 seconds or more, 7.0 seconds or more, 10.0 seconds or more, or even more).

Within each mixing cycle, in some embodiments, vanes 508a and 508b can be rotated at the same rotation rate about the axis of shaft 506 in both directions. Alternatively, in certain embodiments, vanes 508a and 508b can be rotated at different rates in opposite directions about the axis of shaft 506. Similarly, when multiple mixing cycles are used to mix components delivered into mixer 118, the rotation rates in the multiple mixing cycles (in either or both directions of rotation) can be the same or different. In other words, the rotation rate of vanes 508a and 508b in each direction in each individual mixing cycle can be independently selected to achieve mixing uniformity and efficiency. For example, the rotation rate of vanes 508a and 508b can be 1000 revolutions per minute (RPM) about shaft 506 or more (e.g., 1200 RPM or more, 1400 RPM or more, 1600 RPM or more, 1800 RPM or more, 2000 RPM or more, 2200 RPM or more, 2400 RPM or more, 2600 RPM or more, 2800 RPM or more, 3000 RPM or more, or even more).

After mixing of the seed treatment components is complete, controller 115 extracts the seed treatment mixture from mixer 118 by adjusting valve 516 to direct the mixture into conduit 522. In general, conduit 522 is connected directly or indirectly to atomizer 114, and the seed treatment mixture prepared in mixer 118 is dispersed onto seeds by the atomizer.

FIG. 5A shows one example of a mixer 118. In general, mixer 118 can be implemented in a number of ways. FIG. 5B shows another examiner of a mixer 118 that includes an additional recirculation mechanism to further ensure that the components of a seed treatment mixture are thoroughly mixed prior to dispersal on seeds.

Many of the component of mixer 118 in FIG. 5B are similar to corresponding components of mixer 118 in FIG. 5A, and are given the same reference numbers. As in FIG. 5A, the mixing reservoir of mixer 118 in FIG. 5B includes a tank 502 having a central axis 538, and one or more inlets 521 that are configured to receive liquid and/or solid seed treatment components. However, mixer 118 in FIG. 5B does not include rotating vanes. Instead, mixer 118 includes a mixing mechanism featuring an inlet 531 in fluid communication with outlet 509 of tank 502, a pump 530 in fluid communication with inlet 531 via conduit 532, and a recirculation mechanism 535 in fluid communication with pump 530 via conduit 534. In general, at least a portion of recirculation mechanism 535 is positioned within tank 502, and in some embodiments, as shown in FIG. 5B, the entire recirculation mechanism 535 is positioned in tank 502.

In the embodiment shown in FIG. 5B, recirculation mechanism 535 includes a plurality of outlets 536a-536c. For purposes of illustration, recirculation mechanism 535 includes three outlets 536a-536c in FIG. 5B. More generally, however, recirculation mechanism 535 can include two or more (e.g., three or more, four or more, five or more, six or more, seven or more, eight or more, nine or more, 10 or more, 12 or more, 15 or more, 20 or more, or even more) outlets.

To ensure efficient mixing of the seed treatment components to form a mixture suitable for dispersal onto seeds, it has been discovered that it can be advantageous to orient one or more of the outlets 536a-536c at an angle with respect to axis 538 of tank 502. As shown in FIG. 5B, the angle of inclination of the central axis of any of the outlets 536a-536c with respect to axis 538 is a.

In general, for any one or more of the outlets of recirculation mechanism 535, a can be 20 degrees or more (e.g., 25 degrees or more, 30 degrees or more, 35 degrees or more, 40 degrees or more, 45 degrees or more, 50 degrees or more, 55 degrees or more, 60 degrees or more, 65 degrees or more, 70 degrees or more, or even more). For any one or more of the outlets of recirculation mechanism 535, a can be 80 degrees or less (e.g., 75 degrees or less, 70 degrees or less, 65 degrees or less, 60 degrees or less, 55 degrees or less, 50 degrees or less, 45 degrees or less, 40 degrees or less, 35 degrees or less, 30 degrees or less, or even less). For any one or more of the outlets of recirculation mechanism 535, a can be between 20 degrees and 70 degrees (e.g., between 20 degrees and 65 degrees, between 25 degrees and 65 degrees, between 25 degrees and 60 degrees, between 30 degrees and 60 degrees, between 30 degrees and 55 degrees, between 35 degrees and 55 degrees).

In general, recirculation mechanism 535 includes at least one outlet that is inclined at an angle relative to axis 538. In some embodiments, as shown in FIG. 5B, each of the outlets 536a-536c is inclined relative to axis 538. In certain embodiments, one or more of the outlets of recirculation mechanism 535 is inclined relative to axis 538, and one or more of the outlets of recirculation mechanism 535 is oriented parallel to axis 538 (i.e., α=0). In some embodiments, one or more of the outlets of recirculation mechanism 535 can be oriented perpendicular to axis 538 (i.e., α=90 degrees).

The number of outlets of recirculation mechanism 535 that are inclined relative to axis 538, as a percentage of the total number of outlets of recirculation mechanism 535, can be 20% or more (e.g., 30% or more, 40% or more, 50% or more, 60% or more, 70% or more, 80% or more, 90% or more, or even more). In some embodiments, the number of outlets of recirculation mechanism 535 that are inclined relative to axis 538 is one or more (e.g., two or more, three or more, four or more, five or more, six or more, seven or more, eight or more, nine or more, 10 or more, or even more).

The outlets of recirculation mechanism 535 can generally be positioned at a variety of locations within tank 502 to ensure efficient mixing of seed treatment components introduced into the tank. For example, in some embodiments, one or more (e.g., two or more, three or more, four or more, five or more, six or more, seven or more, eight or more, nine or more, 10 or more, or even more) of the outlets can be positioned along a wall (e.g., an outer, lateral wall) of the tank. In certain embodiments, each of the plurality of outlets of recirculation mechanism 535 is positioned along a lateral wall of tank 502. In some embodiments, one or more outlets are positioned along a lateral wall of tank 502, and one or more (e.g., two or more, three or more, four or more, five or more, six or more, seven or more, eight or more, nine or more, 10 or more, or even more) outlets are positioned in an interior region of tank 502, e.g., within ⅔ of the radius of tank 502 from axis 538.

In general, tank 502 can have a variety of shapes. In some embodiments, for example, tank 502 is cylindrical in shape or includes a cylindrical portion. In certain embodiments, tank 502 is conical in shape or includes a conical portion. More generally, in some embodiments, tank 502 includes a curved lateral wall as shown in FIG. 5B. At least a portion of the curved lateral wall is curved about axis 538. In certain embodiments, a portion (or all) of a lateral wall can be inclined relative to axis 538. The inclined portion of the lateral wall can be curved about axis 538 (e.g., the conical portion of the wall of tank 502 in FIG. 5B) or not curved about axis 538.

During operation of mixer 118 in FIG. 5B, at least a portion of the seed treatment mixture in tank 502 is captured by inlet 531 as the seed treatment mixture enters outlet 509. The captured seed treatment mixture is directed through conduit 532 to pump 530. In turn, pump 530 is configured to direct the captured portion of the seed treatment mixture into recirculation mechanism 535 via conduit 534.

Pump 530 is connected to controller 115 via one or more control lines (not shown in FIG. 5B for clarity). Controller 115 can adjust the pumping rate of pump 530, and therefore the recirculation rate of the seed treatment mixture through the recirculation mechanism. A variety of different pumps can be used as pump 530. In some embodiments, for example, pump 530 is a centrifugal pump.

When the captured portion of the seed treatment mixture enters recirculation mechanism 535, the recirculation mechanism is configured to deliver the captured seed treatment mixture into tank 502 through outlets 536a-536c. In some embodiments, multiple outlets of the recirculation mechanism are not only inclined relative to axis 538, but are also helically oriented relative to axis 538. As a result, the captured portion of the seed treatment mixture is introduced into tank 502 in a fluid vortex induced by simultaneous flow of portions of the seed treatment mixture through outlets 536a-536c into tank 502.

In some embodiments, each of the outlets of recirculation mechanism 535 is oriented at a common angle with respect to axis 538, as shown in FIG. 5B. More generally, however, certain outlets of recirculation mechanism 535 can be oriented at a different angle with respect to axis 538 than other outlets of recirculation mechanism 535. For example, in certain embodiments, a first group of one or more (e.g., two or more, three or more, four or more, five or more, six or more, seven or more, eight or more, nine or more, 10 or more, or even more) outlets can be oriented at a first angle with respect to axis 538, and a second group of one or more (e.g., two or more, three or more, four or more, five or more, six or more, seven or more, eight or more, nine or more, 10 or more, or even more) outlets can be oriented at a second angle with respect to axis 538 that is different from the first angle. The number of groups of outlets oriented at different angles in recirculation mechanism 535 can be two or more (e.g., three or more, four or more, five or more, six or more, seven or more, eight or more, nine or more, 10 or more, or even more).

As discussed above, pump 530 and recirculation mechanism 535 can be adjusted to control the rate at which captured portions of the seed treatment mixture are recirculated back into tank 502. For example, in certain embodiments, the recirculation rate is at least 1.5 gallons per minute (e.g., at least 1.6 gallons per minute, at least 1.7 gallons per minute, at least 1.8 gallons per minute, at least 1.9 gallons per minute, at least 2.0 gallons per minute, at least 2.1 gallons per minute, at least 2.2 gallons per minute, at least 2.3 gallons per minute, at least 2.4 gallons per minute, at least 2.5 gallons per minute, at least 3.0 gallons per minute, at least 4.0 gallons per minute, at least 5.0 gallons per minute, at least 6.0 gallons per minute, at least 7.0 gallons per minute, at least 8.0 gallons per minute, at least 9.0 gallons per minute, at least 10.0 gallons per minute, at least 11.0 gallons per minute, at least 12.0 gallons per minute, at least 13.0 gallons per minute, at least 14.0 gallons per minute, at least 15.0 gallons per minute, at least 16.0 gallons per minute, at least 18.0 gallons per minute, at least 20.0 gallons per minute). In some embodiments, the recirculation rate is between 8.0 and 20.0 gallons per minute (e.g., between 8.0 and 18.0 gallons per minute, between 10.0 and 18.0 gallons per minutes, between 10.0 and 15.0 gallons per minute). In certain embodiments, the recirculation rate can be between any of the numerical recirculation rates described herein.

Mixer 118 in FIG. 5B can also mix seed treatment components delivered into tank 502 using counter-rotation of the components. As discussed above in connection with FIG. 5A, particularly when the components consist of both fluid components and solid components, counter-rotation of the components can ensure more thorough and efficient mixing. Counter-rotation of the components within tank 502 can be achieved in various ways. In some embodiments, for example, the orientation of outlets 536a-536c can be adjusted by controller 115, e.g., via actuators (not shown in FIG. 5B) connected to each of the outlets and controlled by controller 115. Controller 115 is thus configured to adjust the angle of the outlets relative to axis 538, and also control the direction of circulation (e.g., clockwise or counter-clockwise) about axis 538 of a seed treatment mixture directed into tank 502 through outlets 536a-536c.

In other words, controller 115 can reverse the direction of vortex circulation of components within tank 502 by adjusting the angular orientation of outlets 536a-536c. In this manner, circulation can be changed between clockwise and counter-clockwise directions by controller 115. Thus, in some embodiments, mixing can be achieved by first directing recirculated seed treatment mixture into tank 502 such that the mixture undergoes vortex rotation in a first direction (e.g., clockwise) for a first time period, and then directing recirculated seed treatment mixture into tank 502 such that the mixture undergoes vortex rotation in a second direction (e.g., counter-clockwise) for a second time period. Controller 115 changes the angular orientation of outlets 536a-536c to change the direction of vortex rotation in tank 502.

In general, the first and second time periods can be the same or different, and can each independently be 1.0 second or more (e.g., 2.0 seconds or more, 3.0 seconds or more, 4.0 seconds or more, 5.0 seconds or more, 6.0 seconds or more, 7.0 seconds or more, 8.0 seconds or more, 9.0 seconds or more, 10 seconds or more, 15 seconds or more, 20 seconds or more, 30 seconds or more, or even more). Between the first and second time periods, a resting period can occur during which seed treatment mixture is not delivered into tank 502 through outlets 536a-536c, or alternatively, seed treatment mixture is delivered into tank 502 at an angle α such that little or no vortex rotation occurs within tank 502 (i.e., a is approximately zero). The resting period can be 0.1 seconds or more (e.g., 0.2 seconds or more, 0.3 seconds or more, 0.5 seconds or more, 0.7 seconds or more, 1.0 seconds or more, 1.5 seconds or more, 2.0 seconds or more, 2.5 seconds or more, 3.0 seconds or more, 4.0 seconds or more, 5.0 seconds or more, 7.0 seconds or more, 10.0 seconds or more, or even more).

In some embodiments, mixing within tank 502 of FIG. 5B can be performed in multiple cycles, with each cycle consisting of delivery of seed treatment mixture into tank 502 through outlets 536a-536c for a first period of time at an angle such that the seed treatment mixture undergoes vortex rotation about axis 538 in the clockwise direction, followed by an optional resting period, and then delivery of seed treatment mixture into tank 502 through outlets 536a-536c for a second period of time at an angle such that the seed treatment mixture undergoes vortex rotation about axis 538 in the counter-clockwise direction. An optional resting period (of length as discussed above) can follow each cycle.

As discussed above in connection with FIG. 5A, mixing cycles can have the same or different total durations, and the same or different resting periods can occur between cycles. The durations of vortex rotation in both clockwise and counter-clockwise directions can be the same or different among multiple cycles. In general, the number of mixing cycles can be 1 or more (e.g., 2 or more, 3 or more, 4 or more, 5 or more, 6 or more, 7 or more, 8 or more, 9 or more, 10 or more, or even more). Other aspects of the mixing cycles implemented by mixer 118 in FIG. 5B are similar to the mixing cycles described above in connection with FIG. 5A.

Mixing by counter-rotation of seed treatment components can also be performed in other ways. For example, in some embodiments, the outlets of recirculation mechanism 535 can include a first group of outlets oriented within tank 502 such that seed treatment mixture directed into tank 502 through the first group of outlets will circulate in tank 502 in a first vortex direction relative to axis 538 (e.g., clockwise), and a second group of outlets oriented within tank 502 such that seed treatment mixture directed into tank 502 through the second group of outlets will circulate in tank 502 in a second, opposite vortex direction relative to axis 538 (e.g., counter-clockwise). Recirculation mechanism 535 can also include a multi-way valve (not shown in FIG. 5B) controlled by controller 115, which allows controller 115 to selectively direct the recirculated seed treatment mixture into either the first or second group of outlets.

In this manner, controller 115 can reverse the direction of vortex circulation in tank 502 by directing the recirculated seed treatment mixture into different outlets of recirculation mechanism 535. Mixing can thus be performed using counter-propagating circulation of the mixture, in one or more mixing cycles, as described above. The attributes associated with mixing in this manner (e.g., time periods, number of cycles, etc.) can be the same as the attributes discussed above in connection with the use of adjustable outlets for mixing of recirculated seed treatment components.

In some embodiments, mixing features of both FIGS. 5A and 5B can be combined in a single mixer 118. For example, a mixer 118 can include vanes 508a-508b, a motor 504, and a shaft 506 as described in connection with FIG. 5A, and a recirculation mechanism 535 as described in connection with FIG. 5B. Aspects of these features from FIGS. 5A and 5B, when combined in a mixer 118, are typically the same as discussed above in connection with FIGS. 5A and 5B.

In a mixer that includes both vanes 508a-508b and recirculation mechanism 535, mixing of seed treatment components can be performed by both 508a-508b and recirculation mechanism 535, or alternatively, largely by vanes 508a-508b, e.g., by selecting the angle α and/or recirculation flow rate such that induced vortex circulation due solely to recirculation mechanism 535 is small compared with the vortex circulation induced by vanes 508a-508b. It should be understood that the embodiments shown in FIGS. 5A and 5B are merely examples of mixers 118, and that components of both embodiments can generally be freely combined to yield other embodiments of mixers that include combinations of the components, all of which are envisioned by this disclosure.

Returning to FIG. 1, atomizer 114 includes a plurality of apertures and typically rotates about an axis 128 that is parallel to a central axis of the cone-shaped portion of housing 112. Controller 115 can adjust the rate of rotation of atomizer 114, thereby regulating the rate at which the overtreatment composition is discharged from atomizer 114 and applied to seeds 190.

In some embodiments, treatment dispersal assembly 104 includes a seed dispersal member 131. Seed dispersal member 131 can generally be implemented in a variety of ways. In certain embodiments, seed dispersal member 131 can be implemented as an inverted cone-shaped member positioned such that the outer surfaces of the member effectively guide falling seeds from inlet 102.

As shown in FIG. 1, during application of an overtreatment composition to seeds 190, the seeds 190 fall under gravity and are intercepted by seed dispersal member 131. The seed trajectories follow the surface contours of seed dispersal member 131, rolling or sliding along the angled surfaces until they reach the rim of the cone-shaped member 131, at which point the seeds 190 fall vertically downward again. The effect of seed dispersal member 131 is to create a cylindrical “sheet” or “curtain” of falling seed in the vicinity of atomizer 114 that is approximately one seed thick. Accordingly, when the overtreatment composition is discharged by atomizer 114, each falling seed is effectively coated with the composition. By ensuring that the “sheet” of falling seed is approximately one seed layer in thickness, system 100 ensures that the overtreatment composition is evenly dispersed with high uniformity onto each of the seeds.

Second transport mechanism 110 can generally be implemented in a variety of ways in system 100. In some embodiments, as shown in FIG. 1, second transport mechanism 110 includes a seed transporting mechanism 127 (e.g., a belt conveyor system) through which seeds are transported from the collection area 126, and control module 124 includes an actuator (for example, a motor) that controls the rate at which the seed transporting mechanism 127 runs, and therefore, the rate at which overtreated seeds 190 are transported from collection region 126 to outlet 106. In turn, control module 124 is connected to controller 115 so that controller 115 can adjust the transport rate of seeds 190 to outlet 106 from collection region 126.

In certain embodiments, second transport mechanism 110 can be implemented as a belt conveyor, and control module 124 can include (or be connected to) a motor or other actuator that controls the linear translation rate of the belt conveyor. As above, controller 115—by virtue of its connection to control module 124—can adjust the linear translation rate of the belt conveyor, and therefore the rate at which overtreated seeds 190 are transported from the collection region 126 to outlet 106.

Seeds 190 that are exposed to the overtreatment composition discharged by treatment dispersal assembly 104 typically arrive at collection region 126 “wet”—that is, with an overtreatment coating that has not fully dried. Ensuring that the overtreatment coating (and any other coatings applied by system 100) are dry before the seeds are discharged from outlet 106 into a storage container (e.g., seed box 30, and sometimes subsequently back into seed box 10) ensures that the overtreated seeds do not stick to one another, and do not experience moisture-based rot or decay during the period of time between overtreatment and planting. The overtreated seeds are dried during the course of their transport by the seed transporting mechanism 127 within the second transport mechanism 110. Accordingly, by adjusting the transport rate of overtreated seeds 190 between collection region 126 and outlet 106, controller 115 can adjust the drying time of the seeds in the second transport mechanism 110.

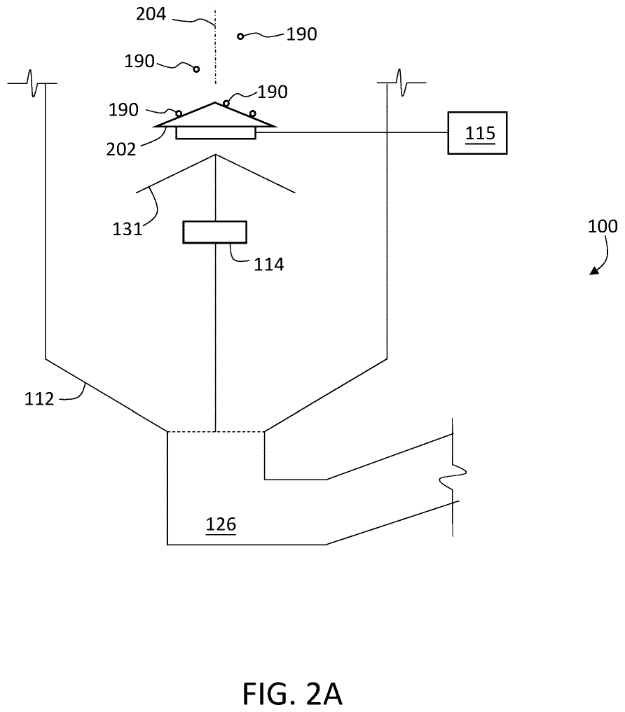

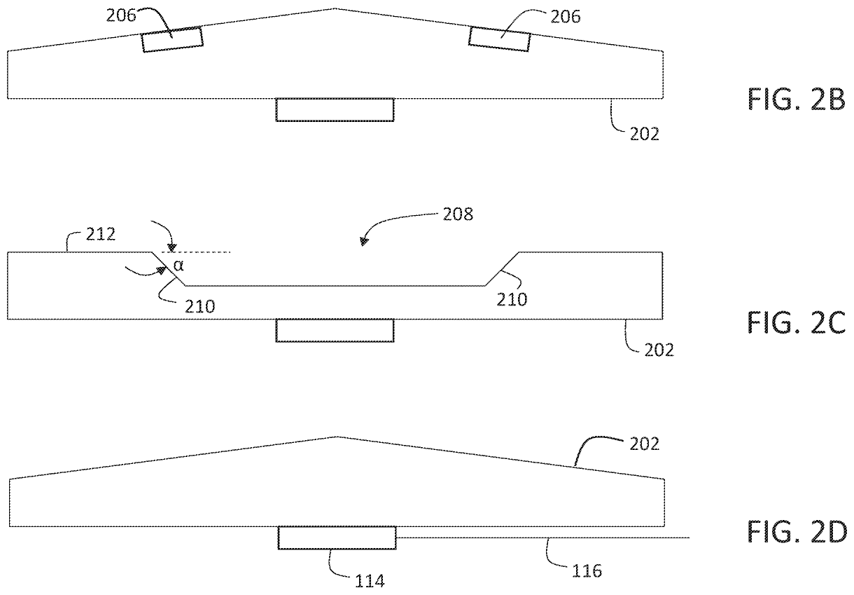

In some embodiments, system 100 can optionally include a support member for seeds 190 within housing 112 and assists the exposure of the seeds to the overtreatment composition discharged by the treatment dispersal assembly 104. The support member can optionally replace seed dispersal member 131 in FIG. 1, or can be present in addition to seed dispersal member 131. FIG. 2A is a schematic diagram showing a portion of an example of system 100. In addition to some of the components shown in FIG. 1, system 100 in FIG. 2A includes a support member 202 that supports seeds 190 after the seeds have fallen from inlet 102. Support member 202 can be implemented as a flat plate or a plate with inclined surfaces (e.g., a shallow cone), for example, that supports seeds 190.

In some embodiments, support member 202 optionally rotates about an axis 204 that is parallel to an axis of the cone-shaped portion of housing 112. Support member 202 is connected to controller 115, and controller 115 can adjust the rate at which support member 202 rotates. As support member 202 rotates, seeds 190 that land on the support member are transported radially outward from the center of support member 202 by centripetal acceleration, eventually falling from support member 202.

In certain embodiments, support member 202 is displaceable in the vertical direction in FIG. 2A, e.g., in a direction parallel to axis 204. Controller 115 can initiate displacement of support member 202 in the vertical direction by a controlled amount. Displacements of support member 202 under the control of controller 115 can occur periodically, alternating with stationary periods involving no vertical displacement. Alternatively, controller 115 can continuously displace support member 202 vertically (e.g., up and down in FIG. 2) during seed treatment.

In some embodiments, support member 202 includes one or more recesses or grooves into which seeds 190 fall after they are admitted into housing 112 by first transport mechanism 108. FIG. 2B is a schematic cross-sectional diagram of an example of support member 202 that includes one or more recesses 206. In general, recesses 206 can have axes that are oriented circumferentially, radially, or in any direction along the surface of support member 202. Further, support member 202 can generally have one or more (e.g., two or more, three or more, four or more, five or more, six or more, eight or more, ten or more, or even more) recesses. The recesses can have the same or different lengths, cross-sectional shapes, and cross-sectional dimensions.

In certain embodiments, one or more of the recesses can have lateral walls that are orthogonal with respect to the seed-supporting surface of support member 202 as shown in FIG. 2B. In some embodiments, one or more of the recesses can have lateral walls that are inclined relative to the seed-supporting surface of support member 202. FIG. 2C is a schematic cross-sectional diagram of an example of a support member 202 that includes one or more recesses 208 with lateral walls that are inclined at an angle a with respect to the seed supporting surface 212 of support member 202. In general, angle a can be from 1 degree or more (e.g., 2 degrees or more, 5 degrees or more, 10 degrees or more, 15 degrees or more, 20 degrees or more, 25 degrees or more, 30 degrees or more, 35 degrees or more, 40 degrees or more, 45 degrees or more, 50 degrees or more, 55 degrees or more, 60 degrees or more, 65 degrees or more, 70 degrees or more, 75 degrees or more, 80 degrees or more, 85 degrees or more), or any range of angles between any two of the values of a described herein.

Although treatment dispersal assembly 104 (and specifically, atomizer 114) is a separate component from support member 202 in FIG. 2A, in some embodiments, the treatment dispersal assembly can be integrated into the support member. FIG. 2D is a schematic diagram showing a support member 202 into which atomizer 114 of treatment dispersal assembly 104 is integrated.

Atomizer 114 in FIG. 2D generally functions in a manner similar to atomizer 114 in FIG. 1 described above. In FIG. 2D, support member 202 replaces seed dispersal member 131 shown in FIG. 1.

In some embodiments, the support member 202 of system 100 can optionally be implemented as a scattering mechanism for dispersing seeds 190 as they fall from inlet 102. The scattering mechanism can replace seed dispersal member 131 shown in FIG. 1, or can be used together with seed dispersal member 131.

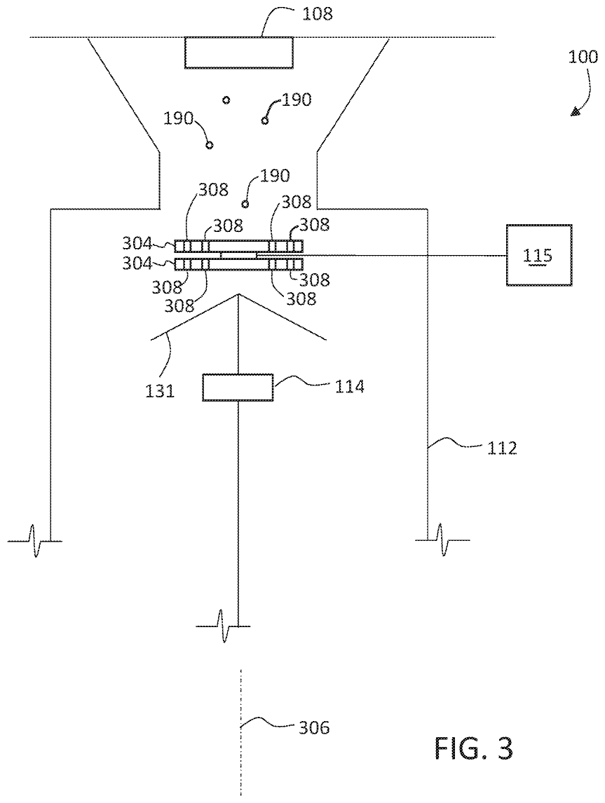

FIG. 3 is a schematic diagram of a portion of an example system 100 that includes a scattering mechanism 302 connected to controller 115. In FIG. 3, scattering mechanism 302 consists of two members 304 with a plurality of apertures 308 extending through each member. One or both of members 304 rotates about axis 306 under the control of controller 115, which adjusts the rate of rotation to control the rate at which seeds 190 pass through scattering mechanism 302. During operation, as seeds 190 are admitted by first transport mechanism 108 into housing 112, the seeds fall onto the top member 304. Seeds that are aligned with one of the apertures 308 in the top member fall onto the bottom member 304. In turn, seeds that are aligned with one of the apertures 308 in the bottom member pass through the bottom member and fall towards treatment dispersal assembly 104.

The arrangement and sizes of the apertures formed in members 304 can generally be selected to achieve a particular spatial distribution and throughput of seeds 190 falling past treatment dispersal assembly 104. A wide variety of different combinations of aperture positions and sizes in members 304 can be used. In some embodiments, for example, the number and/or cross-sectional area of apertures 308 increases in a radial direction outward from a center of one or both of the members 304 to disperse seeds 190 away from the central axis of the conical portion of housing 112.

As described above in connection with support member 202, one or both of members 304 can be displaced vertically in FIG. 3 by controller 115 to further disperse seeds 190 prior to overtreatment. Scattering mechanism 302 can include an actuator (not shown in FIG. 3) that is activatable by controller 115 to displace either of the members 304. Displacements can occur periodically or continuously, as described above.

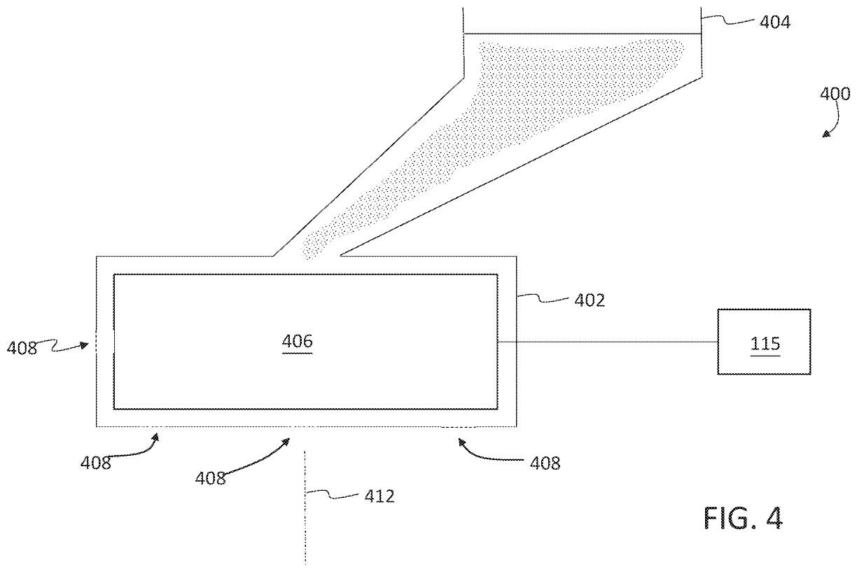

As described above, in some embodiments, treatment dispersal assembly 104 includes an atomizer 114. However, treatment dispersal assembly 104 can also be implemented in other ways. For example, where the overtreatment composition is applied to seeds 190 as a dry powder or as granules, treatment dispersal assembly can include a powder scattering mechanism. FIG. 4 is a schematic diagram of an example powder scattering mechanism 400 that can be implemented in treatment dispersal assembly 104. Powder scattering mechanism 400 includes a reservoir 404 for dry powder or granules of the overtreatment composition, a scattering chamber 402, and a movable scattering element 406. A plurality of apertures 408 are formed in the walls of the scattering chamber 402. Controller 115 is connected to mechanism 400 and can adjust the rate of rotation of scattering element 406 about axis 412.

During operation, the dry power or granules is/are loaded into reservoir 404. Powder or granules fall into chamber 402, and scattering element 406, rotating about axis 412, scatters the powder or granules within chamber 402. The scattered powder or granules that emerge from chamber 402 through apertures 408 is/are applied to seeds 190 that fall through system 100, forming the overtreatment coating on the seeds.

Returning to FIG. 1, system 100 is shown with a single atomizer 114. More generally, however, system 100 can include more than one atomizer. In some embodiments, for example, system 100 can include two or more (e.g., three or more, four or more, five or more, six or more, or even more) atomizers, each connected to fluid handling system 123. A common fluid (for example, an overtreatment composition) can be delivered by the fluid handling system 123 to each atomizer. Alternatively, different fluids can be delivered to different atomizers of system 100.

Returning again to FIG. 1, in some embodiments, the secondary transport mechanism includes additional components that assist the drying of seeds to which an overtreatment composition has been applied. For example, second transport mechanism 110 can optionally include a gas source 152 connected to controller 115. During operation of the system, controller 115 can regulate delivery of a dry gas (such as nitrogen) into second transport mechanism 110 to control the rate at which the applied overtreatment coating on seeds 190 dries.

In certain embodiments, second transport mechanism 110 can optionally include an applicator 150 connected to controller 115 and configured to apply one or more drying agents to seeds to which an overtreatment composition has been applied. Suitable examples of such applicators include power and granule scattering mechanisms, as discussed above. Examples of drying agents that can be used for this purpose include, but are not limited to, talc and graphite. In general, drying agents can be used to shorten the drying time for treated seeds in second transport mechanism 110 and can also improve plantability of the seeds.

During transport of the overtreated seeds 190 by seed-transporting mechanism 127 within the second transport mechanism 110, the overtreatment composition is relatively fragile as it dries on seeds. Abrasion, mechanical disruption, and inactivation of biological components of the composition are possible. In some embodiments, to reduce abrasion of the overtreatment adjustments and/or changes are made to the seed-transporting mechanism 127, e.g., the seed transporting mechanism 127 includes a belt conveyor or auger system formed of a relatively soft, compliant, non-abrasive material. Examples of such materials include, but are not limited to, polymer materials, silicone materials, and rubber materials.

In certain embodiments, to gently tumble the overcoated seeds as they dry, second transport mechanism 110 can include a conveyor belt that follows an undulating or serpentine path. Successive “peaks” and “valleys” along the undulating conveyor path result in gentle tumbling of the seeds as they are transported.

### Treatment of Crop Seeds

Controller 115 can adjust and control various operating parameters of system 100 to apply a variety of overtreatment compositions to seeds 190 under many different conditions. In general, the conditions are selected to allow for adequate seed treatment rates, while at the same time ensuring that coatings applied upstream to the seeds are not compromised, and overtreatment compositions applied by system 100 remain viable up to the time at which the overtreated seeds are planted.

In some embodiments, controller 115 adjusts the first transport mechanism 108 so that seeds 190 are admitted into housing 112 at a rate of between 100 lbs./min. and 1000 lbs./min. (e.g., between 100 and 400 lbs./min., 500 lbs./min. and 900 lbs./min, between 600 lbs./min and 900 lbs./min, between 600 lbs./min. and 800 lbs./min, between 650 lbs./min. and 800 lbs./min, between 650 lbs./min. and 750 lbs./min.).

In certain embodiments, to ensure adequate dispersal of an overtreatment composition discharged by atomizer 114 onto seeds 190, controller 115 adjusts a rotation rate of atomizer 114 to a value between 1000 revolutions per minute (RPM) and 2500 RPM (e.g., between 1200 and 2300 RPM, between 1500 and 2000 RPM (e.g., between 1600 and 1700 RPM), between 1000 and 2000 RPM, between 1500 and 2500 RPM, and any range within these ranges).

In some embodiments, controller 115 adjusts a rotation rate of support member 202 to control the exposure time of seeds 190 to the overtreatment composition discharged by the treatment dispersal assembly. For example, the rotation rate of support member 202 can be between 100 RPM and 500 RPM (e.g., between 150 RPM and 450 RPM, between 200 RPM and 400 RPM, between 100 RPM and 400 RPM, between 200 RPM and 500 RPM, and any range within these ranges).

In certain embodiments, controller 115 adjusts a supply rate of an overtreatment composition from mixer 118 to atomizer 114 to adjust the volume or concentration of overtreatment composition applied to seeds 190. In general, the supply rate selected can depend upon the type of seed being treated and the overtreatment composition that is applied to the seed. Supply rates for smaller seeds such as wheat and canola seeds having relatively high aggregate surface area may be relatively larger, while supply rates for larger seeds with smaller aggregate surface area may be relatively smaller.

In some embodiments, controller 115 adjusts the seed-transporting mechanism 127 thereby controlling the rate of the overcoated seeds through the second transport mechanism 110 to control a total drying time of the seeds following arrival of the seeds at the collection region 126 of system 100. For example, the transport rate can be adjusted so the total drying time for between 350 and 500 pounds of seed is between 20 s and 180 s (e.g., between 45 s and 150 s, between 60 s and 120 s, between 60 s and 90s, between 20 s and 45 s and any range within these ranges).

The dwell time refers to the elapsed interval between the time that the overcoating treatment is applied to seeds 190, and the time that the seeds are planted. In general, it can be advantageous to minimize the dwell time to ensure continued viability of microbials and other biological agents applied to seeds 190. In some embodiments, for example, the dwell time is 90 days or less (e.g., 80 days or less, 70 days or less, 60 days or less, 50 days or less, 40 days or less, 30 days or less, 20 days or less, 10 days or less, 5 days or less, 3 days or less, 2 days or less, 1 day or less). In certain embodiments, seeds are overcoated, dried, and planted on the same day.

In general, the overtreatment composition that is applied to seeds 190 is prepared by fluid handling system 123 and applied by the treatment dispersal assembly 104. Components of the composition can be combined into a single aqueous or non-aqueous solution and applied to seeds 190, or certain components can be applied separately from other components. Where certain components are applied separately, system 100 can include multiple atomizers 114 as described above, and fluid handling system 123 delivers the separate components to different atomizers. Alternatively, or in addition, fluid handling system 123 can deliver the separate components to one or more common atomizers at different times.

The overtreatment composition that is applied to the seeds generally includes at least one microbial. In some embodiments, for example, the at least one microbial includes a microbe which impacts plant health or nutrition, such as at least one nitrogen-fixing microbe, such as a gram-negative nitrogen-fixing microbe. More generally, numerous bacteria and fungi have been shown to provide beneficial effects for plant nutrition and health. These bacteria and fungi provide benefits to plants in various ways. In general, they can be split into subcategories. A first category of microbes functions to improve resistance to diseases and pests (biocontrol agents). A second category of microbes functions to help mitigate abiotic stresses such as water stress, temperature stress, heavy metal stress, and salt stress. A third category of microbes functions to improve a plant's nutritional status, such as by improving a plant's capacity to acquire nutrients, by supplying nutrients (e.g., nitrogen) directly to a plant, and by improving the plant's nutrient use efficiency.

Endophytic fungi strains from the Aspergillus, Penicillium, Trichoderma, Piriforma, and Glomus genus have been shown to improve plant health in each of these categories. The majority of endomycorrhizal fungi fall under the Glomeromycota fungi kingdom. Mycorrhizal fungi form a symbiotic relationship with the plants roots and the mycelium of these fungal strains extend from the plants root system. These mycelia have the ability to capture more nutrients for the plant that normally would be unavailable to the plant. This directly improves the plant's ability to be more efficient at nutrient uptake. Additionally, these mycelia can defend the plant under abiotic stresses. For example, mycorrhizal fungi can improve soil quality and water holding capacity as they increase soil aggregation. This can improve aeration and water flow within the soil which can directly help plants in an abiotic stress such as drought.

Bacterial strains from the Pseudomonas, Bacillus, Rhizobiacae, methylotrophic, Achromobacter, Agrobacterium, Ustilago, Azospirillum, Rhizobium, Azotobacter, Klebsiella, and Burkholderia genus/species have also shown beneficial effects on plant growth and development. The mechanisms by which these bacteria improve plant growth and development are varied. Some of these bacterial strains can decompose and mineralize organic matter and enhance the availability of mineral nutrients such as phosphorus and iron. These microbes directly increase available forms of phosphorus to the plant that are normally not available. Secondly, these bacterial strains can help improve nutrient uptake by the plant. One way this is achieved is when microbes in the root zone feed on the sugars, amino acids, and organic acids that are released from the plant the microbes then release metabolites that are beneficial to the plant. These metabolites can be hormones such as auxins and cytokinins in the root zone. These hormones can alter plant growth and the roots structure by overproduction of lateral roots and root hairs. This directly increases nutrient and water uptake for the plant.

Furthermore, some of these microbes have the ability to fix atmospheric nitrogen in the root zone which can directly be utilized by the plant. Other microbial strains act as biocontrol agents by releasing secondary metabolites that can be antibiotic in nature and damage the cell walls of plant pathogenic bacteria. These microbes can also induce specific plant defense responses in which the plant can initiate when they sense that they are in the presence of pathogens. This is typically done when elicitor molecules are released by the microbes in the root zone to trigger a defense mechanism by the plant. In general, specific strains of these fungi and bacteria will have different effects on plant growth and development, and therefore, specific strains from each of these genus or species will have different beneficial effects for the host plant.

In general, microbes from any of the above above genus and/or species can be used as microbials in overtreatments applied to seeds as described herein. Examples of specific commercially available microbials and natural product extracts that can be applied in seed overtreatments as described herein include those examples shown in Table 1 below, but are not limited to the examples of Table 1.

TABLE 1
Commercially Available Microbials for Seed Overtreatments

| | | Bacteria | |
|---|---|---|---|
| Product | Category | or Fungi | Microbe |
| Rootella X | Abiotic stress mitigator, | Fungi | Glomus intraradices |
| | nutritional | | |
| Terrasym | Nutritional | Bacteria | M-trophs aka mthylotrophs. |
| 450 | | | Methylobacterium |
| | | | gregans |
| Envita | N fixing bacteria | Bacteria | Gluconacetobacter diazotrophicus |
| iNvigorate | Nutritional, N fixing, | Bacteria | Azotobacter vinelandii, Clostridium |
| | nutrient enhancer | | pasteurianum |
| PrimAgro N | Nutritional, abiotic | Bacteria | Bacillus subtilis with 30% nitrogen, 1% |
| | stress mitigator | | sulfur |
| EndoFuse | Abiotic stress mitigator | Fungi | Glomus intraradices, glomus mosseae, |
| | | | glomus aggregatum, glomus etunicatum |
| MycoGold | Biocontrol agent, | Fungi | Beauveria Bassiana, Azospirillum, |
| | Abiotic stress mitigator, | and | Azotobacter |
| | Nutrient uptake | bacteria | |
| | enhancer | combo | |
| BioFlex | Nutritional, germination | Fungi | Azotobacter, Clostridium, Mycorrhizae |
| | enhancer | and | |
| | | bacteria | |
| | | combo | |
| Rhyzo-link | Biocontrol agent, | Bacteria | Bacillus subtilis, Bacillus |
| | Nutritional/plant | | methylotrophicus, Bacillus |
| | growth enhancer | | amyloliquefaciens, Bacillus |
| | | | megaterium, Bacillus licheniformis |
| QuickRoots | Nutrient availability and | Fungi | Bacillus |
| | uptake of nitrogen, | and | amyloliquefaciens and Trichoderma |
| | phosphate and | Bacteria | virens |
| | potassium | combo | |
| SabrEx for | Nutritional, abiotic | Fungi | Trichoderma harzianum, Trichoderma |
| Corn | stress mitigator | | atroviride |
| Biotrinsic | Nutritional, abiotic | Bacteria | Ochrobactrum anthropi and Bacillus |
| M33 FP + | stress mitigator | | Subtillus, Bacillus simplex |
| M34 FP and | | | |
| W10 | | | |
| MicroAZ | Nutritional, abiotic | Bacteria | Azospirillum brasilense |
| | stress mitigator, N | | |
| | fixation | | |
| JumpStart | Nutritional | Fungi | Penicillium bilaiae |
| Pacesetter | Nutritional | Extract | Extract of Reynoutria sachalinensis |
| | | | (giant knotweed) |
| Toggle | Nutritional, abiotic | Extract | Extract from algae (Ascophyllum |
| | stress mitigator | | nodosum) |

In certain embodiments, the at least one microbial includes at least one nitrogen-fixing bacterium. Examples of suitable bacteria include, but are not limited to, bacteria from strains 137-1036 (accession number 201712002), 137-2253 (accession number PTA-126740), 137-3890 (accession number PTA-126749), 6-5687 (accession number PTA-126743, previously described as 6-2122), and combinations of bacteria from these strains.

In some embodiments, the overtreatment composition can include an extender. In certain embodiments, the overtreatment composition can include a polymer. When present, the extender can function in a manner similar to a polymer, encapsulating the other components of the composition around the seed, forming a protective coating for each treated seed to retain the treatment on the seed. In addition, extenders and polymers can assist in promoting flow of the seed through system 100 and within the seed box of a planting system, and in reducing dust-off associated with seed handling, thereby improving plantability.

In certain embodiments, the overtreatment composition can include a polymer precursor. Polymer precursors typically polymerize on the seed surface following deposition to form a polymer coating. Examples of suitable polymer precursors include, but are not limited to, monomers, dimers, trimers, and more generally, n-mers of any precursor to the polymers described above.

In some embodiments, the overtreatment composition includes a protecting agent that assists in preserving the viability of one or more microbials that are contained in the composition. A variety of protecting agents can be included in the overtreatment compositions applied by system 100 including, but not limited to, pH modifiers, rheology modifiers, simple or complex sugars, sugar alcohols, polyvinylpyrrolidone (PVP), vinyl acetate (VA), copolymers of polyvinylpyrrolidone and vinyl acetate (designated generally as PVP-VA), polysorbate, propylene, glycol, and glycerol.

In certain embodiments, as discussed above, the overtreatment composition is not a liquid composition. For example, the overtreatment composition can be a dry powder composition. Alternatively, the overtreatment composition can include granules that include one or more microbials. As discussed above, dry powder compositions and granule-based compositions can be applied to the seeds with a powder scattering mechanism. Alternatively, or in addition, dry powder compositions and granule-based compositions can be applied to seeds by applicator 150 in the second transport mechanism 110.

In some embodiments, where the overtreatment composition is a liquid composition, the viscosity of the composition can be adjusted to prevent run-off of the overtreatment composition from the surfaces of the seeds. For example, to restrict run-off, the viscosity of the overtreatment composition can be between 50 centiPoise (cP) and 250 cP (e.g., between 100 cP and 200 cP, between 150 cP and 250 cP, between 100 cP and 250 cP, between 50 cP and 200 cP, between 50 cP and 150 cP, and any range within these ranges).

### Microbial Stability, Seed Viability, and Upstream Coating Effectiveness

As discussed above, overtreatment compositions are applied by system 100 to ensure that the stability of the microbial(s) that is/are part of the compositions are maintained following application of the treatment, and the viability of the seeds is maintained following the application of the overtreatment composition.

Because the seeds that are treated by system 100 typically come from a seed processing facility, the seeds may already have been coated with an upstream coating. Upstream coatings commonly include components such as biocides (e.g., fungicides, insecticides, nematicides), and certain biological agents. The downstream overcoating compositions are applied to the already-treated seeds by system 100 in a manner ensuring that the effectiveness of the elements of the upstream coating is maintained following overtreatment.

### (a) Microbial Stability

To assess the stability of a microbial applied to a seed as part of an overtreatment composition, microbes are extracted from treated seeds using an extraction buffer followed by bacterial enumeration. Typically 25 seeds from specific formulation are put into sterile containers, in 3 biological replications, 250 mL of extraction buffer is added to the container and shaken for 30 min. to extract as much bacteria from the seed as possible. The extract is then assayed for bacterial enumeration using the standard plate method, which is well known in the art. The stability of microbes on the seed is calculated by monitoring the viability of microbial formulation on the seed over time at various temperatures.

In the standard plate method, each colony forming unit (CFU) detected on the culture plate represents a single microorganism originally present on the surface of the overtreated corn seed. In an embodiment, the microbe CFU per seed (as measured by the standard plate method) on the culture plate is at least 10² CFU. In another embodiment, the CFU per seed is, for example, at least 10³ CFU, at least 10⁴ CFU, at least 10⁵ CFU, at least 10⁶ CFU, at least 10⁷ CFU per seed, or more.

Microbial viability right after overtreatment and over time at various temperatures is a good measure of the ability of the overtreatment composition to protect the microbial during seed treatment, and is also a good indicator as to whether the seed overtreatment process or upstream treatment chemistry has any negative impact on the survival of the microbial on the seed.

### (b) Seed Viability

Seed viability is measured using both a warm germination test, and a cold germination test; both tests are conducted in a laboratory. The warm germination test provides an estimate of seed viability when seeds are germinated under warm temperatures, which are considered ideal for seed germination. The cold germination test provides an estimate of seed viability when seeds are germinated under cold temperatures, which is considered stressful for seed germination.

To conduct the warm germination test, seeds are placed in a moist brown paper towel, in a lab growth chamber at a temperature of 25° C. The seeds are then allowed to imbibe water, germinate, and grow for a period of 7 days, after which the number of germinated seeds are counted providing the percentage of seeds that have germinated under ideal conditions.

To conduct the cold germination test, seeds are placed in a moist brown paper towel at 10° C. temperature for a 7-day period. Then the seeds are placed in a growth chamber at a temperature of 25° C. for an additional 7 days. At the end of this 7-day period, the number of germinated seeds is counted providing the percentage of seeds that have germinated under stressful conditions. Seed viability is a good measure of the impact of the seed-germination response to seed overtreatments when grown under favorable or stressful conditions.

### (c) Effectiveness of Upstream Coating Elements

As discussed above, elements of the upstream coating applied to seeds typically include fungicides, insecticides, nematicides, polymer and color coatings. To determine if overtreatments impact the underlying upstream seed treatments efficacy, seeds with only the upstream coating and seeds with both upstream coatings and overtreatments are compared in laboratory, greenhouse, and field trials against selected plant pathogens. The efficacy of upstream-applied insecticides against selected insects and pests by comparing responses between seeds of the two groups. Upstream seed treatments and overtreatments are considered compatible if the efficacy of the underlying upstream seed treatment is not negatively impacted when an overtreatment is applied.

### Agricultural Compositions

Seeds that are treated with one or more overtreatment compositions using the methods and systems described herein can be used in and/or form agricultural compositions that are used for growing food and other crops. As such, plant seeds of the agricultural compositions can be viable to grow into plants.

The agricultural compositions typically include one or more plant seeds that include a first coating and an overtreatment. The overtreatment generally includes at least one microbial. A variety of different plant seeds can be used in the composition including, but not limited to, corn seeds. The first coating can include various components such as, but not limited to, one or more biocides. As such, the first coating can have biocidal activity.

As discussed above, the overtreatment can also include various components, examples of which include, but are not limited to, polymers and additional microbials. Microbials that can be used in the overtreatment as part of the agricultural compositions can include microbes which impact plant health or nutrition, such as nitrogen fixing microbes including, but not limited to, gram-negative microbes such as gram-negative nitrogen fixing microbes and gram-positive microbes such as gram-positive nitrogen fixing microbes. Specific targets for genetic variation to facilitate field-based nitrogen fixation in the selected microbes include one or more genes selected from the group consisting of nifA, nifL, ntrB, ntrC, glnA, glnB, glnK, draT, amtB, glnD, glnE, nifJ, nifH, nifD, nifK, nifY, nifE, nifN, nifU, nifS, nifV, nifW, nifZ, nifM, nifF, nifB, and nifQ coding for proteins functional in the biological nitrogen fixation. Examples of such nitrogen-fixing bacteria include, but are not limited to, Klebsiella variicola strains 137-1036, 137-2253, and 137-3890, Kosakonia saccharii strain 6-5687, and any combination thereof. In some agricultural compositions, one or more microbials present in the overtreatment provide fixed nitrogen to a plant grown from the plant seed on which the overtreatment is applied.

### Bacterial Species

Microbes useful in the methods and compositions disclosed herein may be obtained from any source. In some cases, microbes may be bacteria, archaea, protozoa or fungi. The microbes of this disclosure may be nitrogen fixing microbes, for example a nitrogen fixing bacteria, nitrogen fixing archaea, nitrogen fixing fungi, nitrogen fixing yeast, or nitrogen fixing protozoa. Microbes useful in the methods and compositions disclosed herein may be spore forming microbes, for example spore forming bacteria. In some cases, bacteria useful in the methods and compositions disclosed herein may be Gram positive bacteria or Gram-negative bacteria. In some cases, the bacteria may be an endospore forming bacteria of the Firmicute phylum. In some cases, the bacteria may be a diazotroph. In some cases, the bacteria may not be a diazotroph.

The methods and compositions of this disclosure may be used with an archaea, such as, for example, Methanothermobacter thermoautotrophicus.

In some cases, bacteria which may be useful include, but are not limited to, Agrobacterium radiobacter, Bacillus acidocaldarius, Bacillus acidoterrestris, Bacillus agri, Bacillus aizawai, Bacillus albolactis, Bacillus alcalophilus, Bacillus alvei, Bacillus aminoglucosidicus, Bacillus aminovorans, Bacillus amylolyticus (also known as Paenibacillus amylolyticus) Bacillus amyloliquefaciens, Bacillus aneurinolyticus, Bacillus atrophaeus, Bacillus azotoformans, Bacillus badius, Bacillus cereus (synonyms: Bacillus endorhythmos, Bacillus medusa), Bacillus chitinosporus, Bacillus circulans, Bacillus coagulans, Bacillus endoparasiticus Bacillus fastidiosus, Bacillus firmus, Bacillus kurstaki, Bacillus lacticola, Bacillus lactimorbus, Bacillus lactis, Bacillus laterosporus (also known as Brevibacillus laterosporus), Bacillus lautus, Bacillus lentimorbus, Bacillus lentus, Bacillus licheniformis, Bacillus maroccanus, Bacillus megaterium, Bacillus metiens, Bacillus mycoides, Bacillus natto, Bacillus nematocida, Bacillus nigrificans, Bacillus nigrum, Bacillus pantothenticus, Bacillus popillae, Bacillus psychrosaccharolyticus, Bacillus pumilus, Bacillus siamensis, Bacillus smithii, Bacillus sphaericus, Bacillus subtilis, Bacillus thuringiensis, Bacillus uniflagellatus, Bradyrhizobium japonicum, Brevibacillus brevis Brevibacillus laterosporus (formerly Bacillus laterosporus), Chromobacterium subtsugae, Delftia acidovorans, Lactobacillus acidophilus, Lysobacter antibioticus, Lysobacter enzymogenes, Paenibacillus alvei, Paenibacillus polymyxa, Paenibacillus popilliae (formerly Bacillus popilliae), Pantoea agglomerans, Pasteuria penetrans (formerly Bacillus penetrans), Pasteuria usgae, Pectobacterium carotovorum (formerly Erwinia carotovora), Pseudomonas aeruginosa, Pseudomonas aureofaciens, Pseudomonas cepacia (formerly known as Burkholderia cepacia), Pseudomonas chlororaphis, Pseudomonas fluorescens, Pseudomonas proradix, Pseudomonas putida, Pseudomonas syringae, Serratia entomophila, Serratia marcescens, Streptomyces colombiensis, Streptomyces galbus, Streptomyces goshikiensis, Streptomyces griseoviridis, Streptomyces lavendulae, Streptomyces prasinus, Streptomyces saraceticus, Streptomyces venezuelae, Xanthomonas campestris, Xenorhabdus luminescens, Xenorhabdus nematophila, Rhodococcus globerulus AQ719 (NRRL Accession No. B-21663), Bacillus sp. AQ175 (ATCC Accession No. 55608), Bacillus sp. AQ 177 (ATCC Accession No. 55609), Bacillus sp. AQ178 (ATCC Accession No. 53522), and Streptomyces sp. strain NRRL Accession No. B-30145. In some cases the bacterium may be Azotobacter chroococcum, Methanosarcina barkeri, Klesiella pneumoniae, Azotobacter vinelandii, Rhodohacter spharoides, Rhodobacter capsulatus, Rhodobcter palustris, Rhodosporillum rubrum, Rhizobium leguminosarum or Rhizobium etli.

In some cases the bacterium may be a species of Clostridium, for example Clostridium pasteurianum, Clostridium beijerinckii, Clostridium perfringens, Clostridium tetani, Clostridium acetobutylicum.

In some cases, bacteria used with the methods and compositions of the present disclosure may be cyanobacteria. Examples of cyanobacterial genuses include Anabaena (for example Anabaena sp. PCC7120), Nostoc (for example Nostoc punctiforme), or Synechocystis (for example Synechocystis sp. PCC6803).

In some cases, bacteria used with the methods and compositions of the present disclosure may belong to the phylum Chlorobi, for example Chlorobium tepidum.

In some cases, microbes used with the methods and compositions of the present disclosure may comprise a gene homologous to a known NifH gene. Sequences of known NifH genes may be found in, for example, the Zehr lab NifH database, (wwwzehr.pmc.ucsc.edu/nifH_Database_Public/, Apr. 4, 2014), or the Buckley lab NifH database (www.css.cornell.edu/faculty/buckley/nifh.htm, and Gaby, John Christian, and Daniel H. Buckley. “A comprehensive aligned nifH gene database: a multipurpose tool for studies of nitrogen-fixing bacteria.” Database 2014 (2014): bau001.). In some cases, microbes used with the methods and compositions of the present disclosure may comprise a sequence which encodes a polypeptide with at least 60%, 70%, 80%, 85%, 90%, 95%, 96%, 96%, 98%, 99% or more than 99% sequence identity to a sequence from the Zehr lab NifH database, (wwwzehr.pmc.ucsc.edu/nifH_Database_Public/, Apr. 4, 2014). In some cases, microbes used with the methods and compositions of the present disclosure may comprise a sequence which encodes a polypeptide with at least 60%, 70%, 80%, 85%, 90%, 95%, 96%, 96%, 98%, 99% or more than 99% sequence identity to a sequence from the Buckley lab NifH database, (Gaby, John Christian, and Daniel H. Buckley. “A comprehensive aligned nifH gene database: a multipurpose tool for studies of nitrogen-fixing bacteria.” Database 2014 (2014): bau001.).

Microbes useful in the methods and compositions disclosed herein can be obtained by extracting microbes from surfaces or tissues of native plants; grinding seeds to isolate microbes; planting seeds in diverse soil samples and recovering microbes from tissues; or inoculating plants with exogenous microbes and determining which microbes appear in plant tissues. Non-limiting examples of plant tissues include a seed, seedling, leaf, cutting, plant, bulb, tuber, root, and rhizomes. In some cases, bacteria are isolated from a seed. The parameters for processing samples may be varied to isolate different types of associative microbes, such as rhizospheric, epiphytes, or endophytes. Bacteria may also be sourced from a repository, such as environmental strain collections, instead of initially isolating from a first plant. The microbes can be genotyped and phenotyped, via sequencing the genomes of isolated microbes; profiling the composition of communities in planta; characterizing the transcriptomic functionality of communities or isolated microbes; or screening microbial features using selective or phenotypic media (e.g., nitrogen fixation or phosphate solubilization phenotypes). Selected candidate strains or populations can be obtained via sequence data; phenotype data; plant data (e.g., genome, phenotype, and/or yield data); soil data (e.g., pH, N/P/K content, and/or bulk soil biotic communities); or any combination of these.

The bacteria and methods of producing bacteria described herein may apply to bacteria able to self-propagate efficiently on the leaf surface, root surface, or inside plant tissues without inducing a damaging plant defense reaction, or bacteria that are resistant to plant defense responses. The bacteria described herein may be isolated by culturing a plant tissue extract or leaf surface wash in a medium with no added nitrogen. However, the bacteria may be unculturable, that is, not known to be culturable or difficult to culture using standard methods known in the art. The bacteria described herein may be an endophyte or an epiphyte or a bacterium inhabiting the plant rhizosphere (rhizospheric bacteria). The bacteria obtained after repeating the steps of introducing genetic variation, exposure to a plurality of plants, and isolating bacteria from plants with an improved trait one or more times (e.g. 1, 2, 3, 4, 5, 10, 15, 25, or more times) may be endophytic, epiphytic, or rhizospheric. Endophytes are organisms that enter the interior of plants without causing disease symptoms or eliciting the formation of symbiotic structures, and are of agronomic interest because they can enhance plant growth and improve the nutrition of plants (e.g., through nitrogen fixation). The bacteria can be a seed-borne endophyte. Seed-borne endophytes include bacteria associated with or derived from the seed of a grass or plant, such as a seed-borne bacterial endophyte found in mature, dry, undamaged (e.g., no cracks, visible fungal infection, or prematurely germinated) seeds. The seed-borne bacterial endophyte can be associated with or derived from the surface of the seed; alternatively, or in addition, it can be associated with or derived from the interior seed compartment (e.g., of a surface-sterilized seed). In some cases, a seed-borne bacterial endophyte is capable of replicating within the plant tissue, for example, the interior of the seed. Also, in some cases, the seed-borne bacterial endophyte is capable of surviving desiccation.

The bacteria isolated according to methods of the disclosure, or used in methods or compositions of the disclosure, can comprise a plurality of different bacterial taxa in combination. By way of example, the bacteria may include Proteobacteria (such as Pseudomonas, Enterobacter, Stenotrophomonas, Burkholderia, Rhizobium, Herbaspirillum, Pantoea, Serratia, Rahnella, Azospirillum, Azorhizobium, Azotobacter, Duganella, Delftia, Bradyrhizobiun, Sinorhizobium and Halomonas), Firmicutes (such as Bacillus, Paenibacillus, Lactobacillus, Mycoplasma, and Acetabacterium), and Actinobacteria (such as Streptomyces, Rhodacoccus, Microbacterium, and Curtobacterium). The bacteria used in methods and compositions of this disclosure may include nitrogen fixing bacterial consortia of two or more species. In some cases, one or more bacterial species of the bacterial consortia may be capable of fixing nitrogen. In some cases, one or more species of the bacterial consortia may facilitate or enhance the ability of other bacteria to fix nitrogen. The bacteria which fix nitrogen and the bacteria which enhance the ability of other bacteria to fix nitrogen may be the same or different. In some examples, a bacterial strain may be able to fix nitrogen when in combination with a different bacterial strain, or in a certain bacterial consortia, but may be unable to fix nitrogen in a monoculture. Examples of bacterial genuses which may be found in a nitrogen fixing bacterial consortia include, but are not limited to, Herbaspirillum, Azospirillum, Enterobacter, and Bacillus.

Bacteria that can be produced by the methods disclosed herein include Azotobacter sp., Bradyrhizobium sp., Klebsiella sp., and Sinorhizobium sp. In some cases, the bacteria may be selected from the group consisting of: Azotobacter vinelandii, Bradyrhizobium japonicum, Klebsiella pneumoniae, and Sinorhizobium meliloti. In some cases, the bacteria may be of the genus Enterobacter or Rahnella. In some cases, the bacteria may be of the genus Frankia, or Clostridium. Examples of bacteria of the genus Clostridium include, but are not limited to, Clostridium acetobutilicum, Clostridium pasteurianum, Clostridium beijerinckii, Clostridium perfringens, and Clostridium tetani. In some cases, the bacteria may be of the genus Paenibacillus, for example Paenibacillus azotofixans, Paenibacillus borealis, Paenibacillus durus, Paenibacillus macerans, Paenibacillus polymyxa, Paenibacillus alvei, Paenibacillus amylolyticus, Paenibacillus campinasensis, Paenibacillus chihensis, Paenibacillus glucanolyticus, Paenibacillus illinoisensis, Paenibacillus larvae subsp. Larvae, Paenibacillus larvae subsp. Pulvifaciens, Paenibacillus lautus, Paenibacillus macerans, Paenibacillus macquariensis, Paenibacillus macquariensis, Paenibacillus pabuli, Paenibacillus peoriae, or Paenibacillus polymyxa.

In some examples, bacteria isolated according to methods of the disclosure can be a member of one or more of the following taxa: Achromobacter, Acidithiobacillus, Acidovorax, Acidovoraz, Acinetobacter, Actinoplanes, Adlercreutzia, Aerococcus, Aeromonas, Afipia, Agromyces, Ancylobacter, Arthrobacter, Atopostipes, Azospirillum, Bacillus, Bdellovibrio, Beijerinckia, Bosea, Bradyrhizobium, Brevibacillus, Brevundimonas, Burkholderia, Candidatus Haloredivivus, Caulobacter, Cellulomonas, Cellvibrio, Chryseobacterium, Citrobacter, Clostridium, Coraliomargarita, Corynebacterium, Cupriavidus, Curtobacterium, Curvibacter, Deinococcus, De/ltia, Desemzia, Devosia, Dokdonella, Dyella, Enhydrobacter, Enterobacter, Enterococcus, Erwinia, Escherichia, Escherichia Shigella, Exiguobacterium, Ferroglobus, Filimonas, Finegoldia, Flavisolibacter, Flavobacterium, Frigoribacterium, Gluconacetobacter, Hafnia, Halobaculum, Halomonas, Halosimplex, Herbaspirillum, Hymenobacter, Klebsiella, Kocuria, Kosakonia, Lactobacillus, Leclercia, Lentzea, Luteibacter, Luteimonas, Massilia, Mesorhizobium, Methylobacterium, Microbacterium, Micrococcus, Microvirga, Mycobacterium, Neisseria, Nocardia, Oceanibaculum, Ochrobactrum, Okibacterium, Oligotropha, Oryzihumus, Oxalophagus, Paenibacillus, Panteoa, Pantoea, Pelomonas, Perlucidibaca, Plantibacter, Polynucleobacter, Propionibacterium, Propioniciclava, Pseudoclavibacter, Pseudoronas, Pseudonocardia, Pseudoxanthomonas, Psychrobacter, Rahnella, Ralstonia, Rheinheimera, Rhizobium, Rhodococcus, Rhodopseudomonas, Roseateles, Ruminococcus, Sebaldella, Sediminibacillus, Sediminibacterium, Serratia, Shigella, Shinella, Sinorhizobium, Sinosporangium, Sphingobacterium, Sphingomonas, Sphingopyxis, Sphingosinicella, Staphylococcus, Stenotrophomonas, Strenotrophomonas, Streptococcus, Streptomyces, Stygiolobus, Sulfurisphaera, Tatumella, Tepidimonas, Thermomonas, Thiobacillus, Variovorax, WPS-2 genera incertae sedis, Xanthomonas, and Zimmermannella.

In some cases, a bacterial species selected from at least one of the following genera are utilized: Enterobacter, Klebsiella, Kosakonia, and Rahnella. In some cases, a combination of bacterial species from the following genera are utilized: Enterobacter, Klebsiella, Kosakonia, and Rahnella. In some cases, the species utilized can be one or more of: Enterobacter sacchari, Klebsiella variicola, Kosakonia sacchari, and Rahnella aquatilis.

In some cases, a Gram positive microbe may have a Molybdenum-Iron nitrogenase system comprising: nifH, nifD, nifK, nifB, nifE, nifN, nifX, hesA, nifV, nifW, nifU, nifS, nifI1, and nifI2. In some cases, a Gram positive microbe may have a vanadium nitrogenase system comprising: vnfDG, vnfK, vnfE, vnfN, vupC, vupB, vupA, vnfV, vnfR1, vnfH, vnfR2, vnfA (transcriptional regulator). In some cases, a Gram positive microbe may have an iron-only nitrogenase system comprising: anfK, anfG, anfD, anfH, anfA (transcriptional regulator). In some cases, a Gram positive microbe may have a nitrogenase system comprising glnB, and glnK (nitrogen signaling proteins). Some examples of enzymes involved in nitrogen metabolism in Gram positive microbes include glnA (glutamine synthetase), gdh (glutamate dehydrogenase), bdh (3-hydroxybutyrate dehydrogenase), glutaminase, gltAB/gltB/gltS (glutamate synthase), asnA/asnB (aspartate-ammonia ligase/asparagine synthetase), and ansA/ansZ (asparaginase).

Some examples of proteins involved in nitrogen transport in Gram positive microbes include amtB (ammonium transporter), glnK (regulator of ammonium transport), glnPHQ/glnQHMP (ATP dependent glutamine/glutamate transporters), glnT/alsT/yrbD/yflA (glutamine-like proton symport transporters), and gltP/gltT/yhcl/nqt (glutamate-like proton symport transporters).

Examples of Gram positive microbes which may be of particular interest include Paenibacillus polymixa, Paenibacillus riograndensis, Paenibacillus sp., Frankia sp., Heliobacterium sp., Heliobacterium chlorum, Heliobacillus sp., Heliophilum sp., Heliorestis sp., Clostridium acetobutylicum, Clostridium sp., Mycobacterium flaum, Mycobacterium sp., Arthrobacter sp., Agromyces sp., Corynebacterium autitrophicum, Corynebacterium sp., Micromonspora sp., Propionibacteria sp., Streptomyces sp., and Microbacterium sp.

Some examples of genetic alterations which may be made in Gram positive microbes include: deleting glnR to remove negative regulation of BNF in the presence of environmental nitrogen, inserting different promoters directly upstream of the nif cluster to eliminate regulation by GlnR in response to environmental nitrogen, mutating glnA to reduce the rate of ammonium assimilation by the GS-GOGAT pathway, deleting amtB to reduce uptake of ammonium from the media, mutating glnA so it is constitutively in the feedback-inhibited (FBI-GS) state, to reduce ammonium assimilation by the GS-GOGAT pathway.

In some cases, glnR is the main regulator of N metabolism and fixation in Paenibacillus species. In some cases, the genome of a Paenibacillus species may not contain a gene to produce glnR. In some cases, the genome of a Paenibacillus species may not contain a gene to produce glnE or glnD. In some cases, the genome of a Paenibacillus species may contain a gene to produce glnB or glnK. For example, Paenibacillus sp. WLY78 doesn't contain a gene for glnB, or its homologs found in the archaeon Methanococcus maripaludis, nifI1 and nifI2. In some cases, the genomes of Paenibacillus species may be variable. For example, Paenibacillus polymixa E681 lacks glnK and gdh, has several nitrogen compound transporters, but only amtB appears to be controlled by GlnR. In another example, Paenibacillus sp. JDR2 has glnK, gdh and most other central nitrogen metabolism genes, has many fewer nitrogen compound transporters, but does have glnPHQ controlled by GlnR. Paenibacillus riograndensis SBR5 contains a standard glnRA operon, an fdx gene, a main nif operon, a secondary nif operon, and an anf operon (encoding iron only nitrogenase). Putative glnR/tnrA sites were found upstream of each of these operons. GlnR may regulate all of the above operons, except the anf operon. GlnR may bind to each of these regulatory sequences as a dimer.

Paenibacillus N-fixing strains may fall into two subgroups: Subgroup I, which contains only a minimal nif gene cluster and subgroup II, which contains a minimal cluster, plus an uncharacterized gene between nifX and hesA, and often other clusters duplicating some of the nif genes, such as nifH, nifHDK, nifBEN, or clusters encoding vanadium nitrogenase (vnf) or iron only nitrogenase (anf) genes.

In some cases, the genome of a Paenibacillus species may not contain a gene to produce glnB or glnK. In some cases, the genome of a Paenibacillus species may contain a minimal nif cluster with 9 genes transcribed from a sigma-70 promoter. In some cases, a Paenibacillus nif cluster may be negatively regulated by nitrogen or oxygen. In some cases, the genome of a Paenibacillus species may not contain a gene to produce sigma-54. For example, Paenibacillus sp. WLY78 does not contain a gene for sigma-54. In some cases, a nif cluster may be regulated by glnR, and/or TnrA. In some cases, activity of a nif cluster may be altered by altering activity of glnR, and/or TnrA.

In Bacilli, glutamine synthetase (GS) is feedback-inhibited by high concentrations of intracellular glutamine, causing a shift in confirmation (referred to as FBI-GS). Nif clusters contain distinct binding sites for the regulators GlnR and TnrA in several Bacilli species. GlnR binds and represses gene expression in the presence of excess intracellular glutamine and AMP.

A role of GlnR may be to prevent the influx and intracellular production of glutamine and ammonium under conditions of high nitrogen availability. TnrA may bind and/or activate (or repress) gene expression in the presence of limiting intracellular glutamine, and/or in the presence of FBI-GS. In some cases, the activity of a Bacilli nif cluster may be altered by altering the activity of GlnR.

Feedback-inhibited glutamine synthetase (FBI-GS) may bind GlnR and stabilize binding of GlnR to recognition sequences. Several bacterial species have a GlnR/TnrA binding site upstream of the mf cluster. Altering the binding of FBI-GS and GlnR may alter the activity of the nif pathway.

### Sources of Microbes

The bacteria (or any microbe according to the disclosure) may be obtained from any general terrestrial environment, including its soils, plants, fungi, animals (including invertebrates) and other biota, including the sediments, water and biota of lakes and rivers; from the marine environment, its biota and sediments (for example, sea water, marine muds, marine plants, marine invertebrates (for example, sponges), marine vertebrates (for example, fish)); the terrestrial and marine geosphere (regolith and rock, for example, crushed subterranean rocks, sand and clays); the cryosphere and its meltwater; the atmosphere (for example, filtered aerial dusts, cloud and rain droplets); urban, industrial and other man-made environments (for example, accumulated organic and mineral matter on concrete, roadside gutters, roof surfaces, and road surfaces).

The plants from which the bacteria (or any microbe according to the disclosure) are obtained may be a plant having one or more desirable traits, for example a plant which naturally grows in a particular environment or under certain conditions of interest. By way of example, a certain plant may naturally grow in sandy soil or sand of high salinity, or under extreme temperatures, or with little water, or it may be resistant to certain pests or disease present in the environment, and it may be desirable for a commercial crop to be grown in such conditions, particularly if they are, for example, the only conditions available in a particular geographic location. By way of further example, the bacteria may be collected from commercial crops grown in such environments, or more specifically from individual crop plants best displaying a trait of interest amongst a crop grown in any specific environment: for example the fastest-growing plants amongst a crop grown in saline-limiting soils, or the least damaged plants in crops exposed to severe insect damage or disease epidemic, or plants having desired quantities of certain metabolites and other compounds, including fiber content, oil content, and the like, or plants displaying desirable colors, taste or smell. The bacteria may be collected from a plant of interest or any material occurring in the environment of interest, including fungi and other animal and plant biota, soil, water, sediments, and other elements of the environment as referred to previously.

The bacteria (or any microbe according to the disclosure) may be isolated from plant tissue. This isolation can occur from any appropriate tissue in the plant, including for example root, stem and leaves, and plant reproductive tissues. By way of example, conventional methods for isolation from plants typically include the sterile excision of the plant material of interest (e.g., root or stem lengths, leaves), surface sterilization with an appropriate solution (e.g. 2% sodium hypochlorite), after which the plant material is placed on nutrient medium for microbial growth.

Alternatively, the surface-sterilized plant material can be crushed in a sterile liquid (usually water) and the liquid suspension, including small pieces of the crushed plant material spread over the surface of a suitable solid agar medium, or media, which may or may not be selective (e.g. contain only phytic acid as a source of phosphorus). This approach is especially useful for bacteria which form isolated colonies and can be picked off individually to separate plates of nutrient medium, and further purified to a single species by well-known methods. Alternatively, the plant root or foliage samples may not be surface sterilized but only washed gently thus including surface dwelling epiphytic microorganisms in the isolation process, or the epiphytic microbes can be isolated separately, by imprinting and lifting off pieces of plant roots, stem or leaves onto the surface of an agar medium and then isolating individual colonies as above. This approach is especially useful for bacteria, for example. Alternatively, the roots may be processed without washing off small quantities of soil attached to the roots, thus including microbes that colonize the plant rhizosphere. Otherwise, soil adhering to the roots can be removed, diluted and spread out onto agar of suitable selective and non-selective media to isolate individual colonies of rhizospheric bacteria.

### Overtreatment Compositions

Examples of overtreatment and upstream compositions may include seed coatings for commercially important agricultural crops, for example, sorghum, canola, tomato, strawberry, barley, rice, maize, and wheat. Examples of compositions can also include seed coatings for corn, soybean, canola, sorghum, potato, rice, vegetables, cereals, and oilseeds. Seeds as provided herein can be genetically modified organisms (GMO), non-GMO, gene edited, organic, or conventional. The bacterial species may be present in compositions at a concentration of between 10⁸ to 10¹⁰ CFU/mL. In some examples, compositions may be supplemented with trace metal ions, such as molybdenum ions, iron ions, manganese ions, or combinations of these ions. The concentration of ions in examples of compositions as described herein may between about 0.1 mM and about 50 mM. Some examples of compositions may also be formulated with a carrier, such as beta-glucan, carboxylmethyl cellulose (CMC), bacterial extracellular polymeric substance (EPS), sugar, animal milk, or other suitable carriers. In some examples, peat or planting materials can be used as a carrier, or biopolymers in which a composition is entrapped in the biopolymer can be used as a carrier. The compositions comprising the bacterial populations described herein can improve plant traits, such as promoting plant growth, maintaining high chlorophyll content in leaves, increasing fruit or seed numbers, and increasing fruit or seed unit weight.

The compositions can include a tackifier or adherent (referred to as an adhesive agent) to help bind other active agents to a substance (e.g., a surface of a seed). Such agents are useful for combining bacteria with carriers that can contain other compounds (e.g., control agents that are not biologic), to yield a coating composition. Such compositions help create coatings around the plant or seed to maintain contact between the microbe and other agents with the plant or plant part. In one embodiment, adhesives are selected from the group consisting of: alginate, gums, starches, lecithins, formononetin, polyvinyl alcohol, alkali formononetinate, hesperetin, polyvinyl acetate, cephalins, Gum Arabic, Xanthan Gum, Mineral Oil, Polyethylene Glycol (PEG), Polyvinyl pyrrolidone (PVP), Arabinogalactan, Methyl Cellulose, PEG 400, Chitosan, Polyacrylamide, Polyacrylate, Polyacrylonitrile, Glycerol, Triethylene glycol, Vinyl Acetate, Gellan Gum, Polystyrene, Polyvinyl, Carboxymethyl cellulose, Gum Ghatti, and polyoxyethylene-polyoxybutylene block copolymers.

In some embodiments, the adhesives can be, e.g. a wax such as carnauba wax, beeswax, Chinese wax, shellac wax, spermaceti wax, candelilla wax, castor wax, ouricury wax, and rice bran wax, a polysaccharide (e.g., starch, dextrins, maltodextrins, alginate, and chitosans), a fat, oil, a protein (e.g., gelatin and zeins), gum arables, and shellacs. Adhesive agents can be non-naturally occurring compounds, e.g., polymers, copolymers, and waxes. For example, non-limiting examples of polymers that can be used as an adhesive agent include: polyvinyl acetates, polyvinyl acetate copolymers, ethylene vinyl acetate (EVA) copolymers, polyvinyl alcohols, polyvinyl alcohol copolymers, celluloses (e.g., ethylcelluloses, methylcelluloses, hydroxymethylcelluloses, hydroxypropylcelluloses, and carboxymethylcelluloses), polyvinylpyrolidones, vinyl chloride, vinylidene chloride copolymers, calcium lignosulfonates, acrylic copolymers, polyvinylacrylates, polyethylene oxide, acylamide polymers and copolymers, polyhydroxyethyl acrylate, methylacrylamide monomers, and polychloroprene.

In some examples, one or more of the adhesion agents, anti-fungal agents, growth regulation agents, and pesticides (e.g., insecticide) are non-naturally occurring compounds (e.g., in any combination). Additional examples of agriculturally acceptable carriers include dispersants (e.g., polyvinylpyrrolidone/vinyl acetate PVPIVA S-630), surfactants, binders, and filler agents.

The compositions can also contain a surfactant. Non-limiting examples of surfactants include nitrogen-surfactant blends such as Prefer 28 (Cenex), Surf-N(US), Inhance (Brandt), P-28 (Wilfarm) and Patrol (Helena); esterified seed oils include Sun-It II (AmCy), MSO (UAP), Scoil (Agsco), Hasten (Wilfarm) and Mes-100 (Drexel); and organo-silicone surfactants include Silwet L77 (UAP), Silikin (Terra), Dyne-Amic (Helena), Kinetic (Helena), Sylgard 309 (Wilbur-Ellis) and Century (Precision). In one embodiment, the surfactant is present at a concentration of between 0.01% v/v to 10% v/v. In another embodiment, the surfactant is present at a concentration of between 0.1% v/v to 1% v/v.

In certain cases, the formulation includes a microbial stabilizer. Such an agent can include a desiccant, which can include any compound or mixture of compounds that can be classified as a desiccant regardless of whether the compound or compounds are used in such concentrations that they in fact have a desiccating effect on a liquid inoculant. Such desiccants are ideally compatible with the bacterial population used, and should promote the ability of the microbial population to survive application on the seeds and to survive desiccation. Examples of suitable desiccants include one or more of trehalose, sucrose, glycerol, and methylene glycol. Other suitable desiccants include, but are not limited to, non-reducing sugars and sugar alcohols (e.g., mannitol or sorbitol). The amount of desiccant introduced into the formulation can range from about 5% to about 50% by weight/volume, for example, between about 10% to about 40%, between about 15% to about 35%, or between about 20% to about 30%. In some cases, it is advantageous for the formulation to contain agents such as a fungicide, an antibacterial agent, an herbicide, a nematicide, an insecticide, a plant growth regulator, a rodenticide, bactericide, or a nutrient. In some examples, agents may include protectants that provide protection against seed surface-borne pathogens. In some examples, protectants may provide some level of control of soil-borne pathogens. In some examples, protectants may be effective predominantly on a seed surface.

In some examples, a fungicide may include a compound or agent, whether chemical or biological, that can inhibit the growth of a fungus or kill a fungus. In some examples, a fungicide may include compounds that may be fungistatic or fungicidal. In some examples, fungicide can be a protectant, or agents that are effective predominantly on the seed surface, providing protection against seed surface-borne pathogens and providing some level of control of soil-borne pathogens. Non-limiting examples of protectant fungicides include captan, maneb, thiram, or fludioxonil.

In some examples, fungicide can be a systemic fungicide, which can be absorbed into the emerging seedling and inhibit or kill the fungus inside host plant tissues. Systemic fungicides used for seed treatment include, but are not limited to the following: azoxystrobin, carboxin, mefenoxam, metalaxyl, thiabendazole, trifloxystrobin, and various triazole fungicides, including difenoconazole, ipconazole, tebuconazole, and triticonazole. Mefenoxam and metalaxyl are primarily used to target the water mold fungi Pythium and Phytophthora. Some fungicides are preferred over others, depending on the plant species, either because of subtle differences in sensitivity of the pathogenic fungal species, or because of the differences in the fungicide distribution or sensitivity of the plants. In some examples, fungicide can be a biological control agent, such as a bacterium or fungus. Such organisms may be parasitic to the pathogenic fungi, or secrete toxins or other substances which can kill or otherwise prevent the growth of fungi. Any type of fungicide, particularly ones that are commonly used on plants, can be used as a control agent in a seed composition.

In some examples, the upstream composition comprises a control agent which has antibacterial properties. In one embodiment, the control agent with antibacterial properties is selected from the compounds described herein elsewhere. In another embodiment, the compound is Streptomycin, oxytetracycline, oxolinic acid, or gentamicin. Other examples of antibacterial compounds which can be used as part of a seed coating composition include those based on dichlorophene and benzylalcohol hemi formal (ProxelR from ICI or ActicideR RS from Thor Chemie and KathonR MK 25 from Rohm & Haas) and isothiazolinone derivatives such as alkylisothiazolinones and benzisothiazolinones (ActicideR MBS from Thor Chemie).

In some examples, growth regulator is selected from the group consisting of. Abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione phosphorotrithioate, 2,3,5-tri-iodobenzoic acid, trinexapac-ethyl and uniconazole. Additional non-limiting examples of growth regulators include brassinosteroids, cytokinines (e.g., kinetin and zeatin), auxins (e.g., indolylacetic acid and indolylacetyl aspartate), flavonoids and isoflavanoids (e.g., formononetin and diosmetin), phytoaixins (e.g., glyceolline), and phytoalexin-inducing oligosaccharides (e.g., pectin, chitin, chitosan, polygalacuronic acid, and oligogalacturonic acid), and gibellerins. Such agents are ideally compatible with the agricultural seed or seedling onto which the formulation is applied (e.g., it should not be deleterious to the growth or health of the plant). Furthermore, the agent is ideally one which does not cause safety concerns for human, animal or industrial use (e.g., no safety issues, or the compound is sufficiently labile that the commodity plant product derived from the plant contains negligible amounts of the compound).

Some examples of nematode-antagonistic biocontrol agents include ARF18; 30 Arthrobotrys spp.; Chaetomium spp.; Cylindrocarpon spp.; Exophilia spp.; Fusarium spp.; Gliocladium spp.; Hirsutella spp.; Lecanicillium spp.; Monacrosporium spp.; Myrothecium spp.; Neocosmospora spp.; Paecilomyces spp.; Pochonia spp.; Stagonospora spp.; vesiculararbuscular mycorrhizal fungi, Burkholderia spp.; Pasteuria spp., Brevibacillus spp.; Pseudomonas spp.; and Rhizobacteria. Particularly preferred nematode-antagonistic biocontrol agents include ARF18, Arthrobotrys oligospora, Arthrobotrys dactyloides, Chaetomium globosum, Cylindrocarpon heteronema, Exophilia jeanselmei, Exophilia pisciphila, Fusarium aspergilus, Fusarium solani, Gliocladium catenulatum, Gliocladium roseum, Gliocladium vixens, Hirsutella rhossiliensis, Hirsutella minnesotensis, Lecanicillium lecanii, Monacrosporium drechsleri, Monacrosporium gephyropagum, Myrotehcium verrucaria, Neocosmospora vasinfecta, Paecilomyces lilacinus, Pochonia chlamydosporia, Stagonospora heteroderae, Stagonospora phaseoli, vesiculararbuscular mycorrhizal fungi, Burkholderia cepacia, Pasteuria penetrans, Pasteuria thornei, Pasteuria nishizawae, Pasteuria ramosa, Pastrueia usage, Brevibacillus laterosporus strain G4, Pseudomonas fluorescens and Rhizobacteria.

Some examples of nutrients can be selected from the group consisting of a nitrogen fertilizer including, but not limited to Urea, Ammonium nitrate, Ammonium sulfate, Non-pressure nitrogen solutions, Aqua ammonia, Anhydrous ammonia, Ammonium thiosulfate, Sulfur-coated urea, Urea-formaldehydes, IBDU, Polymer-coated urea, Calcium nitrate, Ureaform, and Methylene urea, phosphorous fertilizers such as Diammonium phosphate, Monoammonium phosphate, Ammonium polyphosphate, Concentrated superphosphate and Triple superphosphate, and potassium fertilizers such as Potassium chloride, Potassium sulfate, Potassium-magnesium sulfate, Potassium nitrate. Such compositions can exist as free salts or ions within the seed coat composition. Alternatively, nutrients/fertilizers can be complexed or chelated to provide sustained release over time.

Some examples of rodenticides may include selected from the group of substances consisting of 2-isovalerylindan-1,3-dione, 4-(quinoxalin-2-ylamino)benzenesulfonamide, alphachlorohydrin, aluminum phosphide, antu, arsenous oxide, barium carbonate, bisthiosemi, brodifacoum, bromadiolone, bromethalin, calcium cyanide, chloralose, chlorophacinone, cholecalciferol, coumachlor, coumafuryl, coumatetralyl, crimidine, difenacoum, difethialone, diphacinone, ergocalciferol, flocoumafen, fluoroacetamide, flupropadine, flupropadine hydrochloride, hydrogen cyanide, iodomethane, lindane, magnesium phosphide, methyl bromide, norbormide, phosacetim, phosphine, phosphorus, pindone, potassium arsenite, pyrinuron, scilliroside, sodium arsenite, sodium cyanide, sodium fluoroacetate, strychnine, thallium sulfate, warfarin and zinc phosphide.

In the liquid form, for example, solutions or suspensions, bacterial populations can be mixed or suspended in water or in aqueous solutions. Suitable liquid diluents or carriers include water, aqueous solutions, petroleum distillates, or other liquid carriers.

Solid compositions can be prepared by dispersing the bacterial populations in and on an appropriately divided solid carrier, such as peat, wheat, bran, vermiculite, clay, talc, bentonite, diatomaceous earth, fuller's earth, pasteurized soil, and the like. When such formulations are used as wettable powders, biologically compatible dispersing agents such as non-ionic, anionic, amphoteric, or cationic dispersing and emulsifying agents can be used.

The solid carriers used upon formulation include, for example, mineral carriers such as kaolin clay, pyrophyllite, bentonite, montmorillonite, diatomaceous earth, acid white soil, vermiculite, and pearlite, and inorganic salts such as ammonium sulfate, ammonium phosphate, ammonium nitrate, urea, ammonium chloride, and calcium carbonate. Also, organic fine powders such as wheat flour, wheat bran, and rice bran may be used. The liquid carriers include vegetable oils such as soybean oil and cottonseed oil, glycerol, ethylene glycol, polyethylene glycol, propylene glycol, polypropylene glycol, etc.

### Non-Genetically Modified Maize

The systems and methods described herein are suitable for any of a variety of nongenetically modified maize plant seeds. And in some aspects, the corn is organic. Furthermore, the methods and bacteria described herein are suitable for any of the following nongenetically modified hybrids, varieties, lineages, etc. In some embodiments, corn varieties generally fall under six categories: sweet corn, flint corn, popcorn, dent corn, pod corn, and flour corn.

### Sweet Corn

Yellow su varieties include Earlivee, Early Sunglow, Sundance, Early Golden Bantam, Iochief, Merit, Jubilee, and Golden Cross Bantam. White su varieties include True Platinum, Country Gentleman, Silver Queen, and Stowell's Evergreen. Bicolor su varieties include Sugar & Gold, Quickie, Double Standard, Butter & Sugar, Sugar Dots, Honey & Cream. Multicolor su varieties include Hookers, Triple Play, Painted Hill, Black Mexican/Aztec.

Yellow se varieties include Buttergold, Precocious, Spring Treat, Sugar Buns, Colorow, Kandy King, Bodacious R/M, Tuxedo, Incredible, Merlin, Miracle, and Kandy Korn EH. White se varieties include Spring Snow, Sugar Pearl, Whiteout, Cloud Nine, Alpine, Silver King, and Argent. Bicolor se varieties include Sugar Baby, Fleet, Bon Jour, Trinity, Bi-Licious, Temptation, Luscious, Ambrosia, Accord, Brocade, Lancelot, Precious Gem, Peaches and Cream Mid EH, and Delectable R/M. Multicolor se varieties include Ruby Queen.

Yellow sh2 varieties include Extra Early Super Sweet, Takeoff, Early Xtra Sweet, Raveline, Summer Sweet Yellow, Krispy King, Garrison, Illini Gold, Challenger, Passion, Excel, Jubilee SuperSweet, Illini Xtra Sweet, and Crisp 'N Sweet. White sh2 varieties include Summer Sweet White, Tahoe, Aspen, Treasure, How Sweet It Is, and Camelot. Bicolor sh2 varieties include Summer Sweet Bicolor, Radiance, Honey 'N Pearl, Aloha, Dazzle, Hudson, and Phenomenal.

Yellow sy varieties include Applause, Inferno, Honeytreat, and Honey Select. White sy varieties include Silver Duchess, Cinderella, Mattapoisett, Avalon, and Captivate. Bicolor sy varieties include Pay Dirt, Revelation, Renaissance, Charisma, Synergy, Montauk, Kristine, Serendipity/Providence, and Cameo.

Yellow augmented supersweet varieties include Xtra-Tender 1ddA, Xtra-Tender 11dd, Mirai 131Y, Mirai 130Y, Vision, and Mirai 002. White augmented supersweet varieties include Xtra-Tender 3dda, Xtra-Tender 31dd, Mirai 421 W, XTH 3673, and Devotion. Bicolor augmented supersweet varieties include Xtra-Tender 2dda, Xtra-Tender 21dd, Kickoff XR, Mirai 308BC, Anthem XR, Mirai 336BC, Fantastic XR, Triumph, Mirai 301BC, Stellar, American Dream, Mirai 350BC, and Obsession.

### Flint Corn

Flint corn varieties include Bronze-Orange, Candy Red Flint, Floriani Red Flint, Glass Gem, Indian Ornamental (Rainbow), Mandan Red Flour, Painted Mountain, Petmecky, Cherokee White Flour,

### Pop Corn

Pop corn varieties include Monarch Butterfly, Yellow Butterfly, Midnight Blue, Ruby Red, Mixed Baby Rice, Queen Mauve, Mushroom Flake, Japanese Hull-less, Strawberry, Blue Shaman, Miniature Colored, Miniature Pink, Pennsylvania Dutch Butter Flavor, and Red Strawberry.

### Dent Corn

Dent corn varieties include Bloody Butcher, Blue Clarage, Ohio Blue Clarage, Cherokee White Eagle, Hickory Cane, Hickory King, Jellicorse Twin, Kentucky Rainbow, Daymon Morgan's Knt. Butcher, Learning, Learning's Yellow, McCormack's Blue Giant, Neal Paymaster, Pungo Creek Butcher, Reid's Yellow Dent, Rotten Clarage, and Tennessee Red Cob.

In some embodiments, corn varieties include P1618 W, P1306 W, P1345, P1151, P1197, P0574, P0589, and P0157. W=white corn.

In some embodiments, the methods and bacteria described herein are suitable for any hybrid of the maize varieties set forth herein.

### Genetically Modified Maize

The systems and methods described herein are suitable for any of a hybrid, variety, lineage, etc. of genetically modified maize plant seeds.

### EXAMPLES

The foregoing examples are not intended to limit the scope of the disclosure in any manner, and are only provided to further demonstrate features and advantages of the systems, methods, and compositions described herein.

### Example 1

### Preparation of Dry Microbial Powder

100 μL of thawed working microbial cell stock in a baffled shake flask was used as primary seed to achieve more than 0.1% volume of the secondary seed culture. The secondary seed culture was grown in an agitated fermentation vessel to achieve more than 2% volume of the main fermentation vessel (10-150M3) and transferred to the main fermentation vessel. The main fermentation vessel was agitated, aerated, and cooled. Secondary seed cultures of gram-negative, aerobic bacteria Klebsiella variicola strain 137-2253 (Kv137-2253) and Kosakonia sacchari strain 6-5687 (Ks6-5687) were fermented in separate batch fermentation(s).

The resulting fermentation broths were harvested, concentrated to 20× and used to prepare the dry powder composition. Two parts of 20× concentrated fermentation broth was mixed with 1 part of cryoprotectant stock and subjected to freeze drying process using liquid nitrogen. The cryoprotectant stock was prepared by dissolving 350 grams of sucrose and 150 grams of inulin in 700 ml of water.

A freeze dried cake of individual strains was then blended with anticaking agent and milled into a powder. Freeze dried material of both strains were combined at a 1:1 mass ratio and blended with bulking excipients and packaged in mylar pouches (380 grams per pouch).

### Example 2

### Preparation of Extender Solution

Two different extender solutions were prepared by mixing the components listed in Table 2 below. The extender compositions 1368 and 1378 differ from each other only in the source of polyvinyl pyrrolidone-vinyl acetate used. In the preparation of Extender 1368, the commercial source for polyvinyl pyrrolidone-vinyl acetate was Jarpol PVP/VA 73 W while the commercial source for the polyvinyl pyrrolidone-vinyl acetate in the preparation of Extender 1378 was Agrimer VA 7w.

TABLE 2
Extenders Composition

| Extender Ingredients | | |
|---|---|---|
| (% wt) | 1368 | 1378 |
| Deionized or Reverse | 70.5 | 70.5 |
| Osmosis Water | | |
| K₂HPO₄ | 1 | 1 |
| KH₂PO₄ | 0.5 | 0.5 |
| Jarpol PVP/VA 73W | 17 | |
| Neosorb P60W | 11 | 11 |
| Agrimer VA 7w | | 17 |

Mixing the dry microbial powder prepared as in Example 1 with the liquid extender preparation as in Example 2 yielded an overtreatment composition useful in overtreatment of the seeds. Overtreatment of the seed can be carried out both on the laboratory scale and on the commercial scale. A commonly used laboratory scale seed treater is the Hege 11 liquid seed treater available from Wintersteiger AG, Austria. When using Hege liquid seed treater, 5.4 fl. Oz of overtreatment composition is used to treat 100 lbs of seed and the overtreatment was carried at the speed of 3.3 lbs of seed per 50 second. KSi 02PRO SC is a commonly used commercial scale seed treater available from KSi, Sabetha, KS, USA. When using the commercial scale Ksi seed treater, 5.4 fl. Oz of overtreatment composition was used to treat 100 lbs of seed and the overtreatment was carried at the speed of 350 lbs of seed per minute.

To assess the effectiveness of the systems and mixing methods described herein, mixing effectiveness of the commercial scale mixture as modified according to the present invention was compared against a mixing operation performed by a laboratory scale mixer. The commercial scale mixture includes a mixing tank with a 3-blade mixing shaft, and a recirculation loop with a peristaltic pump. A microbial powder (380 g) was combined with 4.25 L of a liquid extender in the mixing tank. The powder and liquid extender were mixed with the mixing shaft rotating at 114 RPM, and a recirculation loop flow rate of 1 gallon per minute. Mixing occurred for 30 seconds.

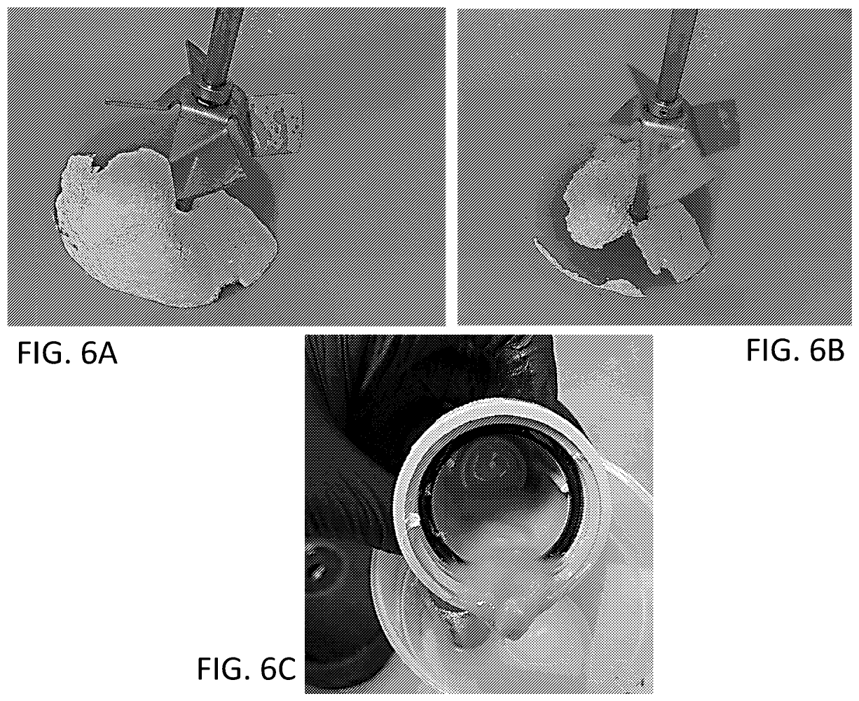

FIG. 6A is an image showing the microbial powder and liquid extender in the tank, along with the 3-blade mixing shaft. FIG. 6B is an image showing the result of mixing for 30 seconds. As is evident from this image, the mixing quality was poor. FIG. 6C shows an image of an inline filter that was used to filter the suspension after mixing. The filter was clogged after a short time due to aggregation of the powder and a low level of dispersion of the powder through the liquid extender.

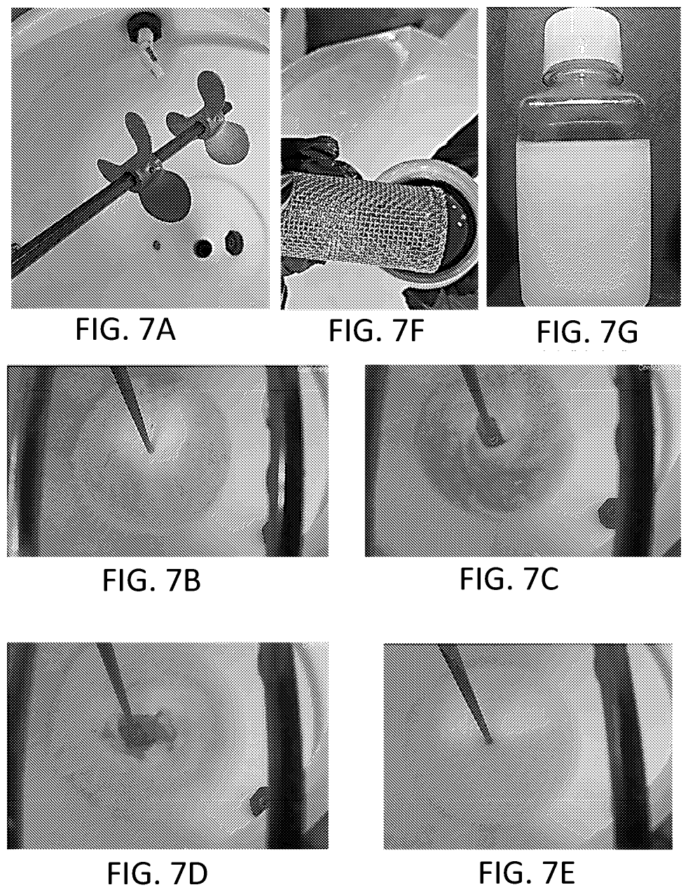

The experiment was repeated using 380 g of the microbial powder and 4.25 L of the liquid extender combined in a mixer similar to mixer 118 in FIG. 5A. FIG. 7A is an image of shaft 506 with vanes 508a-508b (implemented as propellers) in tank 502. The microbial powder and liquid extender were mixed with vanes 508a-508b rotating at 1917 RPM about shaft 506. FIG. 7B is an image showing the microbial powder and liquid extender in tank 502 prior to mixing. FIG. 7C is an image showing the microbial powder and liquid extender after mixing for 5 seconds at 1917 RPM, with vanes 508a-508b rotating in a clockwise direction. FIG. 7D is an image showing the microbial powder and liquid extender after mixing for a further 5 seconds at 1917 RPM, with vanes 508a-508b rotating in a counter-clockwise direction.

The mixing cycle described above in connection with FIGS. 7C and 7D was repeated 5 times, and the results are shown in FIG. 7E. The microbial powder and liquid extender were completely mixed. FIG. 7F is an image of in-line filter 510. No clogging of the filter was observed. FIG. 7G is an image of the mixed overtreatment; no settling of the microbial powder occurred. The foregoing results demonstrate significantly improved mixing relative to the results achieved with the commercially available mixer as modified according to the present invention. Moreover, the commercial scale seed treater modified according to the present disclosure, is suitable for overtreating a large volume of seeds in a single operation. For example, using the commercial scale seed treater modified according to the present invention, it is possible to feed one ProBox full of corn seeds into the seed treater at one end and collect the overtreated corn seeds at the other end without any loss or damage in a ProBox. A ProBox of corn seeds is referred to as 1 Unit and comprises 50 bags of seeds which is equivalent to 4 million seeds. 1 Unit of corn seed is used to plant 110 acres of land at the density of 28,000-36,000 seeds per acre.

### Example 3

### Viability of Microbes on the Overtreated Corn Seeds

The corn seeds overtreated with the composition comprising dry microbe and liquid extender formulation prepared according to the method described in the present invention is referred to as “PROVEN 40 OS” seed where the term “OS” stands for “overtreated seed” and the term “PROVEN 40” stands to show that the corn seed overtreated with nitrogen fixing microbes as described in the present invention, upon germination has been shown to reduce the requirement for synthetic nitrogen fertilizer by about 40 pounds per acre. A basic requirement for the reduction in the requirement for synthetic nitrogen fertilizer when using the PROVEN 40 OS seeds to plant the corn field is that the microbes applied to the surface of the corn seeds according to the overtreatment process of the present invention should be viable for a certain period on the seed surface, subsequently colonize the rhizosphere of the growing corn plant, fix atmospheric nitrogen, and excrete nitrogen compounds for the use by the corn plants to reduce the dependency of the crop plants on the synthetic nitrogen fertilizer.

The viability of nitrogen fixing microbes on the surface of the overtreated seeds is the key factor in achieving the commercial success of PROVEN 40 OS corn seeds. The viability of nitrogen fixing microbes on the surface of PROVEN 40 OS corn seeds can be determined by measuring the number of colony forming units (CFUs) of microbes on the surface of the overtreated seed. The method for determining microbial stability by enumerating bacterial population has been disclosed in the specification above under the heading “Microbial Stability, Seed Viability, and upstream Coating Effectiveness”. Enumeration of bacterial population by using a standard plate method is well known in the art. In the standard plate method used in this invention, each colony forming unit (CFU) detected on the culture plate represents a single microorganism originally present on the surface of the overtreated corn seed. When two or more bacterial strains are used in the preparation of overtreatment composition as described above, the total number of colony forming units (CFUs) counted in any experiment is considered to be equally represented by each of the bacterial strains.

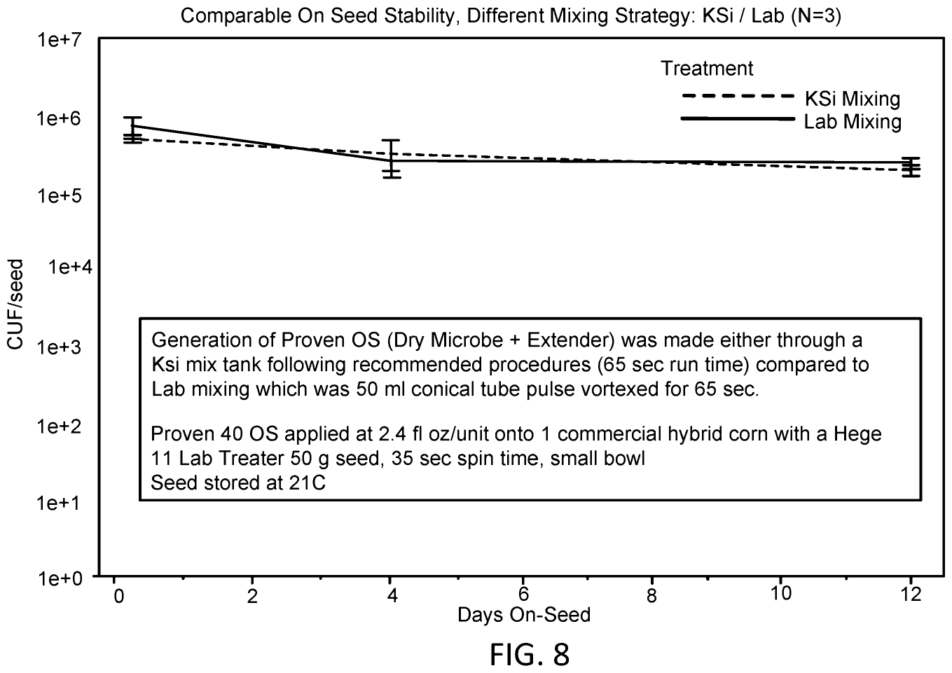

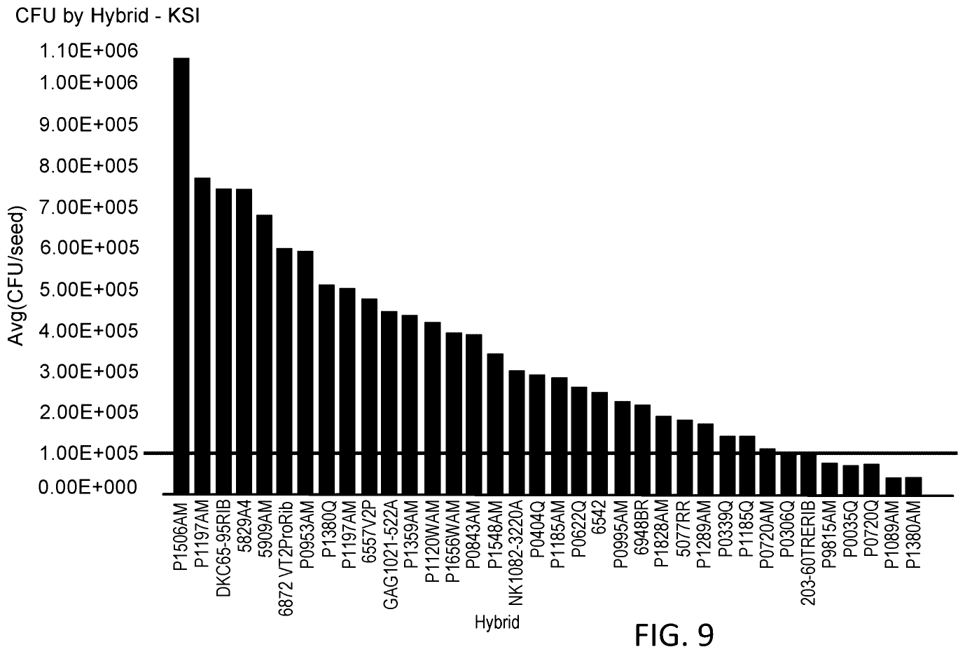

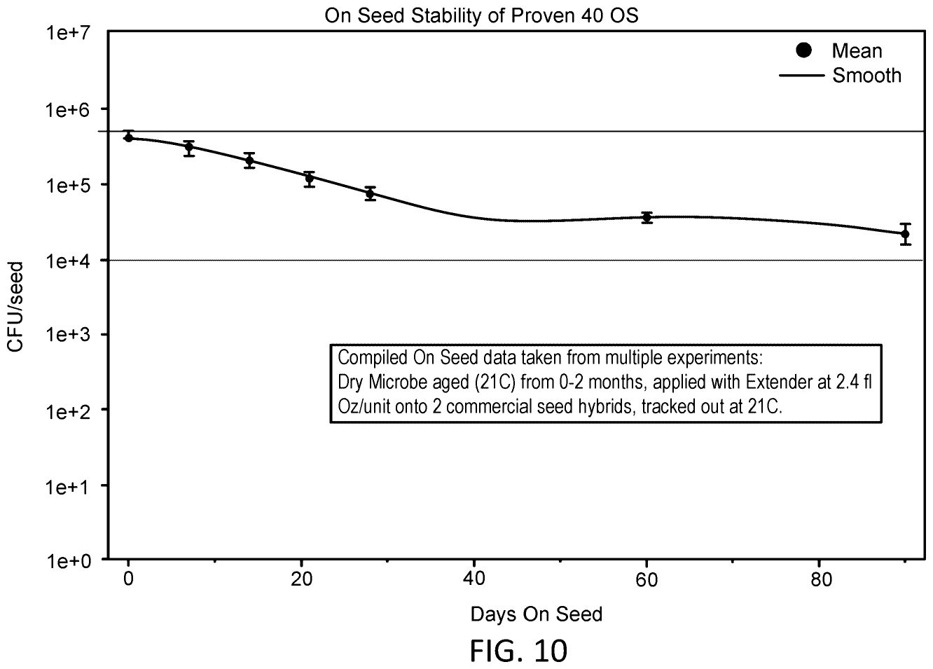

FIG. 8 shows a similar viability profile of microbes on the surface of the seeds overtreated either at the laboratory scale or commercial scale. FIG. 9 shows the viability profile of the microbes on the surface of multiple brands of overtreated corm seed. The horizontal line indicates that the corn seed from majority of the corn varieties are able maintain the viability profile of the microbes above the threshold level of 1×10′ when overtreated with nitrogen fixing microbes according to the overtreatment process disclosed in this invention. In addition, as the results shown in FIG. 10 indicate, the overtreated seeds stored at 21° C. maintained a significant level of microbial viability for 100 days.

### Example 4

### Certain Key Characteristics for Evaluating Seed Overtreatment.

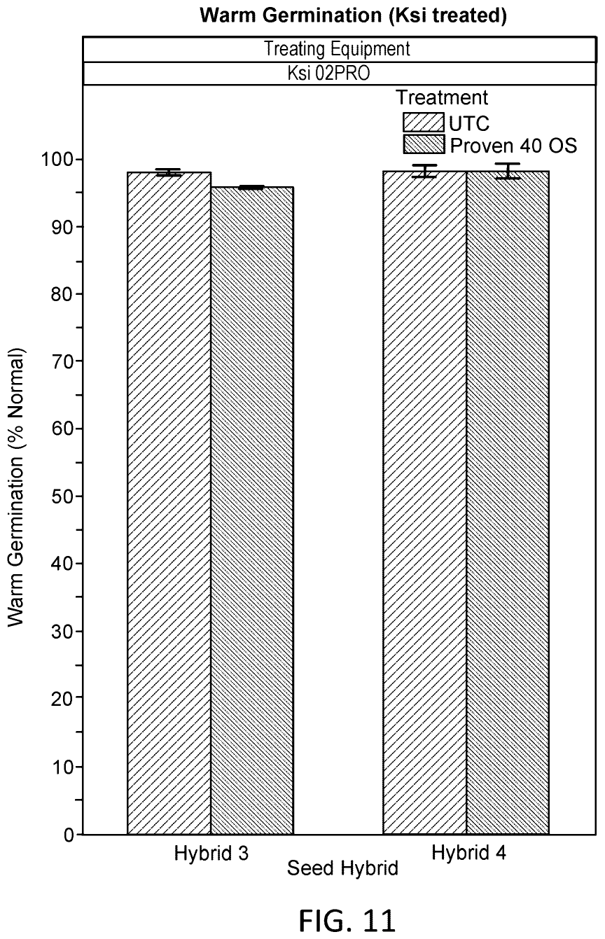

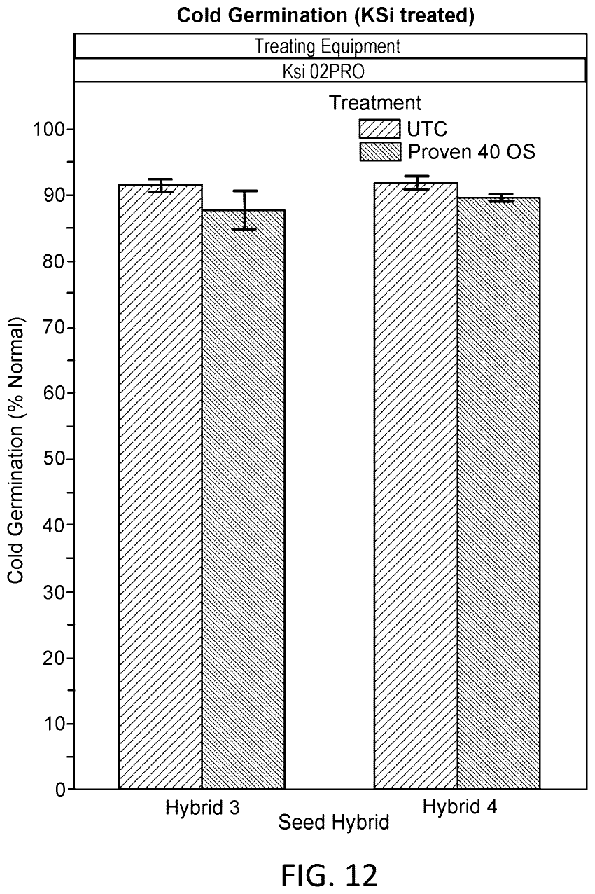

Besides microbe viability, there are a few other characteristics, such as seed germination, plantability and measurement of dust on seed (dust-off) that can be tested to establish that the overtreated corn seed PROVEN 40 OS is suitable for agricultural applications. As shown in FIGS. 11 and 12, no differences were observed in percent warm or cold germination rates of two different PROVEN 40 OS corn seeds derived from the overtreatment of two different varieties of corn seeds using KSi-02PRO commercial seed treater when compared to untreated control seeds (UTC).

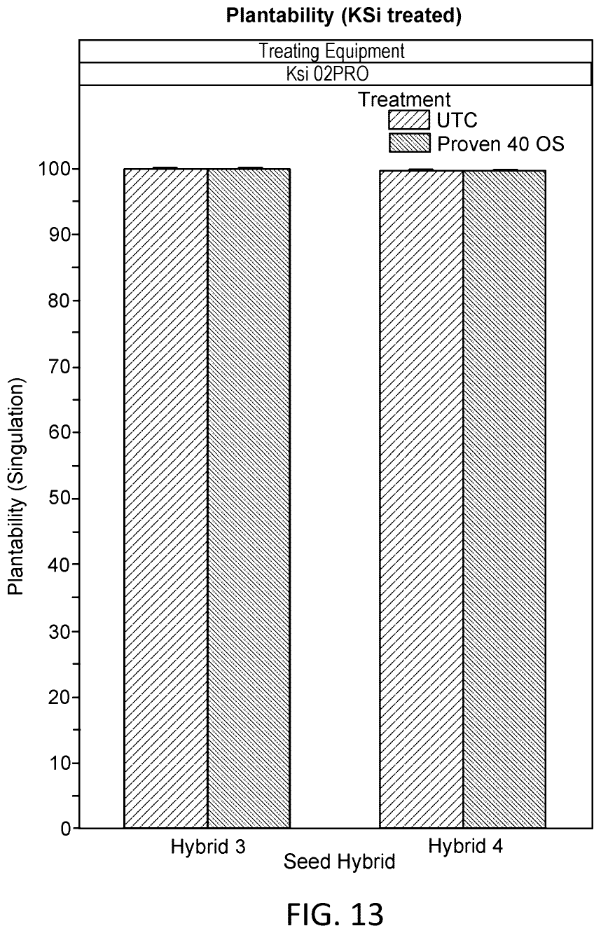

In addition, as shown in FIG. 13, there was no difference in seed plantability of two different varieties of PROVEN 40 OS corn seeds derived from the overtreatment of two different varieties of corn seeds using KSi-02PRO commercial seed treater when compared to untreated control seeds (UTC). In determining the score on seed plantability, percent singulation of seed flowing through a commercial Precision Planter seed-metering unit with an eSet JD Corn disc was determined. Passing results were 98% or higher.

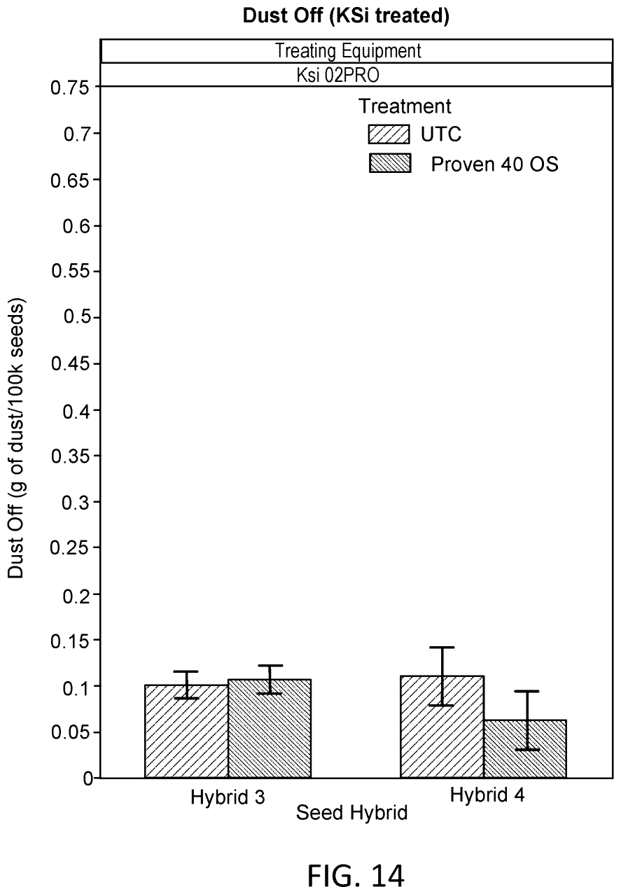

Yet another method to evaluate the effect of seed overtreatment is seed treatment dust-off It is a measurement of “dust” from overtreated seeds, and it is measured using a commercial Heuback dustmeter, reported as grams of dust per 100,000 seeds. The commercial standard is typically less than 75 grams of dust per 100,000 seeds. As shown in FIG. 14, no differences were observed in dust-off measurement of two different PROVEN 40 OS corn seeds derived from the overtreatment of two different varieties of corn seeds using KSi-02PRO commercial seed treater when compared to untreated control seeds (UTC).

### Example 5

### Certain Key Measurements for Evaluating Performance of PROVEN 40 OS Corn Seed

Research trials have shown that PROVEN 40 OS can produce up to 40 pounds of plant-available nitrogen per acre. Nitrogen provided to corn plants through the activity of microbes associated with PROVEN 40 OS seed is not susceptible to many of the environmental stresses that result in the loss of synthetic nitrogen and subsequent negative impact on crop production and the environment.

Additional experiments were undertaken to evaluate the on-farm performance of PROVEN 40 OS corn seeds where the nitrogen fixing microbes were applied to the surface of the seeds of commercial corn hybrids as an overtreatment using commercial seed treaters. Seed overtreatment was applied using 5.4 fl. oz. of overtreatment solution to overtreat 100 lbs of commercial varieties of corn seed. Seed overtreatment was applied to 110 commercial corn hybrids across 15 seed brands using a KSI 02PRO or a USC AT500H commercial seed treater.

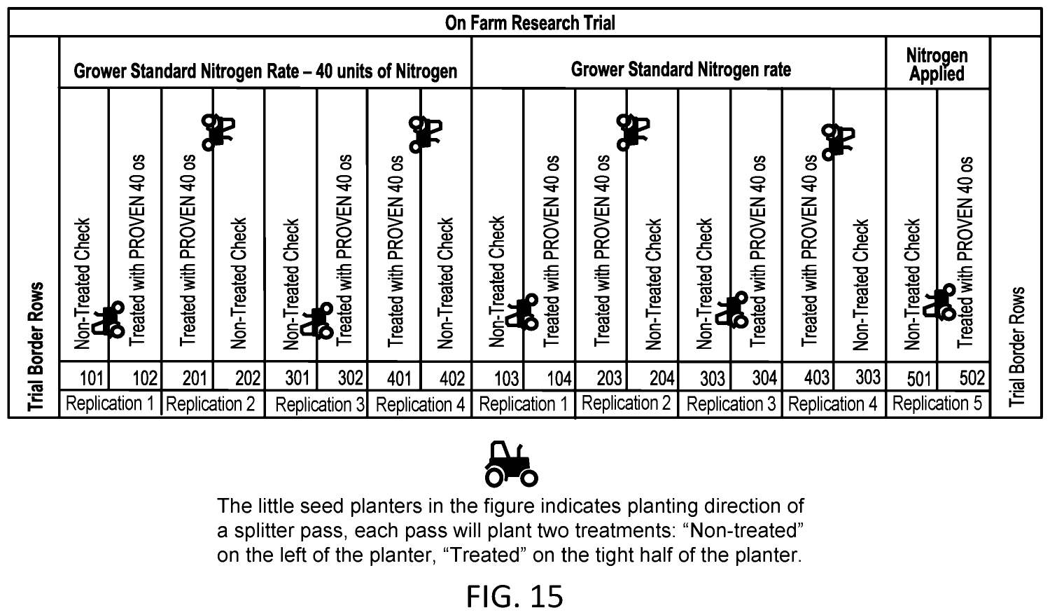

An on-farm research protocol was conducted at 30 locations across the United States corn belt to evaluate the performance of PROVEN 40 OS seed overtreatment in corn production fields. The on-farm trial consisted of two seed treatments and two nitrogen fertilizer applications, as shown in FIG. 15. Optionally two treatment groups were included in the trial design where no synthetic fertilizer was applied. Thus, in a typical trial design the following six different groups were present. (1) Non-treated/reduced N; (2) PROVEN 40 OS/Reduced N; (3) Non-treated/GSP (Grower's Standard Practice for synthetic nitrogen fertilizer application); (4) PROVEN 40 OS/GSP; (5) Non-treated/Zero synthetic nitrogen (optional group); and (6) PROVEN 40 OS/Zero synthetic nitrogen (optional group). The term “non-treated” as used in this Example refers to the original seeds that were used to produce PROVEN 40 OS corn seed through overtreatment process using a commercial scale seed treater. Under this Example PROVEN 40 OS corn seed is also referred as “treated seed”. The two nitrogen fertilizer applications were established in zones across the on-farm field trial. Seed treatments were established across the on-farm trial using a split-planter arrangement, where non-treated seed was planted using the left half of the planter, and PROVEN 40 OS treated seed was planted using the right half of the planter.

Key measurements for evaluating the effect of PROVEN 40 OS seed overtreatment application on-farm performance included: corn stand establishment, reduction in leaf firing, pounds of nitrogen produced per acre by PROVEN 40 OS microbes and grain yield (bushels/acre) with reduced application of synthetic nitrogen fertilizer.

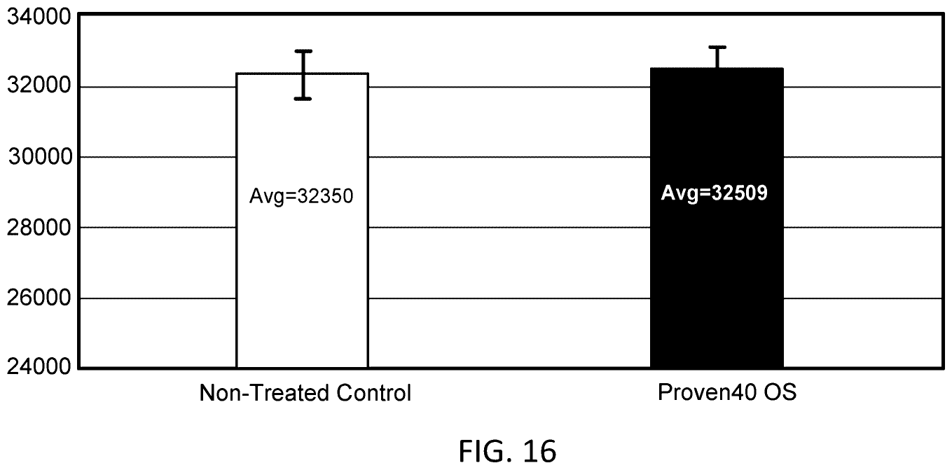

At the V2 stage of the corn plant growth (seedling growth stage), corn stand establishment (plant count per acre) was determined by making multiple assessments of corn plant populations within a corn field. Stand counts were taken within sampling zone areas of the non-treated seed and the treated seed. Multiple counts were taken within 1/1000 acre within sampling zones. Those counts were then averaged among replications of the treatments to determine the average population of emerged seed by treatment. As the result shown in FIG. 16 indicates, overtreatment of corn seeds with commercial scale seed treater before planting did not have any negative impact on the emergence and early seedling growth.

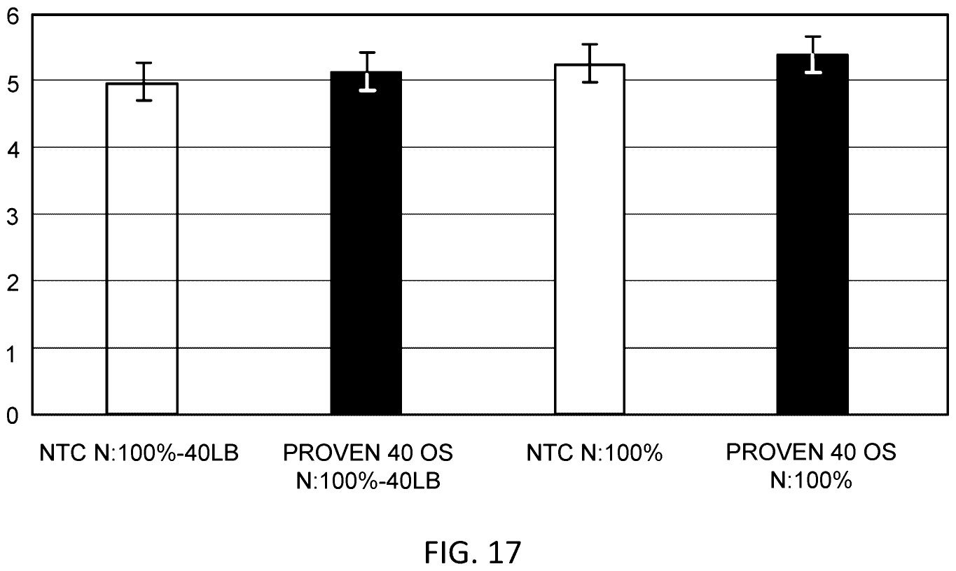

Leaf firing was used as a measure of determining nitrogen level in the growing corn plant. Ten plants per plot were rated for the number of green leaves below the ear leaf. This leaf firing analysis indicated that PROVEN 40 OS delivered in season nitrogen demonstrating reduced leaf firing in comparison to non-treated seed (FIG. 17). The vertical axis in FIG. 17 represents the number of green leaves in the plants from different groups.

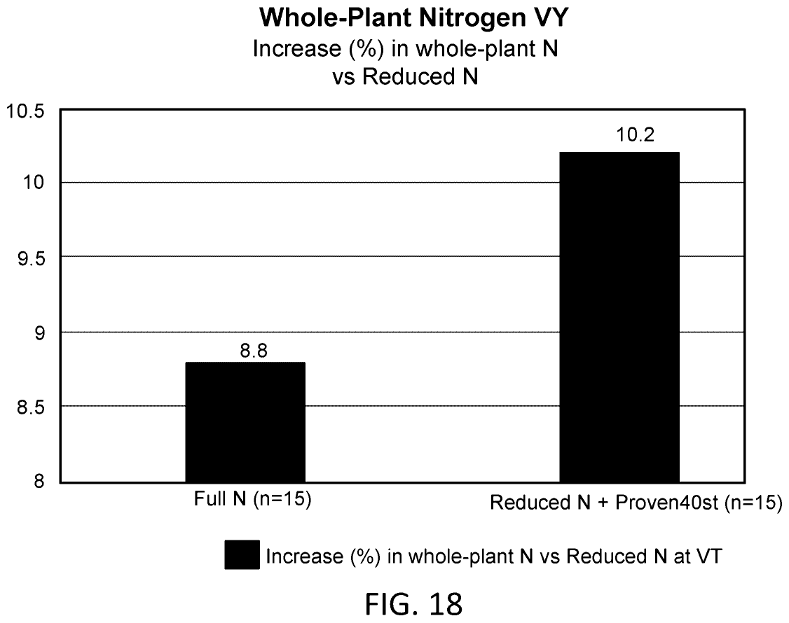

Pounds of plant nitrogen produced by the corn plants per acre was determined at the VT stage of plant growth (late vegetative growth stage) to determine the impact of overtreatment of corn seed with a commercial seed treater before planting Whole plant tissue samples were collected within individual seed overtreatment areas. Data was reported as pounds of nitrogen per acre (percent whole-plant nitrogen X sample dry weight X corn stand count per acre) As the results in FIG. 18 show, the plant derived from PROVEN 40 OS seeds had a 14 lbs N lift for the whole plant tissue when grown in the field supplied with reduced synthetic nitrogen fertilizer.

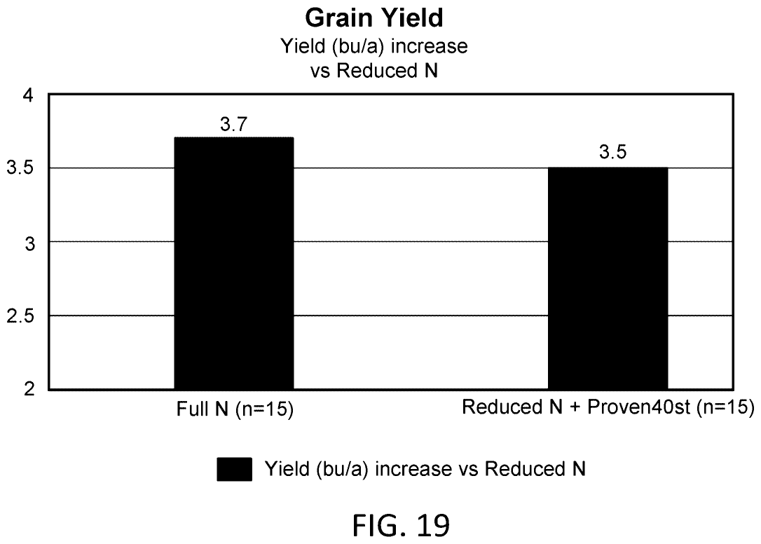

FIG. 19 compares the grain yield (bushels/acre) from the corn plants derived from PROVEN 40 OS corn seed grown in a field supplied with reduced synthetic fertilizer (Growers' Standard Practice minus 40 pounds/acre) with the grain yield (bushels/acre) from plants grown from non-treated corn seed in a field supplied with the synthetic nitrogen fertilizer as per Growers' Standard Practice. As the results in FIG. 19 indicate, overtreating the corn seed using a commercial seed treater did not have any impact on the grain yield even when the treated seeds (PROVEN 40 OS) were grown in the field with a reduced supply of synthetic nitrogen fertilizer. This observation that the grain yield by PROVEN 40 OS corn seeds grown in the field with 40 pound/acre lesser synthetic nitrogen fertilizer is comparable to the grain yield by with the non-treated corn seeds grown in the field supplied with the synthetic nitrogen fertilizer per Growers' Standard Practice demonstrates that the microbes on the surface of the PROVEN 40 OS corn seeds produced nearly 40 pounds of plant-available nitrogen per acre.

### OTHER EMBODIMENTS

While this disclosure describes specific implementations, these should not be construed as limitations on the scope of the disclosure, but rather as descriptions of features in certain embodiments. Features that are described in the context of separate embodiments can also generally be implemented in combination in a single embodiment. Conversely, various features that are described in the context of a single embodiment can also be implemented in multiple embodiments separately or in any suitable sub-combination. Moreover, although features may be described above as present in certain combinations and even initially claimed as such, one or more features from a claimed combination can generally be excised from the combination, and the claimed combination may be directed to a sub-combination or variation of a sub-combination.

In addition to the embodiments expressly disclosed herein, it will be understood that various modifications to the embodiments described may be made without departing from the spirit and scope of the disclosure. Accordingly, other embodiments are within the scope of the following claims.

1.-18. (canceled)

19. A seed overtreatment system for applying an agriculturally useful microbe to seed, comprising:
a treatment applicator comprising an inlet for receiving seeds, a treatment dispersal assembly for applying a treatment to the received seeds, and an outlet for discharging treated seeds;
a mixing reservoir comprising a tank, one or more inlets connected to the tank and configured to receive treatment components, and an outlet connected to the tank;
a mixing mechanism comprising:
an inlet in fluid communication with the outlet of the mixing reservoir;
a pump in fluid communication with the mixing mechanism inlet; and
a circulation mechanism positioned within the tank;
a delivery mechanism configured to deliver at least a portion of a treatment mixture comprising the treatment components from the tank to the treatment applicator; and
a controller coupled to the circulation mechanism,
wherein the circulation mechanism comprises a plurality of vanes configured to rotate about an axis within the tank; and
wherein the controller is configured to mix the treatment components within the tank in one or more mixing cycles by rotating the plurality of vanes within the tank, each mixing cycle comprising:
a first mixing operation in which the plurality of vanes rotate in a first direction about the axis for a first time period; and
a second mixing operation in which the plurality of vanes rotate in a second direction about the axis opposite to the first direction for a second time period.

20.-25. (canceled)

26. The system of claim 19, wherein the controller is configured to rotate the plurality of vanes at a rate of at least 1800 revolutions per minute (RPM) during the first time period.

27. The system of claim 19, wherein the controller is configured to rotate the plurality of vanes at a rate of at least 1800 RPM during the second time period.

28. (canceled)

29. The system of claim 19, wherein the controller is configured to discontinue rotation of the plurality of vanes for a resting period between the first and second periods.

30.-41. (canceled)

42. The system of claim 19, further comprising:
a recirculation mechanism comprising a plurality of outlets positioned within the tank,
wherein central axes of at least two of the outlets are oriented at an angle with respect to an axis of the tank.

43.-50. (canceled)

51. The system of claim 42, wherein the inlet of the mixing mechanism is positioned to capture a portion of a treatment mixture comprising the treatment components, and to direct the captured portion of the treatment mixture to a recirculation pump that directs the captured portion of the treatment mixture to the recirculation mechanism.

52. (canceled)

53. The system of claim 51, wherein the recirculation mechanism is positioned and oriented within the tank to deliver the captured portion of the treatment mixture into the tank in a fluid vortex.

54.-61. (canceled)

62. A system for mixing seed overtreatment components for applying an agriculturally useful microbe to a seed, comprising:
a mixing reservoir comprising a tank, one or more inlets connected to the tank and configured to receive treatment components, and an outlet connected to the tank;
a mixing mechanism comprising:
an inlet in fluid communication with the outlet of the mixing reservoir;
a pump in fluid communication with the mixing mechanism inlet; and
a circulation mechanism positioned in the tank and comprising a plurality of vanes positioned to rotate about an axis;
a delivery mechanism configured to deliver at least a portion of a treatment mixture comprising the treatment components from the tank to the treatment applicator; and
a controller coupled to the circulation mechanism and configured to rotate the plurality of vanes about the axis in each of two opposite directions to mix the treatment components.

63. (canceled)

64. The system of claim 62, wherein the controller is configured to mix the treatment components within the tank in one or more mixing cycles by rotating the plurality of vanes within the tank, each mixing cycle comprising:
a first mixing operation in which the plurality of vanes rotate in a first direction about the axis for a first time period; and
a second mixing operation in which the plurality of vanes rotate in a second direction about the axis opposite to the first direction for a second time period.

65.-69. (canceled)

70. The system of claim 64, wherein the controller is configured to rotate the plurality of vanes at a rate of at least 1800 revolutions per minute (RPM) during the first time period.

71. The system of claim 64, wherein the controller is configured to rotate the plurality of vanes at a rate of at least 1800 RPM during the second time period.

72. (canceled)

73. The system of claim 64, wherein the controller is configured to discontinue rotation of the plurality of vanes for a resting period between the first and second periods.

74.-85. (canceled)

86. The system of claim 62, further comprising:
a recirculation mechanism comprising a plurality of outlets positioned within the tank,
wherein central axes of at least two of the outlets are oriented at an angle with respect to an axis of the tank.

87.-92. (canceled)

93. The system of claim 86, wherein the inlet of the mixing mechanism is positioned to capture a portion of a treatment mixture comprising the treatment components and direct the captured portion of the treatment mixture to a recirculation pump configured to direct the captured portion of the treatment mixture to the recirculation mechanism.

94. (canceled)

95. The system of claim 86, wherein central axes of at least two of the outlets of the recirculation mechanism are oriented at an angle with respect to an axis of the tank.

96.-102. (canceled)

103. A method of overtreating seeds for applying an agriculturally useful microbe to a seed, the method comprising:
preparing a seed treatment composition comprising a liquid treatment component which extends a viability of a microbe and a solid treatment component comprising the microbe; and
applying the seed treatment composition to seeds,
wherein preparing the seed treatment composition comprises:
introducing the liquid and solid treatment components into a mixing reservoir comprising a tank, one or more inlets connected to the tank and configured to receive the treatment components, and an outlet connected to the tank; and
mixing the liquid and solid treatment components with a mixing mechanism comprising an inlet in fluid communication with the outlet of the mixing reservoir, a pump in fluid communication with the mixing mechanism inlet, and a circulation mechanism positioned within the tank and comprising a plurality of vanes configured to rotate about an axis within the tank; and
wherein the treatment components are mixed within the tank in one or more mixing cycles by rotating the plurality of vanes within the tank, each mixing cycle comprising:
a first mixing operation in which the plurality of vanes rotate in a first direction about the axis for a first time period; and
a second mixing operation in which the plurality of vanes rotate in a second direction about the axis opposite to the first direction for a second time period.

104.-108. (canceled)

109. The method of claim 103, wherein the plurality of vanes rotate at a rate of at least 1800 revolutions per minute (RPM) during the first time period.

110. The method of claim 103, wherein the plurality of vanes rotate at a rate of at least 1800 RPM during the second time period.

111. (canceled)

112. The method of claim 103, further comprising discontinuing rotation of the plurality of vanes for a resting period between the first and second periods.

113-115. (canceled)

116. The method of claim 103, further comprising:
capturing portion of a treatment mixture comprising the treatment components from within the tank; and
directing the captured portion of the treatment mixture to a recirculation pump.

117. The method of claim 116, further comprising:
directing the captured portion of the treatment mixture into a recirculation mechanism comprising a plurality of outlets; and
introducing the captured portion of the treatment mixture into the tank using the recirculation mechanism.

118.-120. (canceled)

121. The method of claim 117, wherein two or more of the plurality of outlets of the recirculation mechanism are positioned along a wall of the tank.

122. (canceled)

123. The method of claim 117, wherein the recirculation mechanism is positioned and oriented within the tank to deliver the captured portion of the treatment mixture into the tank in a fluid vortex.

124.-129. (canceled)

130. The method of claim 103, further comprising delivering at least a portion of a treatment mixture comprising the treatment components from the tank to a treatment applicator.

131. The method of claim 130, further comprising filtering the at least a portion of the treatment mixture before delivering it to the treatment applicator.

132.-136. (canceled)

137. The method of claim 117, wherein the seed treatment composition comprises a liquid treatment component (extender) comprising water, a water-soluble polymer, a sugar or sugar alcohol, and a buffering salt and at least one microbe.

138. (canceled)

139. The method of claim 137, wherein the water-soluble polymer is selected from the group consisting of polyvinylpyrrolidone (PVP), polyvinylpyrrolidone-vinyl acetate (PVP-VA), carboxymethyl cellulose (CMC), hydroxypropyl methylcellulose, alginate, and combinations thereof.

140. (canceled)

141. The method of claim 137, wherein the sugar alcohol is sorbitol.

142.-148. (canceled)
